(19) United States
(12) Patent Application Publication
(10) Pub. No.: US 2004/0171489 A1
(43) Pub. Date: Sep. 2, 2004

(54) Synergistic active compound combinations for controlling harmful plants

(76) Inventors: Erwin Hacker, Hochheim (DE); Hermann Bieringer, Eppstein (DE); Thomas Auler, Bad Soden (DE); Lothar Willms, Hofheim (DE); Klemens Minn, Hattersheim (DE); Jens Hollander, Schmitten (DE); Jurgen Zindel, Bad Sooden-Allendorf (DE); Wolfgang Giencke, Hofheim (DE)

Correspondence Address: FROMMER LAWRENCE & HAUG, 745 FIFTH AVENUE- 10TH FL., NEW YORK, NY, 10151, US

(21) Appl. No.: 10/734,792

(22) Filed: Dec. 12, 2003

Related U.S. Application Data
(63) Continuation of application No. 09/787,214, filed on Mar. 15, 2001, now abandoned.
Application No. 09/787,214 is a 371 of international application No. PCT/EP99/06937, filed on Sep. 20, 1999.

(30) Foreign Application Priority Data
Sep. 18, 1998 (DE) 198 42 894.4

(51) Int. Cl. A01N 43/64; A01N 43/66

(52) U.S. Cl. 504/230; 504/231; 504/134

(57) ABSTRACT

The invention relates to synergistic herbicidal combinations for controlling harmful plants in plant cultures. The combinations contain active substances (A) et (B). (A) is an amino triazine with a partial structure of formula (I) as claim 1, in short T-NR-L-M, and L and M are defined as in claim 1, T is a 1,3,5-triazine and NR is an optionally substituted amino group, and (B) is one or more herbicides from the group of compounds consisting of (B1) leaf and/or soil-acting herbicides that are effective against monocotyledonous harmful plants. (B2) herbicides that are chiefly effective against dicotyledonous harmful plants and (B3) herbicides that are effective against monocotyledonous or dicotyledonous harmful plants are optionally (B4) herbicides that are effective against monocotyledonous and dicotyledonous harmful plants which can especially be used in tolerant cultures or on non-cultivated soil, with the exception of combinations of herbicides if the formula (I′), wherein R¹═H or methyl; X═Cl, F and A=a phenoxy methyl group which is unsubstituted at the phenyl ring or which is substituted with one or two radicals from the methyl and fluorine group, or a benzofuran-2-yl or benzothiophen-2-yl radical, with herbicides selected from the group of isoproturon, diclofop methyl, fenoxapropethyl and amidosulfuron.

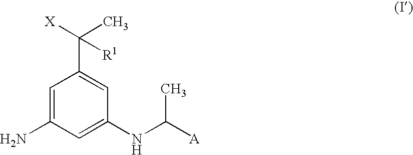

The invention relates to the field of crop protection agents, in particular to combinations of groups of active compounds having different modes of action and types of activity, which are outstandingly suitable for use against harmful plants in crops of useful plants.

In many crops of useful plants, harmful plants are undesirable competitors which can be controlled only with considerable expense and at high cost. They germinate and grow in the soil over prolonged periods of time and can therefore only be effectively controlled with herbicides having foliar and soil action.

Examples of important weed grasses which occur in crops of useful plants all over the world and which are of high economic importance are:

Alcopecurus myosuroides, Avena fatua and other forms of wild oat, Lolium spp., Phalaris spp., Setaria spp., Echinochloa spp., Poa spp., Bromus spp., Elymus repens, Sorghum spp. and others, such as Agrostis spp. and Panicum spp.

It has been known for a relatively long time that some derivatives of 2,4-diamino-1,3,5-triazine substituted in the 6-position have herbicidal action.

WO-A 97/08156, WO-A-97/31904, DE-A-19826670, WO-A-98/15536, WO-A-8/15537, WO-A-98/15538, WO-A-98/15539 and also DE-A-19828519, WO-A-98/34925, WO-A-98/42684, WO-A-99/18100, WO-A-99/19309 and WO-A-99/37627 describe relatively new classes of aminotriazine herbicides.

The effectiveness of these herbicides against harmful plants in the crops is at a high level; however, it depends in general on the application rate, the respective formulation, the harmful plants to be controlled in each case or the spectrum of harmful plants, the climatic and soil conditions, etc. A further criterion is the duration of action, or the rate of degradation of the herbicide. Also to be taken into account are, if appropriate, changes in the susceptibility of harmful plants toward an active compound which may occur on prolonged use or geographically restricted. Activity losses in individual plants can only be compensated to a certain extent by higher application rates of the herbicides, for example because this frequently. decreases the selectivity of the herbicides, or an improvement in activity is not observed, even at higher application rates. In some cases, it is possible to improve the selectivity in crops by addition of safeners. In general, however, there is always a need for methods to achieve the herbicidal action with a lower application rate of active compounds. A lower application rate reduces not only the amount of an active compound which is required for the application, but generally also reduces the amount of formulation auxiliaries required. Both reduce the economic expense and improve the ecological compatibility of the herbicide treatment.

One possibility for improving the property profile of a herbicide may consist in the combination of the active compound with one or more other active compounds which contribute the desired additional properties. However, when two or more active compounds are applied in combination, it is not uncommon for phenomena of physical and biological incompatibility to occur, for example lack of stability of a coformulation, decomposition of an active compound or antagonism of the active compounds. In contrast, what is desired are combinations of active compounds having a favorable activity profile, high stability and, if possible, synergistically enhanced activity, which permits a reduction of the application, compared with the individual application of the active compounds to be combined.

In the publications cited above, it has already been proposed to combine the active compounds described with known herbicides, and an extensive list of possible combination partners has been given.

However, indications of favorable, in particular synergistic, properties of specific combinations have not been given.

Surprisingly, it has now been found that active compounds from the group of the aminotriazine herbicides mentioned interact in a particularly favorable manner in combination with certain structurally different herbicides when used in crops of plants which are suitable for the selective use of the herbicides.

Some herbicide combinations comprising, as one component, herbicides from the group of the 2,4-diamino-1,3,5-triazines have already been disclosed; cf. WO-A-98/1 0654, JP-A-10025211, WO-A-97/35481, JP-A-08198712, EP-A-573897 and EP-A-573898.

The invention provides herbicide combinations which differ from the prior art or have technical advantages, and which comprise a synergistically effective amount of components (A) and (B), where

(A) is one or more herbicidally active aminotriazine compounds having a partial structure of the formula (I)

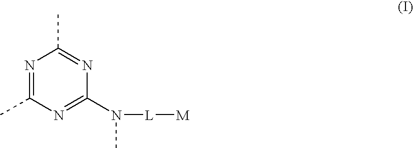

where

L: is a straight-chain or branched, optionally mono- or polysubstituted and/or -bridged alkylene group having 1 to 6 carbon atoms, where one CH₂ group may be replaced by O, N, S(O)ₓ, where x is 0, 1 or 2, or by NO, or is a corresponding alkenylene or alkynylene group having 2 to 8 carbon atoms, preferably 4 to 8 carbon atoms, where one CH₂ group may be replaced by O, and which is optionally mono- or polysubstituted and/or -bridged, and

M is an unsubstituted or substituted aryl or heterocyclyl group, with the proviso that one of the two remaining radicals on the triazine ring is haloalkyl if -L- is a group of the formula —CH(CH₃)—CH₂—O—, and

(B) is one or more herbicides selected from the group of compounds consisting of

(B1) foliar- and/or soil-acting herbicides which are active against monocotyledonous harmful plants,

(B2) herbicides which are active against predominantly dicotyledonous harmful plants and

(B3) herbicides which are active against monocotyledonous and dicotyledonous harmful plants and

(B4) herbicides which are active against monocotyledonous and dicotyledonous harmful plants and which can be employed specifically in tolerant crops or on non-crop land,

except for combinations of herbicides of the formula (I′)

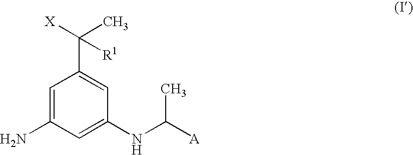

in which

R¹ is H or methyl,

X is a chlorine or fluorine atom and

A is a phenoxymethyl group which is unsubstituted in the phenyl ring or substituted by one or two radicals selected from the group consisting of methyl and fluorine, or

is a benzofuran-2-yl or benzothiophen-2-yl radical,

with herbicides from the group consisting of isoproturon, diclofop-methyl, fenoxaprop-ethyl and amidosulfuron.

The synergistic effects are observed when the active compounds (A) and (B) are applied jointly; however, they can also frequently be observed when the active compounds are applied at different times (splitting). It is also possible to apply the herbicides or the herbicide combinations in a plurality of portions (sequential application), for example after pre-emergence applications, followed by post-emergence applications or after early post-emergence applications, followed by medium or late post-emergence applications. Preference is given here to the joint or almost simultaneous application of the active compounds of the combination in question.

The synergistic effects permit a reduction of the application rates of the individual active compounds, a higher place of activity at the same application rate, the control of harmful plants which were as yet uncontrolled (gaps), an extension of the period of application and/or a reduction in the number of individual applications required and—as a result for the user—weed control systems which are more advantageous economically and ecologically.

The combinations according to the invention of (A)+(B) permit, for example, synergistic increases in activity which, in an unexpected manner, exceed the activities which are achieved with the individual active compounds (A) and (B).

The formula (I) mentioned embraces all stereoisomers and mixtures thereof, in particular also racemic mixtures and—if enantiomers are possible, in each case the biologically active enantiomer or the biologically active enantiomers.

The broken bonds in formula (I) denote bonds to substituents which occur at these positions in known compounds from the group of the herbidical triazines, or which are analogous to the substituents of the known compounds, preferably substituents which are present in the known preferred compounds from the group of the herbicidal triazine.

Of particular interest are herbicide combinations according to the invention comprising aminotriazines of the formula (I) which are covered by formula (Ia), and their salts,

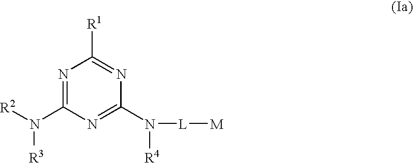

in which

R¹ is an unsubstituted or substituted acyclic hydrocarbon radical or an unsubstituted or substituted cyclic, aromatic or cycloaliphatic hydrocarbon radical or an unsubstituted or substituted heterocyclyl radical, preferably haloalkyl having 1 to 6 carbon atoms,

R² is hydrogen or alkyl having 1 to 4 carbon atoms, in particular hydrogen,

R³ is hydrogen or alkyl having 1 to 4 carbon atoms, in particular hydrogen,

R⁴ is hydrogen and,

L and M are as defined in formula (I).

Aminotriazines of the formula (I) which are preferred for the herbicide combinations are compounds of the formulae (II) to (IX) below and their salts:

1. Compounds of the formula (II) and their salts

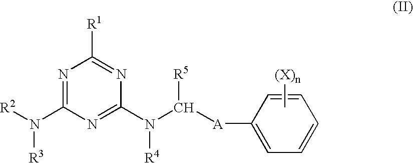

in which

R¹ is (C₁-C₆)-alkyl,

which is unsubstituted or substituted by one or more radicals selected from the group consisting of halogen, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-C₄)-alkynyl, phenyl, which is unsubstituted or substituted, and heterocyclyl having 3 to 6 ring atoms and 1 to 3 hetero ring atoms selected from the group consisting of N, O and S, the ring being unsubstituted or substituted,

R² and R³ in each case independently of one another are hydrogen, amino or alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and. 1 to 3 hetero ring atoms selected from the group consisting of N, O and S, where each of the five last-mentioned radicals is unsubstituted or substituted, or an acyl radical or

R² and R³ together with the nitrogen atom of the group NR²R³ are a heterocyclic radical having 3 to 6 ring atoms and 1 to 4 hetero ring atoms, where the further hetero ring atoms which are optionally present in addition to the nitrogen atom are selected from the group consisting of N, O and S and the radical is unsubstituted or substituted,

R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms, preferably having 1 to 6 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical,

R⁵ is hydrogen, halogen, nitro, cyano, thiocyanato or a radical of the formula —B¹—Y¹, where B¹ and Y¹ are as defined below,

A is an alkylene radical having 1 to 5 straight-chain carbon atoms or alkenylene or alkynylene having in each case 2 to 5 straight-chain carbon atoms, where each of the three last-mentioned diradicals is unsubstituted or substituted by one or more radicals selected from the group consisting of halogen, nitro, cyano, thiocyanato and a radical of the formula —B²—Y²,

(X)ₙ are n substituents X, where X in each case independently of one another, is halogen, (C₁-C₆)-alkyl, (C₂-C₆)-alkenyl, (C₂-C₆)-alkynyl, (C₁-C₆)-alkoxy, (C₂-C₆)-alkenyloxy, (C₂-C₆)-alkynyloxy, [(C₁-C₄)-alkyl]-carbonyl, [(C₁-C₄)-alkoxy]-carbonyl or [(C₁-C₄)-alkylthio]-carbonyl, where the hydrocarbon-containing moieties in the 9 last-mentioned radicals are unsubstituted or substituted, or is a radical of the formula —B^{o}—R^{o}, where B^{o} is as defined below and R^{o} is an aromatic, saturated or partially saturated carbocyclic or heterocyclic radical, where the cyclic radical is substituted or unsubstituted, or two adjacent radicals X together are a fused-on cycle having 4 to 6 ring atoms which is carbocyclic or contains hetero ring atoms selected from the group consisting of O, S and N and which is unsubstituted or substituted by one or more radicals selected from the group consisting of halogen, (C₁-C₄)-alkyl and oxo,

n is 0, 1, 2, 3, 4 or 5,

B^{o},B¹,B² in each case independently of one another are a direct bond or a divalent group of the formula —O—, —S(O)ₚ—, —S(O)ₚ—O—, —O—S(O)ₚ—, —CO—, —O—CO—, —CO—O—, —NR′—, —O—NR′—, —NR′—O—, —NR′—CO—, —CO—NR′—, where p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,

Y¹,Y² in each case independently of one another are H or an acyclic hydrocarbon radical having, for example, 1 to 20 carbon atoms or a cyclic hydrocarbon radical having 3 to 8 carbon atoms or a heterocyclic radical having 3 to 9 ring atoms and 1 to 3 hetero ring atoms selected from the group consisting of N, O and S, where each of the three last-mentioned radicals is unsubstituted or substituted;

2. Compounds of the formula (III) or their salts

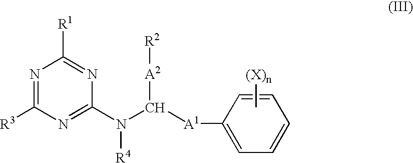

in which

R¹ is aryl, which is unsubstituted or substituted, or (C₃-C₉)-cycloalkyl, which is unsubstituted or substituted, or heterocyclyl, which is substituted or unsubstituted, or

(C₁-C₆)-alkyl, (C₂-C₆)-alkenyl or (C₂-C₆)-alkynyl,

where each of the 3 last-mentioned radicals is unsubstituted or substituted by one or more radicals selected from the group consisting of halogen, hydroxyl, cyano, nitro, thiocyanato, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C4)-alkylsulfinyl, (C₁-C₄)-alkylsulfonyl, (C₁-C₄)-haloalkylsulfinyl, (C₁-C₄)-haloalkylsulfonyl and (C₃-C₉)-cycloalkyl, which is unsubstituted or substituted, and phenyl, which is unsubstituted or substituted, and heterocyclyl, which is unsubstituted or substituted, and radicals of the formulae R′—C(—Z′)—, R′—C(═Z′)—Z—, R′—Z—C(═Z′)—, R′R″N—C(═Z′)—, R′—Z—C(═Z′)—O—, R′R″N—C(═Z′)—Z—, R′—C(═Z′)—NR″— and R′R″N—C(═Z′)—NR′″—, in which R′, R″ and R′″ in each case independently of one another are (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted, and in which Z and Z′ independently of one another are each an oxygen or sulfur atom,

R² is (C₃-C₉)-cycloalkyl, which is unsubstituted or substituted, (C₄-C₉)-cycloalkenyl, which is unsubstituted or substituted, heterocyclyl, which is unsubstituted or substituted, or phenyl, which is unsubstituted or substituted, or

R³ is hydrogen, (C₁-C₆)-alkyl, aryl or (C₃-C₉)-cycloalkyl, where each of the 3 last-mentioned radicals is unsubstituted or substituted, or a radical of the formula —N(B¹-D¹)(B²-D²) or —NR′—N(B¹-D¹)(B²-D²), in which in each case B¹, B², D¹ and D² are as defined below and R′ is hydrogen, (C₁-C₆)-alkyl or [(C₁-C₄)-alkyl]-carbonyl,

R⁴ is a radical of the formula —B³-D³, where B³ and D³ are as defined below,

A¹ is straight-chain alkylene having 1 to 5 carbon atoms or straight-chain alkenylene or alkynylene having in each case 2 to 5 carbon atoms, where each of the three last-mentioned diradicals is unsubstituted or substituted by one or more radicals selected from the group consisting of halogen, nitro, cyano, thiocyanato and radicals of the formula —B⁴-D⁴, where B⁴ and D⁴ are as defined below,

A² is a direct bond or straight-chain alkylene having 1 to 4 carbon atoms or straight-chain alkenylene or alkynylene having in each case 2 to 5 carbon atoms, where each of the three last-mentioned diradicals is unsubstituted or substituted by one or more radicals selected from the group consisting of halogen, nitro, cyano, thiocyanato and radicals of the formula —B⁵-D⁵, or a divalent radical of the formula V¹, V², V³, V⁴ or V⁵,

—CR⁶R⁷—W*—CR⁸R⁹— (V¹)

—CR¹⁰R¹¹—W*—CR¹²R¹³—CR¹⁴R¹⁵— (V²)

—CR¹⁶R¹⁷—CR¹⁸R¹⁹—W*—CR²⁰R²¹— (V³)

—CR²²R²³—CR²⁴R²⁵—W*— (V₄)

—CR²⁶R²⁷—W*— (V⁵)

where each of the radicals R⁶ to R²⁷, in each case independently of one another, is hydrogen, halogen, nitro, cyano, thiocyanato or a radical of the formula —B⁶-D⁶,

W* is in each case an oxygen atom, a sulfur atom or a group of the formula N(B⁷-D⁷) and

B⁵, B⁶, B⁷ , D⁵, D⁶ and D⁷ are as defined below,

B¹, B², B³ and B⁷ in each case independently of one another are a direct bond or a divalent group of the formulae —C(═Z*)—, —C(═Z*)—Z**—, —C(═Z*)—NH— or —C(═Z*)—NR*—, where Z*=an oxygen or sulfur atom, Z**=an oxygen or sulfur atom and R*=(C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted,

B⁴, B⁵ and B⁶ in each case independently of one another are a direct bond or a divalent group of the formulae —O—, —S(O)ₚ—, —S(O)ₚ—O—, —O —S(O)ₚ—, —CO—, —O—CO—, —CO—O—, —S—CO—, —CO—S—, —S—CS—, —CS—S—, —O—CO—O—, —NR^{o}—, —O—NR^{o}—, —NR^{o}—O—, —NR^{o}—CO—, —CO—NR^{o}—, —O—CO—NR^{o}— or —NR^{o}—CO—O—, where p is the integer 0, 1 or 2 and R^{o} is hydrogen, (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted,

D¹, D², D³, D⁴, D⁵ and D⁶ in each case independently of one another are hydrogen, (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted, or in each case two radicals D⁵ of two groups —B⁵-D⁵ attached to one carbon atom are attached to one another forming an alkylene group having 2 to 4 carbon atoms which is unsubstituted or substituted by one or more radicals selected from the group consisting of (C₁-C₄)-alkyl and (C₁-C₄)-alkoxy,

(X)ₙ are n substituents X, where X, in each case independently of one another, is halogen, hydroxyl, amino, nitro, formyl, carboxyl, cyano, thiocyanato, aminocarbonyl or (C₁-C₆)-alkyl, (C₁-C₆)-alkoxy, (C₁-C₆)-alkylthio, mono-(C₁-C₆)-alkylamino, di-(C₁-C₄)-alkylamino, (C₂-C₆)-alkenyl, (C₂-C₆)-alkynyl, [(C₁-C₆)-alkyl]-carbonyl, [(C₁-C₆)-alkoxy]-carbonyl, mono-(C₁-C₆)-alkylamino-carbonyl di-(C₁-C₄)-alkylamino-carbonyl, N-(C₁-C₆)-alkanoyl-amino or N-(C₁-C₄)-alkanoyl-N-(C₁-C₄)-alkylamino, where each of the 13 last-mentioned radicals is unsubstituted or substituted, preferably unsubstituted or substituted by one or more radicals selected from the group consisting of halogen, hydroxyl, amino, nitro, formyl, carboxyl, cyano, thiocyanato, (C₁-C₄)-alkoxy, (C₁-C₄)-haloalkoxy, (C₁-C₄)-alkylthio, (C₁-C₄)-haloalkylthio, mono-(C₁-C₄)-alkylamino, di-(C₁-C₄)-alkylamino, (C₃-C₉)-cycloalkyl, (C₃-C₉)-cycloalkyl-amino, [(C₁-C₄)-alkyl]-carbonyl, [(C₁-C4)-alkoxy]-carbonyl, aminocarbonyl, mono-(C₁-C₄)-alkylamino-carbonyl, di-(C₁-C₄)-alkylamino-carbonyl, phenyl, phenoxy, phenylthio, phenylcarbonyl, heterocyclyl, heterocyclyloxy, heterocyclylthio and heterocyclylamino, where each of the 8 last-mentioned radicals is unsubstituted or substituted by one or more substituents selected from the group consisting of halogen, nitro, cyano, (C₁-C₄)-alkyl, (C₁-C₄)-alkoxy, (C₁-C₄)-alkylthio, (C₁-C₄)-haloalkyl, (C₁-C₄)-haloalkoxy, formyl, (C₁-C₄)-alkyl-carbonyl and (C₁-C₄)-alkoxy-carbonyl,

or (C₃-C₉)-cycloalkyl, (C₃-C₉)-cycloalkoxy, (C₃-C₉)-cycloalkylamino, phenyl, phenoxy, phenylthio, phenylcarbonyl, heterocyclyl, heterocyclyloxy, heterocyclylthio or heterocyclylamino, where each of the 11 last-mentioned radicals is unsubstituted or substituted, or two adjacent radicals X together are a fused-on cycle having 4 to 6 ring atoms which is carbocyclic or contains hetero ring atoms selected from the group consisting of O, S and N and which is unsubstituted or substituted by one or more radicals selected from the group consisting of halogen, (C₁-C₄)-alkyl and oxo, n is 0, 1, 3, 4 or 5 and

“Heterocyclyl” in the radicals mentioned above, independently of one another, is in each case a heterocyclic radical having 3 to 7 ring atoms and 1 to 3 heteroatoms selected from the group consisting of N, O and S,

where

a) the total of the carbon atoms in the radicals A¹ and A²-R² is at least 6 carbon atoms or

b) the total of the carbon atoms in the radicals A¹ and A²-R² is 5 carbon atoms and A¹=a group of the formula —CH₂— or —CH₂CH₂— and R¹═(C₁-C₄)-alkyl, (C₁-C₄)-haloalkyl, (C₂-C₆)-haloalkenyl or (C₃-C₉)-cycloalkyl, which is unsubstituted or substituted;

3. Compounds of the formula (IV) or their salts

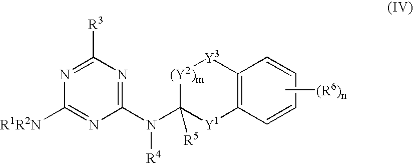

in which

R¹ and R² in each case independently of one another are hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical, heterocyclylthio radical or heterocyclylamino radical having in each case 3 to 6 ring atoms and 1 to 3 hetero ring atoms selected from the group consisting of N, O and S, where each of the five last-mentioned radicals is unsubstituted or substituted, or

an acyl radical or

R¹ and R² together with the nitrogen atom of the group NR¹R² are a heterocyclic radical having 3 to 6 ring atoms and 1 to 4 hetero ring atoms, where any further hetero ring atoms present in addition to the nitrogen atom are selected from the group consisting of N, O and S and the radical is unsubstituted or substituted,

R³ is halogen, cyano, thiocyanato, nitro or a radical of the formula —Z¹—R⁷,

R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical,

R⁵ is halogen, cyano, thiocyanato, nitro or a radical of the formula —Z²—R⁸,

R⁶, in the case where n=1, or the radicals R⁶ in each case independently of one another, if n is greater than 1, is/are halogen, cyano, thiocyanato, nitro or a group of the formula —Z³—R⁹,

R⁷, R⁸, R⁹ in each case independently of one another are

hydrogen or

an acyclic hydrocarbon radical, where carbon atoms in the chain may be substituted by heteroatoms selected from the group consisting of N, O and S, or

a cyclic hydrocarbon radical or

a heterocyclic radical,

where each of the 3 last-mentioned radicals is unsubstituted or substituted,

Z¹, Z², Z³ in each case independently of one another are

a direct bond or

a divalent group of the formula —O—, —S(O)ₚ—, —S(O)ₚ—O—, —O—S(O)ₚ—, —CO—, —CS—, —S—CO—, —CO—S—, −O—CS—, —CS—O—, —S—CS—, —CS—S—, —OCO—, —CO—O—, —NR′—, —O—NR′—, —NR′—O—, —NR′—CO— or —CO—NR′—, where 'p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,

Y¹ ,Y², Y³ and, if m is 2, 3 or 4, further groups Y² are, in each case independently of one another,

a divalent group of the formula CR^{a}R^{b}, where R^{a} and R^{b} are identical or different and are in each case a radical selected from the group of the radicals possible for R⁷ to R⁹, or

a divalent group of the formula —O—, —CO—, —C(═NR)—, —S(O)_{q}—, —NR— or —N(O)—, where q=0, 1 or 2 and R* is hydrogen or alkyl having 1 to 4 carbon atoms, or

Y¹ or Y³ is a direct bond,

where two oxygen atoms of groups Y² and Y³ are not adjacent,

m is 1, 2, 3 or 4,

n is 0, 1, 2, 3 or 4;

4. Substituted 2,4-diamino-1,3,5-triazines of the formula (V),

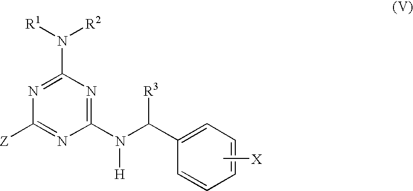

in which

R¹ is hydrogen or unsubstituted or hydroxyl-, cyano-, halogen- or C₁-C₄-alkoxy-substituted alkyl having 1 to 6 carbon atoms, R² is hydrogen, formyl, in each case unsubstituted or cyano-, halogen- or C₁-C₄-alkoxy-substituted alkyl, alkylcarbonyl, alkoxycarbonyl or alkylsulfonyl having in each case 1 to 6 carbon atoms in the alkyl groups, or is unsubstituted or cyano-, halo-C₁-C₄-alkyl-, C₁-C₄-alkoxy-, halo-C₁-C₄-alkoxy- or C₁-C₄-alkoxy-carbonyl-substituted phenylcarbonyl, naphthylcarbonyl, phenylsulfonyl or naphthylsulfonyl,

R³ is unsubstituted or cyano-, halogen- or (C₁-C₄)-alkoxy-substituted alkyl having 1 to 6 carbon atoms or is unsubstituted or cyano-, halogen- or C₁-C₄-alkyl-substituted cycloalkyl having 3 to 6 carbon atoms,

X is a substituent selected from the group below:

hydroxyl, cyano, nitro, halogen, in each case unsubstituted or hydroxyl-, cyano- or halogen-substituted alkyl or alkoxy having in each case 1 to 6 carbon atoms, in each case unsubstituted or halogen-substituted alkylcarbonyl, alkoxycarbonyl, alkylthio, alkylsulfinyl or alkylsulfonyl having in each case 1 to 6 carbon atoms in the alkyl groups, in each case unsubstituted or hydroxyl-, cyano-, nitro-, halogen-, C₁-C₄-alkyl, C₁-C₄-haloalkyl-, C₁-C₄-alkoxy or C₁-C₄-haloalkoxy-substituted phenyl or phenoxy, and

Z is hydrogen, hydroxyl, halogen, is in each case unsubstituted or hydroxyl-, cyano-, nitro-, halogen-, C₁-C₄-alkoxy-, C₁-C₄-alkyl-carbonyl-, C₁-C₄-alkoxy-carbonyl-, C₁-C₄-alkylthio-, C₁-C₄-alkylsulfinyl- or C₁-C₄-alkylsulfonyl-substituted alkyl, alkoxy, alkylcarbonyl, alkoxycarbonyl, alkylthio, alkylsulfinyl or alkylsulfonyl, having in each case 1 to 6 carbon atoms in the alkyl groups, is in each case unsubstituted or halogen-substituted alkenyl or alkynyl having in each case 2 to 6 carbon atoms or is unsubstituted or cyano-, halogen- or C₁-C₄-alkyl-substituted cycloalkyl having 3 to 6 carbon atoms,

5. Compounds of the formula (VI) and their salts

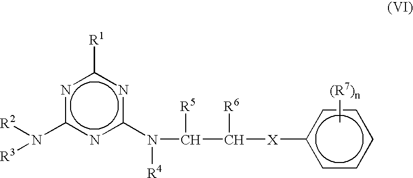

in which

R¹ is (C₁-C₆)-alkyl, which is unsubstituted or substituted by one or more radicals selected from the group consisting of halogen, hydroxyl, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-C₄)-alkynyl and unsubstituted or substituted phenyl, or phenyl, which is unsubstituted or substituted,

R² and R³ in each case independently of one another are hydrogen, amino, (C₁-C₆)-alkyl-amino or di-[(C₁-C₆)-alkyl]-amino, a hydrocarbon radical or a hydrocarbonoxy radical having in each case 1 to 10 carbon atoms, a heterocyclyl radical, heterocyclyloxy radical or heterocyclylamino radical having in each case 3 to 9 ring atoms and 1 to 3 hetero ring atoms selected from the group consisting of N, O and S, where each of the five last-mentioned radicals is unsubstituted or substituted, or an acyl radical or

R² and R³ together with the nitrogen atom of the group NR²R³ are a heterocyclic radical having 3 to 6 ring atoms and 1 to 4 hetero ring atoms, where any hetero ring atoms present in addition to the nitrogen atom are selected from the group consisting of N, O and S and the radical is unsubstituted or substituted,

R⁴ is hydrogen, amino, (C₁-C₆)-alkylamino, di-[(C₁-C₆)-alkyl]-amino, a hydrocarbon radical or hydrocarbonoxy radical having in each case 1 to 10 carbon atoms or a heterocyclyl radical, heterocyclyloxy radical or heterocyclylamino radical having in each case 3 to 9 ring atoms and 1 to 3 hetero ring atoms selected from the group consisting of N, O and S, where each of the five last-mentioned radicals is unsubstituted or substituted, or an acyl radical,

R⁵ and R⁶ in each case independently of one another are halogen, nitro, cyano, thiocyanato or a radical of the formula —X¹-A¹, in which X¹ is a direct bond or a divalent group of the formula —O—, —S(O)ₚ—O—, —O— S(O)ₚ—, —CO—, —O—CO—, —CO—O—, —NR′—, —O—NR′—, —NR′—O—, —NR′—CO— or —CO—NR′—, where in the formulae p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms, and in which A¹ is hydrogen or a hydrocarbon radical or a heterocyclic radical, where each of the two last-mentioned radicals is unsubstituted or substituted, or

R⁵ and R⁶ together are an alkylene chain having 2 to 4 carbon atoms which is unsubstituted or substituted by one or more radicals selected from the group consisting of halogen, (C₁-C₄)-alkyl and oxo,

R⁷, independently of other radicals R⁷, is in each case halogen, nitro, cyano, thiocyanato or a radical of the formula —X²-A², in which X² is a direct bond or a divalent group of the formula —O—, —S(O)_{q}—, —S(O)_{q}—O—, —O—S(O)_{q}—, —CO—, —O—CO—, —CO—O—, —NR″—, —O—N—R″—, —NR″—O—, —NR″—CO— or —CO—NR″—, where in the formulae q=0, 1 or 2 and R″=hydrogen, (C₁-C₆)-alkyl, phenyl, (C₃-C₆)-cycloalkyl, and in which A² is hydrogen or a hydrocarbon radical or a heterocyclic radical, where each of the two last-mentioned radicals is unsubstituted or substituted,

or two adjacent radicals R⁷ together are a fused-on cycle having 4 to 6 ring atoms which is carbocyclic or contains hetero ring atoms selected from the group consisting of O, S and N and which is unsubstituted or substituted by one or more radicals selected from the group consisting of halogen, (C₁-C₄)-alkyl and oxo,

X is a group of the formula —O—, —S(O)ᵣ—, —NR*— or —N(O)—, where r=0, 1 or 2 and R* is hydrogen or alkyl having 1 to 4 carbon atoms, and

n is 0, 1, 2, 3, 4 or 5,

where the grouping —CHR⁵—CHR⁶— has to contain at least 4 carbon atoms if X is —O—;

6. 2,4-amino-1,3,5-triazines of the formula (VII), if appropriate also in their salt form

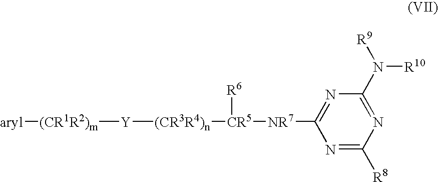

in which

aryl is an unsubstituted or substituted mono- or bicyclic aromatic radical having 5 to 14 ring atoms, 1, 2, 3 or 4 of which, in each case independently of one another, can be from the group consisting of oxygen, sulfur and nitrogen;

—Y— is a divalent unit selected from the group consisting of —O—, —S—, —NR¹¹—, —NR¹²CONR¹³—, —CO₂—, —OCO₂—, —OCONR¹⁴—, —SO—, —SO₂—, —SO₂O—, —OSO₂O—, —SO₂NR¹⁴—, —O—NR¹¹, —NR′—NR″—, in which R′ and R″ independently of one another are defined as R¹⁴, and —(Y′—CR^{a}R^{b}—CR^{c}R^{d})ᵢ—Y″, in which Y′ and Y″ independently of one another are O, S, NH or N[(C₁-C₄)-alkyl], R^{a}, R^{b}, R^{c} and R^{d} in each case independently of one another are H or (C₁-C₄)-alkyl and i is an integer from 1 to 5, or a trivalent unit of the formula —O—N═,

m is 0, 1, 2, 3, 4 or 5,

n is an integer from 1 to 10, with the proviso that n is not 1 if m is zero and —Y— is —O—, —S—, —SO—, —SO₂— or —NR¹¹—;

R¹, R² in each case independently of one another are a radical of a group G1 comprising hydrogen, (C₁-C₁₀)-alkyl, (C₂-C₈)-alkenyl, (C₂-C₈)-alkynyl, (C₁-C₁₀)-alkoxy, (C₃-C₈)-cycloalkyl, (C₃-C₈)-cycloalkoxy, aryl-(C₁-C₆)-alkyl and (C₃-C₈)-cycloalkyl-(C₁-C₆)-alkyl, where in each case the cyclic moiety of the four last-mentioned radicals is unsubstituted or substituted by one or more identical or different radicals selected from the group consisting of halogen, nitro, cyano, thiocyanato and —B—X¹, where —B— and X¹ are as defined below, and where in each case the noncyclic moiety of the eight last-mentioned radicals of group G1 is unsubstituted or substituted by one or more identical or different radicals selected from the group consisting of halogen, nitro, cyano, thiocyanato and —B—X², where X² is as defined below, and where in each case the noncyclic moiety of the radicals of group G1 may be interrupted by one or more identical or different heteroatoms selected from the group consisting of oxygen and sulfur,

R¹ and R² of a (CR¹R²) group form, together with the carbon atom that carries them, a carbonyl group, a group CR¹⁵R¹⁶ or a 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or

two R¹ of two directly or not directly adjacent (CR¹R²) groups form, together with the carbon atoms that carry or link them, an unsubstituted or substituted 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or

two R¹ of two directly adjacent (CR¹R²) groups, together with the bond between the carbon atoms of the groups, are a double bond, or two R¹ and two R² of two directly adjacent (CR¹R²) groups, together with the bond between the carbon atoms of the groups, are a triple bond, or

R¹ is a binding site for the double bond in the case that Y is a trivalent unit ═N—O— adjacent to a CR¹R² group,

R³, R⁴ in each case independently of one another are a radical of a group G2 comprising hydrogen, (C₁-C₁₀)-alkyl, (C₂-C₈)-alkenyl, (C₂-C₈)-alkynyl, (C₁-C₁₀)-alkoxy, (C₁-C₁₀)-alkylthio, (C₁-C₁₀)-alkylsulfinyl, (C₁-C₁₀)-alkylsulfonyl, (C₃-C₈)-cycloalkyl, (C₃-C₈)-cycloalkoxy, aryl, aryl-(C₁-C₆)-alkyl, aryl-(C₁-C₆)-alkoxy, (C₃-C₈)-cycloalkyl-(C₁-C₆)-alkyl, (C₃-C₈)-cycloalkyl-(C₁-C₆)-alkoxy, (C₃-C₈)-cycloalkoxy-(C₁-C6)-alkyl and (C₃-C₈)-cycloalkoxy-(C₁-C₆)-alkoxy, where in each case the cyclic moiety of the nine last-mentioned radicals is unsubstituted or substituted by one or more identical or different radicals selected from the group consisting of halogen, nitro, cyano, thiocyanato und —B—X¹, where —B— and X¹ are as defined below, and where in each case the noncyclic moiety of the sixteen last-mentioned radicals of group G2 is unsubstituted or substituted by one or more identical or different radicals selected from the group consisting of halogen, nitro, cyano, thiocyanato and —B—X², where X² is as defined below, and where in each case the noncyclic moiety of the radicals of group G2 may be interrupted by one or more identical or different heteroatoms selected from the group consisting of oxygen and sulfur, or

R³ and R⁴ form, together with the carbon atom that carries them, a carbonyl group, a group CR¹⁵R¹⁶ or a 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or

two R³ of two directly or not directly adjacent (CR³R⁴) groups form, together with the carbon atoms that carry or link them, an unsubstituted or substituted 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or two R³ of two directly adjacent (CR³R⁴) groups, together with the bond between the carbon atoms of the groups, are a double bond, or two R³ and two R⁴ of two directly adjacent (CR³R⁴) groups, together with the bond between the carbon atoms of the groups, are a triple bond, or

R³ is a binding site for the double bond in the case that Y is a trivalent unit —O—N═ adjacent to a CR³R⁴ group,

—B— is a direct bond or a divalent unit selected from the group consisting of —O—, —S—, —NR¹¹—, —NR¹²CONR¹³—, —CO₂—, —OCO₂—, —OCONR¹⁴—, —SO—, —SO₂—, —SO₂O—, —OSO₂O— and —SO₂NR¹⁴—;

X¹ is hydrogen, (C₁-C₈)-alkyl, (C₂-C₈)-alkenyl, (C₂-C₈)-alkynyl, (C₃-C₈)-cycloalkyl or heterocyclyl having 3 to 9 ring atoms, 1, 2 or 3 of which are from the group consisting of nitrogen, oxygen and sulfur, where the five last-mentioned radicals are unsubstituted or substituted by one or more identical or different halogen atoms;

X² is hydrogen or heterocyclyl having 3 to 9 ring atoms, 1, 2 or 3 of which are from the group consisting of nitrogen, oxygen and sulfur, which heterocyclyl is unsubstituted or substituted by one or more identical or different halogen atoms;

R⁵, R⁶ in each case independently of one another are a radical of group G2, or

R³and R⁵ of two directly or not directly adjacent (CR³R⁴) and (CR⁵R⁶) groups form, together with the carbon atoms linking them, an unsubstituted or substituted 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or

R⁵and R⁶ form, together with the carbon atom that carries them, a carbonyl group, a group CR¹⁵R¹⁶ or a 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or

R⁶ is heterocyclyl;

R⁷ is hydrogen, amino, alkylcarbonyl, alkylamino or dialkylamino having in each case one to six carbon atoms in the alkyl, radical, an acyclic hydrocarbon or hydrocarbonoxy radical having in each case one to six carbon atoms, a cyclic hydrocarbon or hydrocarbonoxy radical having in each case three to six carbon atoms or heterocyclyl, heterocyclyloxy or heterocyclylamino having in each case three to six ring atoms and one to three hetero ring atoms selected from the group consisting of nitrogen, oxygen and sulfur, where each of the ten last-mentioned radicals is unsubstituted or substituted by one or more identical or different radicals selected from the group consisting of halogen, (C₁-C₄)-alkoxy, halo-(C₁-C₄)-alkoxy, (C₁-C₄)-alkylthio, (C₂-C₄)-alkenyl, (C₂-C₄)-alkynyl, (C₂-C₄)-alkenyloxy, (C₂-C₄)-alkynyloxy, hydroxyl, amino, acylamino, alkylamino, dialkylamino, nitro, carboxyl, cyano, azido, (C₁-C₄)-alkoxycarbonyl, (C₁-C₄)-alkylcarbonyl, formyl, carbamoyl, mono- and di-(C₁-C₄)-alkyl)-aminocarbonyl, (C₁-C₄)-alkylsulfinyl, halo-(C₁-C₄)-alkylsulfinyl, (C₁-C₄)-alkylsulfonyl, halo-(C₁-C₄)-alkylsulfonyl and, in the case of cyclic radicals, also (C₁-C₄)-alkyl and halo-(C₁-C₄)-alkyl;

R⁸ is (C₁-C₁₀)-alkyl, (C₂-C₈)-alkenyl, (C₂-C₈)-alkynyl, which are unsubstituted or substituted by one or more identical or different radicals selected from the group consisting of halogen, cyano, nitro, thiocyanato, hydroxyl, (C₁-C₄)-alkoxy, (C₁-C₄)-alkylthio, (C₁-C₄)-alkylsulfinyl, (C₁-C₄)-alkylsulfonyl, phenyl, (C₃-C₉)-cycloalkyl, (C₃-C₉)-cycloalkoxy and heterocyclyl having three to six ring atoms and one to three hetero ring atoms selected from the group consisting of oxygen, nitrogen and sulfur, which heterocyclyl is unsubstituted or substituted by one or more identical or different radicals selected from the group consisting of halogen, amino, (C₁-C₄)-alkyl, (C₁-C₄)-alkoxy, halo-(C₁-C₄)-alkyl and halo-(C₁-C₄)-alkoxy, (C₃-C₈)-cycloalkyl, (C₃-C₈)-cycloalkoxy or a heterocyclyl radical having three to six ring atoms, where these three last-mentioned radicals are unsubstituted or substituted by one or more identical or different radicals selected from the group consisting of halogen, nitro, cyano, thiocyanato, (C₁-C₄)-alkyl, (C₁-C₄)-alkoxy, halo-(C₁-C₄)-alkyl and halo-(C₁-C₄)-alkoxy;

R⁹, R¹⁰ in each case independently of one another are hydrogen, amino, (C₁-C₁₀)-alkylcarbonyl, (C₁-C₁₀)-alkylamino, di-[(C₁-C₁₀)-alkyl]amino, (C₁-C₁₀)-alkyl, (C₃-C₈)-cycloalkyl, (C₁-C₁₀)-alkoxy, (C₃-C₈)-cycloalkoxy, heterocyclyl, heterocyclyloxy or heterocyclylamino having in each case 3 to 6 ring atoms and 1 to 3 hetero ring atoms selected from the group consisting of oxygen, nitrogen and sulfur, where each of the ten last-mentioned radicals is unsubstituted or substituted, or

R⁹ and R¹⁰ form, together with the nitrogen atom that carries them, a heterocycle having a total of three to six ring atoms, one to four of which are hetero ring atoms, where any further hetero ring atoms present in addition to the nitrogen atom are selected from the group consisting of oxygen, nitrogen and sulfur and where this heterocycle is unsubstituted or substituted;

R¹¹ is hydrogen, amino, (C₁-C₁₀)-alkylamino, di-[(C₁-C₁₀)-alkyl]amino, (C₁-C₁₀)-alkyl, (C₃-C₈)-cycloalkyl, (C₃-C₈)-cycloalkyl-(C₁-C₆)-alkyl, (C₁-C₁₀)-alkoxy, (C₁-C₆)-alkoxy-(C₁-C₆)-alkoxy, (C₃-C₈)-cycloalkoxy, (C₁-C₁₀)-alkylcarbonyl, where the nine last-mentioned radicals are unsubstituted or substituted;

R¹², R¹³ in each case independently of one another are hydrogen, (C₁-C₁₀)-alkyl, (C₂-C₈)-alkenyl, (C₂-C₈)-alkynyl, phenyl, phenyl-(C₁-C₆)-alkyl, (C₃-C₈)-cycloalkyl, (C₃-C₈)-cycloalkyl-(C₁-C₆)-alkyl, where in each case the cyclic moiety of the four last-mentioned radicals is unsubstituted or substituted by one or more identical or different radicals selected from the group consisting of (C₁-C₄)-alkyl, halo-(C₁-C₄)-alkyl, (C₁-C₄)-alkoxy and halo-(C₁-C₄)-alkoxy, or

R¹² and R¹³ form, together with the N-CO-N group that carries them, a 5- to 8-membered ring which, in addition to the two nitrogen atoms mentioned, may contain a further heteroatom selected from the group consisting of oxygen, nitrogen and sulfur and which is unsubstituted or substituted,

R¹⁴ is hydrogen or in each case unsubstituted or substituted (C₁-C₁₀)-alkyl or (C₃-C₁₀)-cycloalkyl and

R¹⁵, R¹⁶ in each case independently of one another are hydrogen, aryl (C₁-C₁₀)-alkoxy, aryl-(C₁-C₆)-alkyl, (C1-C₁₀)-alkyl, (C₁-C₁₀)-alkylthio, where the five last-mentioned radicals are unsubstituted or substituted, and where the aliphatic carbon skeleton of the three last-mentioned radicals may be interrupted by one or more identical or different heteroatoms selected from the group consisting of oxygen and sulfur, or

R¹⁵ and R¹⁶ form, together with the carbon atom that carries them, a 3- to 6-membered ring which optionally contains one or two identical or different heteroatoms selected from the group consisting of oxygen, nitrogen and sulfur and which is unsubstituted or substituted;

7. Substituted 2-amino-4-alkylamino-1,3,5-triazines of the formula (VIII)

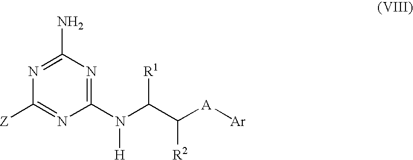

in which

R¹ is in each case unsubstituted or substituted alkyl having 2 to 6 carbon atoms or cycloalkyl having 3 to 6 carbon atoms,

R² is hydrogen or is alkyl having 1 to 4 carbon atoms, A is oxygen or methylene,

Ar is in each case unsubstituted or substituted phenyl, naphthyl or heterocyclyl, and

Z is hydrogen, is halogen or is in each case unsubstituted or substituted alkyl, alkoxy, alkylcarbonyl, alkoxycarbonyl, alkylthio, alkylsulfinyl, alkylsulfonyl, alkenyl or alkynyl;

8. 2,4-amino-1,3,5-triazines of the formula (IX), if appropriate also in their salt form,

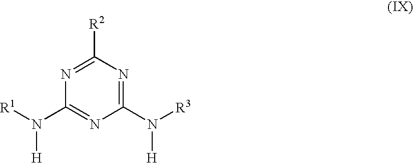

in which

R¹ is hydrogen or is unsubstituted or substituted alkyl, alkylcarbonyl, alkoxycarbonyl, alkenylcarbonyl or alkynylcarbonyl;

R² is hydrogen or is in each case unsubstituted or substituted alkenyl or alkynyl, and

R³ is the grouping -A-Z; in which

A is unsubstituted or substituted straight-chain or branched alkanediyl which optionally contains, at the beginning or at the end or within the alkanediyl chain, a heteroatom (group) selected from the group consisting of O, S, NH and alkylimino, and

Z is an unsubstituted or substituted monocyclic or bicyclic, carbocyclic or heterocyclic grouping selected from the group consisting of cyclopentyl, cyclohexyl, phenyl, naphthyl, tetralinyl, decalinyl, indanyl, indenyl, furyl, benzofuryl, dihydrobenzofuryl, thienyl, benzothienyl, dihydrobenzothienyl, isobenzofuryl, dihydroisobenzofuryl, isobenzothienyl, dihydroisobenzothienyl, pyrrolyl, indolyl, isoindolyl, indolinyl, isoindolinyl, benzodioxolyl, oxazolyl, benzoxazolyl, thiazolyl, benzothiazolyl, indazolyl, oxadiazolyl, thiadiazolyl, pyrazolyl, pyridinyl, pyrimidinyl, pyrazinyl, pyridazinyl, quinolyl, isoquinolyl, quinoxalinyl, cinnolinyl and phathalazinyl.

Particularly preferred aminotriazines of the formula (I) to be used according to the invention are those of the formula (X)

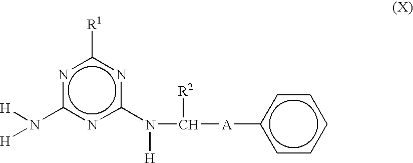

in which

R¹ is (C₁-C₄)-alkyl or (C₁-C₄)-haloalkyl;

R² is (C₁-C₄)-alkyl, (C₃-C₆)-cycloalkyl or (C₃-C6)-cycloalkyl-(C₁-C₄)-alkyl and

A is —CH₂—, —CH₂—CH₂—, —CH₂—CH₂—CH₂—, —O—, —CH₂—CH₂—O—, —CH₂—CH₂—CH₂—O—.

Halogen is preferably chlorine, bromine and iodine; in haloalkyl, halogen is preferably fluorine.

R¹ is preferably —CF(CH₃)₂,

R² is preferably (C₁-C₄)-alkyl or (C₃-C₄)-cycloalkyl.

A is preferably —CH₂—, —CH₂—CH₂— or —CH₂—CH₂—CH₂—.

Particularly preferred compounds of the formula (X) are the compounds (A1), (A2), (A3), (A4), (A5), (A6), (A7):

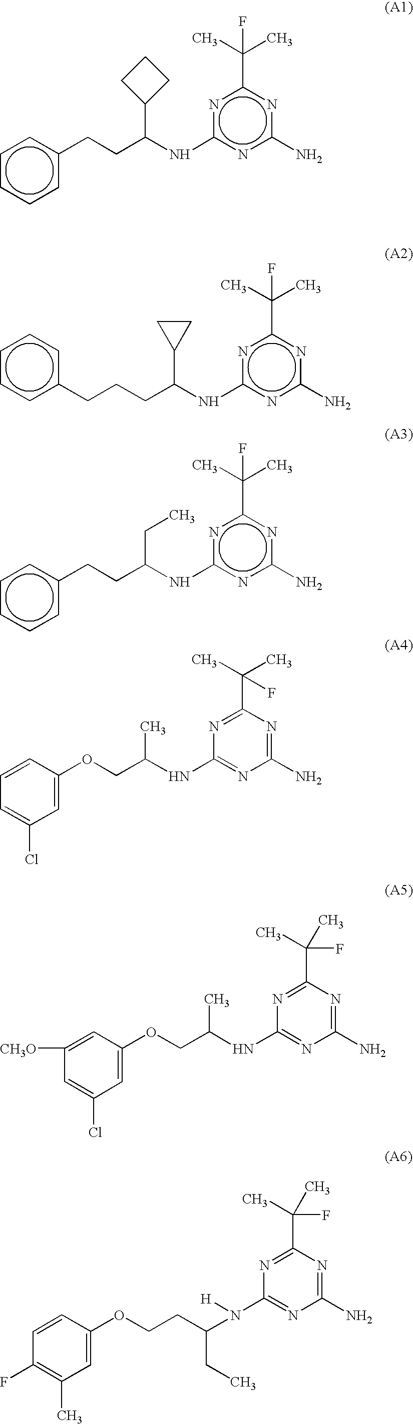

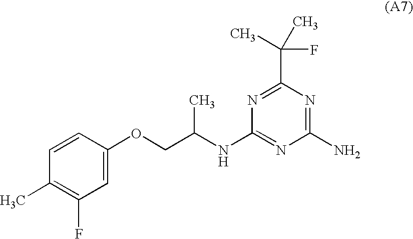

Aminotriazines of the formula (I) are known. The preparation of such compounds is described, for example, in the publications below, or it can be carried out, for example, by the methods described in these publications:

WO-A 97/08 156 (compounds of the formula (II)),

DE-A 198 26 670 (compounds of the formula. (III)),

WO-A 97/31 904 (compounds of the formula (IV)),

WO-A 98/15 536 (compounds of the formula (V)),

WO-A 98/34 925 (compounds of the formula (VI)),

DE-A 198 25 519 (compounds of the formula (VlI)),

WO-A-98/15 537 (compounds of the formula (VII)),

WO-A-99/19309 (compounds of the formula (IX)),

Suitable aminotriazines (I) or salts thereof are furthermore the compounds listed in the publications WO-A-98/42684, WO-A-99/18100, WO-A-99/19309 and WO-A-99/37627.

For the preferred compounds, their preparation and general conditions for their use and in particular for specific example compounds, reference is made to the descriptions of the publications mentioned, and these descriptions are inasmuch part of the present invention.

The active compounds (A) are suitable for controlling weeds in a number of crops, for example in crops of economical importance, such as cereals (wheat, barley, rye, rice, corn), sugar beet, sugar cane, oilseed rape, cotton and soy. Of particular interest is the use in cereals such as wheat and corn, in particular corn. These crops are also preferred for the combinations (A)+(B).

Suitable combination partners (B) are, for example, one or more of the following compounds of subgroups (B1) to (B4) (in most cases, the herbicides are referred to by the common name, in accordance with the reference “The Pesticide Manual” 11th Ed., British Crop Protection Council 1997, abbreviated “PM”.

(B1) foliar- and/or soil-acting herbicides which are active against monocotyledonous harmful plants, preferably

(B1.1) ureas which are predominantly soil-acting, such as

(B1.1.1) isoproturon (PM, p. 732-734), i.e. 3-(4-isopropylphenyl)-1,1-dimethylurea and/or

(B1.1.2) chlorotoluron (PM, p. 229-231), i.e. 3-(3-chloro-p-tolyl)-1,1-dimethylurea and/or

(B1.2) compounds of various structures, which are predominantly soil-acting, such as

(B1.2.1) fluthiamide (=flufenacet, see PM, p. 82-83), i.e. 4′-fluoro-N-isopropyl-2-(5-trifluoromethyl-1,3,4-thiadiazol-2-yloxy)acet-anilide and/or

(B1.2.2) pendimethalin (PM, p. 937-939), i.e. N-(1-ethylpropyl)-2,6-di-nitro-3,4-xylidine and/or

(B1.2.3) prosulfocarb (PM, p. 1039-1041), i.e. s-benzyl dipropylthio-carbamate and/or

(B1.3) 2-(4-heteroaryl- or 4-aryloxyphenoxy)propionic acids which are predominantly foliar-acting, such as

(B1.3.1) clodinafop-propargyl (PM, p. 251-253), i.e. prop-2-ynyl (R)-2-[4-[(5-chloro-3-fluoro-2-pyridinyl)oxy]phenoxy]propanoate and/or

(B1.3.2) diclofop-methyl (PM, p. 374-377), i.e. methyl (RS)-2-[4-(2,4-dichlorophenoxy)phenoxy]propanoate and/or

(B1.3.3) fenoxaprop-P-ethyl (PM, p. 519-520), i.e. ethyl (R)-2-[4-[(6-chloro-2-benzoxazolyl)oxy]phenoxy]propanoate, also in the form of the mixtures of the optical isomers, for example the racemic mixture fenoxaprop-ethyl and/or

(B1.3.4) quizalofop-P and its esters, such as the ethyl or tefuryl ester (PM, p. 1089-1092), also in the form of the mixtures of the optical isomers, for example the racemic mixture quizalofop and its esters and/or

(B1.3.5) fluazifop-P and its esters, such as the butyl ester (PM, p. 556-557), also in the form of the mixtures of the optical isomers, for example the racemic mixture fluazifop-butyl and/or

(B1.3.6) haloxyfop and haloxyfop-P and their esters, such as the methyl or the etotyl ester (PM, p. 660-663) and/or

(B1.3.7) propaquizafop (PM, p. 1021-1022) and/or

(B1.3.8) cyhalofop and its esters, such as the butyl ester (PM, p. 297-298) (=(R)-2-[4-(4-cyano-2-fluorophenoxy)phenoxy]propionic acid or butyl (R)-2-[4-(4-cyano-2-fluorophenoxy)phenoxy]-propanoate) and/or

(B1.4) cyclohexanedione oximes which are predominantly foliar-acting, such as

(B1.4.1) sethoxydim (PM, p. 1101-1103), i.e. (E,Z)-2-(1-ethoxyimino-butyl)-5-[2-(ethylthio)propyl]-3-hydroxycyclohex-2-enone, and/or

(B1.4.2) cycloxydim (PM, p. 290-291), i.e. 2-(1-ethoxyiminobutyl)-3-hydroxy-5-thian-3-ylcyclohex-2-enone, and/or

(B1.4.3) clethodim (PM, p. 250-251), i.e. 2-{(E)-1-[(E)-3-chloroallyloxy-imino]propyl}-5[-2-(ethylthio)propyl]-3-hydroxycyclohex-2-en-one and/or

(B1.4.4) clefoxidim or “BAS 625 H” (see AG Chem New Compound Review, Vol. 17, 1999, p. 26, published by Agranova) (=2-[1-2-(4-chlorophenoxy)propoxyimino)butyl]-3-oxo-5-thion-3-yl-cyclohex-1-enol).

(B1.4.5) tralkoxidim (PM, p. 1211-1212), i.e. 2-[1-(ethoxyimino)propyl]-3-hydroxy-5-mesitylcyclohex-2-enone, and/or

(B1.5) chloroacetamides which are predominantly soil-acting, such as

(B1.5.1) dimethenamid (PM, p. 409-410), i.e. 2-chloro-N-(2,4-dimethyl-3-thienyl)-N-(2-methoxy-1-methylethyl)acetamide, and/or

(B1.5.2) penthoxamid, i.e. 2-chloro-N-(2-ethoxyethyl)-N-(2-methyl-1-phenyl-1-propenyl)acetamide (TKC-94, known from AG Chem New Compound, Review Vol. 17 (1999), EP-A-206 251), and/or

(B1.5.3) butachlor (PM, p. 159-160), i.e. N-(butoxymethyl)-2-chloro-N-(2,6-diethylphenyl)acetamide, and/or

(B1.5.4) pretilachlor (PM, p. 995-996), i.e. 2-chloro-N-(2,6-diethyl-phenyl)-N-(propoxyethyl)acetamide, and/or

(B1.6) compounds having various structures and foliar and/or soil action, such as

(B1.6.1) imazamethabenz-methyl (PM, p. 694-696), i.e. methyl (±)-2-(4-isopropyl-4-methyl-5-oxo-2-imidazolin-2-yl)para- and -meta-toluate, and/or

(B1.6.2) simazin (PM, p. 1106-1108), i.e. 6-chloro-N,N′-diethyl-2,4-diamino-1,3,5-triazine, and/or

(B1.6.3) molinate (PM, p. 847-849), i.e. S-ethyl azepane-1-thiocarboxylate, and/or

(B1.6.4) thiobencarb (benthiocarb) (PM, p.1192-1193), i.e. S-4-chloro-benzyl diethylthiocarbamate, and/or

(B1.6.4) MY 100, i.e. 3-[1-(3,5-dichlorophenyl)-1,1-dimethyl]-6-methyl-5-phenyl-2H,3H-1,3-oxazin-4-one (from Rhone Poulenc), and/or

(B1.6.5) anilofos (PM, p.47-48), i.e. S-4-chloro-N-isopropylcarbaniloyl-methyl O,O-dimethyl dithiophosphate, and/or

(B1.6.6) cafenstrole (CH 900) (PM, p. 173-174), i.e. N,N-diethyl-3-mesitylsulfonyl-1H-1,2,4-triazole-1-carboxamide, and/or

(B1.6.7) mefenacet (PM, p. 779-781), i.e. 2-(1,3-benzothiazol-2-yloxy)-N-methylacetanilide, and/or

(B1.6.8) fentrazamid (NBA 061), i.e. N-cyclohexyl-N-ethyl-4-(2-chloro-phenyl)-5-oxo-4,5-dihydrotetrazole-1-carboxamide, and/or

(B1.6.9) thiazopyr (PM, p. 1185-1187), i.e. methyl 2-difluoromethyl-5-(4,5-dihydro-1,3-thiazol-2-yl)-4-isobutyl-6-trifluoromethyInicotinate, and/or

(B 1.6.10) oxadiazon (PM. p. 905-907), i.e. 3-tert-butyl-3-(2,4-dichloro-5-isopropoxyphenyl)-1,3,4-oxadiazol-2(3H)-one, and/or

(B1.6.11) esprocarb (PM, p. 472-473), i.e. S-benzyl 1,2-dimethylpropyl-(ethyl)thiocarbamate, and/or

(B1.6.12) pyributicarb (PM, p. 1060-1061), i.e. O-3-tert-butylphenyl 6-(methoxy-2-pyridyl(methyl)thiocarbamate, and/or

(B1.6.13) azimsulfuron (PM, p. 63-65), i.e. 1-(4,6-dimethoxypyrimidin-2-yl)-3-[1-methyl-4-(2-methyl-2H-tetrazol-5-yl)pyrazol-5-yl-sulfonyl]urea, and/or

(B1.6.14) azoles, such as those known from EP-A-0663913, for example AEB391, i.e. 1-(3-chloro-4,5,6,7-tetrahydropyrazolo-[1,5-a]pyridin-2-yl)-5-methylpropargylamino)-4-pyrazolyl-carbonitrile, and/or

(B1.6.15) thenylchlor (PM, p. 1182-1183), i.e. 2-chloro-N-(2,6-dimethyl-phenyl)-N[(3-methoxy-2-thienyl)methyl]acetamide, and/or

(B1.6.16) pentoxazone (KPP 314) (PM, p. 942-943), i.e. 3-(4-chloro-5-cyclopentyloxy-2-fluorophenyl)-5-isopropylidene-1,3-oxazol-idine-2,4-dione, and/or

(B1.6.17) pyriminobac, pyriminobac-methyl (KIH 6127) (PM, p. 1071-1072), i.e. 2-(4,6-dimethoxy-2-pyrimidinyloxy)-6-(1 -methoxy-iminoethyl)benzoic acid), and its salts and esters, such as the methyl ester, and/or

(B1.6.18) flucarbazone and its salts, such as flucarbazone sodium salt (BAY MKH 6562, known from AG Chem New Compound, Review Vol. 17 (1999), page 28 and EP-A-507171), i.e. 1H-1,2,4-triazole-1 -carboxamide-4,5-dihydro-3-methoxy-4-methyl-5-oxo-N-[[2-(trifluoromethoxy)phenyl]sulfonyl] sodium salt, preferably in amounts of 5-100, in particular 10-80, g of a.s./ha, and/or

(B1.6.19) procarbazone (BAY MKH 6561, known from AG Chem New Compound, Review Vol. 17 (1999), page 27 and EP-A-507171), i.e. methyl 2-[[[(4,5-dihydro-4-methyl-5-oxo-3-propoxy-1H-1,2,4-triazol-1-yl)carbonyl]amino]sulfonyl]benzoate, and its salts, preferably in amounts of 10-150, in particular 50-120, 9 of a.s./ha and/or

(B2) herbicides which are predominantly active against dicotyledonous plants, preferably

(B2.1) sulfonylureas, such as

(B2.1.1) tribenuron-methyl (PM, p. 1230-1232), i.e. methyl 2-[4-methoxy-6-methyl-1,3,5-triazin-2-yl(methyl)carbamoylsulfamoyl]benzoate, and/or

(B2.1.2) thifensulfuron and its esters, preferably the methyl ester (PM, p. 1188-1190), i.e. 3-[[[(4-methoxy-6-methyl-1,3,5-triazin-2-yl)amino]carbonyl]amino]sulfonyl]-2-thiophenecarboxylic acid or methyl 3-[[[(4-methoxy-6-methyl-1,3,5-triazin-2-yl)amino]-carbonyl]amino]sulfonyl]-2-thiophenecarboxylate and its salts, and/or

(B2.1.3) prosulfuron (PM, p. 1041-1043), i.e. 1-(4-methoxy-6-methyl-1,3,5-triazin-2-yl)-3-[2-(3,3,3-trifluoropropyl)phenylsulfonyl]-urea and its salts, and/or

(B2.1.4) amidosulfuron (PM, p. 37-38), i.e. 1-(4,6-dimethoxypyrimidin-2-yl)-3-mesyl(methyl)sulfamoylurea and its salts, and/or

(B2.1.5) chlorimuron and its esters, such as chlorimuron-ethyl (PM, p. 217-218) (=2-(4-chloro-2-methoxypyrimidin-2-ylcarbamoyl-sulfamoyl-benzoic acid and its esters, such as the ethyl ester) and/or

(B2.1.6) halosulfuron and its esters, such as the methyl ester (PM, p. 657-659), i.e. methyl 3-chloro-5-(4,6-dimethoxypyrimidin-2-ylcarbamoylsulfamoyl)-1-methylpyrazolecarboxylate, also in its salt form, and/or

(B2.1.7) LAB271272, (=tritosulfuron, CAS Reg. No. 142469-14-5; see AG Chem New Compound Review, Vol. 17, 1999, p. 24, published by AGRANOVA), i.e. N-[[[4-methoxy-6-(trifluoro-methyl)-1,3,5-triazin-2-yl)amino]carbonyl]-2-(trifluoromethyl)-benzenesulfonamide), preferably in an amount of 2-250, in particular 10-150, g of a.s./ha, and/or

(B2.1.8) bensulfuron-methyl (PM, p. 104-105), i.e. methyl 2-[[[[[(4,6-dimethoxy-2-pyrimidinyl)amino]carbonyl]amino]sulfonyl]-methyl]benzoate, and/or

(B2.1.9) ethoxysulfuron (PM, p. 488-489), i.e. 1-(4,6-dimethoxypyrimidin-2-yl)-3-(2-ethoxyphenoxysulfonyl)urea, and/or

(B2.1.10) cinosulfuron (PM, p. 248-250), i.e. 1-(4,6-dimethoxy-1,3,5-triazin-2-yl)-3-[2-(2-methoxyethoxy)phenylsulfonyl)urea, and/or

(B2. 1.11) pyrazosulfuron and its esters, such as pyrazosulfuron-ethyl (PM, p. 1052-1054) (=5-(4,6-dimethoxypyrimidin-2-ylcarbamoylsulfamoyl)-1-methylpyrazole-4-carboxylic acid and its salts and esters, such as the ethyl ester), and/or

(B2.1.12) imazosulfuron (PM, p. 703-704), i.e. 1-(2-chloro-imidazo[1,2-a]pyridin-3-ylsulfonyl)-3-(4,6-dimethoxypyrimidin-2-yl)urea, and/or

(B2.1.13) cyclosulfamuron (PM, p. 288-289), i.e. 1-(2-(cyclopropylcarbonyl)phenylsulfamoyl]-3-(4,6-dimethoxypyrimidin-2-yl)urea, and/or

(B2.2) growth regulators (of the auxin type), such as

(B2.2.1) MCPA (PM, p. 767-769), i.e. (4-chloro-2-methylphenoxy)-acetic acid and its salts and esters, and/or

(B2.2.2) 2,4-D (PM, p. 323-327), i.e. 2,4-dichlorophenoxyacetic acid and its salts and esters, and/or

(B2.2.3) dichlorprop (PM, p. 368-370), i.e. (RS)-2-(2,4-dichloro-phenoxy)propionic acid, and/or

(B2.2.4) mecoprop-P (PM, p. 776-779), i.e. (RS)- or (R)-2-(4-chloro-o-tolyloxy)propionic acid, and/or

(B2.2.5) fluoroxypyr (PM, p. 597-600), i.e. 4-amino-3,5-dichloro-6-fluoro-2-pyridyloxyacetic acid, and/or

(B2.2.6) dicamba (PM, p. 356-359), i.e. 3,6-dichloro-o-anisic acid, and/or

(B2.2.7) clopyralid (PM, p. 260-263), i.e. 3,6-dichloro-2-pyridine-carboxylic acid, and/or

(B2.2.8) picloram (PM, p. 977-979), i.e. 4-amino-3,5,6-trichloropicolinic acid, and/or

(B2.3) hydroxybenzonitriles, such as

(B.2.3.1) bromoxynil (PM, p. 149-151), i.e. 3,5-dibromo-4-hydroxybenzonitrile, and/or

(B.2.3.2) ioxynil (PM, p. 718-721), i.e. 4-hydroxy-3,5-diiodobenzonitrile, and/or

(B2.4) diphenyl ethers, such as

(B2.4.1) fluoroglycofen-ethyl (PM, p. 580-582), i.e. O-[5-(2-chloro-α,α,α-trifluoro-p-tolyloxy)-2-nitrobenzoyl]glycolic acid, and/or

(B2.4.2) aclonifen (PM, p. 14-16), i.e. 2-chloro-6-nitro-3-phenoxy-aniline, preferably in an amount of 10-5000, in particular 20-3000, g of a.s./ha, and/or

(B2.4.3) acifluorfen (PM, p. 12-14) and its salts, such as the sodium salt (=5-[2-chloro-4-(trifluoromethyl)phenoxy]-2-nitrobenzoic acid and its salts, such as the Na salt), and/or

(B2.5) [1,2,4]-triazolopyrimidinesulfonamides, such as

(B2.5.1) cloransulam and preferably the methyl ester (PM, p. 165), i.e. 3-chloro-2-(5-ethoxy-7-fluoro-[1,2,4]triazolo-[1,5-c]pyrimidin-2-ylsulfonamido)benzoic acid or methyl 3-chloro-2-(5-ethoxy-7-fluoro-[1,2,4]triazolo-[1,5-c]pyrimidin-2-ylsulfonamido)-benzoate, and/or

(B2.5.2) florasulam, i.e. N-(2,6-difluorophenyl)-8-fluoro-5-methoxy-1,2,4-triazolo[1,5C]-pyrimidine-2-sulfonamide (DE-570, cf. Zeitschrift Pfl. Krankh. PflSchutz, Sonderblatt XVI, 527-534 81998), and/or

(B2.6) compounds of various structures, such as

(B2.6.1) bentazone (PM, p. 109-111), i.e. 3-isopropyl-1H-2,1,3-benzo-thiadiazin-4(3H)-one 2,2-dioxide, and/or

(B2.6.2) bifenox (PM, p.116-117), i.e. methyl 5-(2,4-dichlorophenoxy)-2-nitrobenzoate, and/or

(B2.6.3) carfentrazone-ethyl (PM, p. 191-193), i.e. ethyl (RS)-2-chloro-3-[2-chloro-4-(4-difluoromethyl-4,5-dihydro-3-methyl-5-oxo-1H-1,2,4-triazol-1 -yl)-4-fluorophenyl]propionate, and/or

(B2.6.4) pyraflufen (PM, p. 1048-1049), i.e. 2-chloro-5-(4-chloro-5-difluoromethoxy-1-methylpyrazol-3-yl)-4-fluorophenoxyacetic acid, and/or

(B2.6.5) pyridate (PM, p. 1064-1066), i.e. O-(6-chloro-3-phenylpyridazin-4-yl) S-(octyl) thioformate, and/or

(B2.6.6) linuron (PM, p. 751-753), i.e. 3-(3,4-dichlorophenyl)-1-methoxy-1-methylurea, and/or

(B2.6.7) diflufenzopyr (BASF 654 00 H) (PM, p. 81-82), i.e. 2-{1-[4-(3,5-difluorophenyl)semicarbazone]ethyl}nicotinic acid, and its salts,

(B2.6.8) cinidon-ethyl (BAS 615005, cf. AG Chem New Compound Review Vol. 17 (1999), page 26), preferably in an amount of 5-500, in particular 10-400, g of a.s./ha, and/or

(B2.6.9) clopyralid and its salts and esters (PM, p. 260-263), preferably in an amount of 10-2000, in particular 20-1000, g of a.s./ha,

(B2.6.10) metribuzin (PM, p. 840-841), preferably in an amount of 50-3000, in particular 60-2000, g of a.s./ha, and/or

(B2.6.11) picolinafen, i.e. N-4-fluorophenyl-6-(3-trifluoromethylphen-oxy)pyridine-2-carboxamide (AC 900001, cf. AG Chem New Compound Review Vol. 17 (1999), page 35), preferably in an amount of 1-90, in particular 2-80, g of a.s./ha, and/or

(B2.6.12) clomazone (PM, p. 256-257), preferably in an amount of 50-5000, in particular 100-3000, g of a.s./ha, and/or

(B2.6.13) bromobutide (PM, p. 144-145), i.e. 2-bromo-3,3-dimethyl-N-(1-methyl-1-phenylethyl)butyramide, and/or

(B2.6.14) benfuresate (PM, p. 98-99), i.e. 2,3-dihydro-3,3-dimethyl-benzofuran-5-yl ethanesulfonate, and/or

(B2.6.15) dithiopyr (PM, p. 442-443) (=S,S′-dimethyl 2-difluoromethyl-4-isobutyl-6-trifluoromethylpyridine-3,5-di(thiocarboxylate)), and/or

(B2.6.16) triclopyr, i.e. 3,5,6-trichloro-2-pyridyloxyacetic acid, and its salts and esters, and/or

(B3) herbicides which are active against monocotyledonous and dicotyledonous harmful plants, preferably

(B3.1) sulfonylureas, such as

(B3.1.1) metsulfuron (PM, p. 842-844), i.e. 2-[(4-methoxy-6-methyl-1,3,5-triazin-2-yl)carbamoylsulfamoyl]benzoic acid, and its esters, such as, preferably, the methyl ester methsulfuron-methyl, and/or

(B3.1.2) triasulfuron (PM, p. 1222-1224), i.e. 1 -[2-(2-chloroethoxy)-phenylsulfonyl]-3-(4-methoxy-6-methyl-1,3,5-triazin-2-yl)urea, and/or

(B3.1.3) chlorsulfuron (PM, p. 239-240), i.e. 1-(2-chlorosulfonyl)-3-(4-methoxy-6-methyl-1,3,5-triazin-2-yl)urea, and/or

(B3.1.4) iodosulfuron (proposed common name) and, preferably, the methyl ester (cf. WO 96/41537), i.e. 4-iodo-2-(4-methoxy-6-methyl-1,3,5-triazin-2-ylcarbamoylsulfamoyl)benzoic acid or methyl 4-iodo-2-(4-methoxy-6-methyl-1,3,5-triazin-2-ylcarbamoylsulfamoyl)benzoate, known from WO-A-92/13845, and/or

(B3.1.5) AEF060, i.e. methyl 4-methylsulfonylamino-2-(4,6-dimethoxy-pyrimidin-2-ylcarbamoylsulfamoyl)benzoate, known from WO-A-95/10507, and/or

(B3.1.6) sulfosulfuron (PM, p. 1130-1131), i.e. 1-(4,6-dimethoxypyrimidin-2-yl)-3-(2-ethylsulfonylimidazole[1,2-a]pyridin-3-yl)sulfonylurea, and/or

(B3.1.7) flupyrsulfuron (PM, p. 586-588), i.e. 2-(4,6-dimethoxypyrimidin-2-ylcarbamoylsulfamoyl)-6-trifluoromethyinicotinic acid, preferably the sodium salt of the methyl ester, and/or

(B3.1.8) nicosulfuron (PM, p. 877-879), i.e. 2-(4,6-dimethoxypyrimidin-2-yl)-3-(3-dimethylcarbamoyl-2-pyridylsulfonyl)urea, and/or

(B3.1.9) rimsulfuron (PM, p. 1095-1097), i.e. 1-(4,6-dimethoxypyrimidin-2-yl)-3-(3-ethylsulfonyl-2-pyridylsulfonyl)urea, and/or

(B3.1.10) primisulfuron and esters, such as the methyl ester (PM, p. 997-999), i.e. 2-[4,6-bis(difluoromethoxy)pyrimidin-2-ylcarbamoylsulfamoyl]benzoic acid or methyl 2-[4,6-bis(difluoromethoxy)pyrimidin-2-ylcarbamoylsulfamoyl]-benzoate, and/or

(B3.1.11) AEF360, i.e. 4-formylamino-2-[[(4,6-dimethoxypyrimidin-2-yl)-carbamoyl]sulfamoyl]-N,N-dimethylbenzamide, known from WO-A-9???, and/or

(B3.2) triazine derivatives, such as

(B3.2.1) cyanazine (PM, p. 280-283), i.e. 2-(4-chloro-6-ethylamino-1,3,5-triazin-2-ylamino)-2-methylpropionitrile, and/or

(B3.2.2) atrazin (PM, p. 55-57), i.e. N-ethyl-N′-isopropyl-6-chloro-2,4-diamino-1,3,5-triazine, and/or

(B3.2.3) terbuthylazin (PM, p. 1168-1170), i.e. N-ethyl-N′-tert-butyl-6-chloro-2,4-diamino-1,3,5-triazine, and/or

(B3.2.4) terbutryn (PM, p. 1170-1172), i.e. N-(1,1-dimethylethyl)-N′-ethyl-6-methylthio-2,4-diamino-1,3,5-triazine, and/or

(B3.3) chloroacetamides, such as

(B3.3.1) acetochlor (PM, p. 10-12), i.e. 2-chloro-N-(ethoxymethyl)-N-(2-ethyl-6-methylphenyl)acetamide, and/or

(B3.3.2) metolachlor (PM, p. 833-834), i.e. 2-chloro-N-(2-ethyl-6-methylphenyl)-N-(2-methoxy-1-methylethyl)acetamide, and/or

(B3.3.3) alachlor (PM, p. 23-24), i.e. 2-chloro-N-(2,6-diethylphenyl)-N-(methoxymethyl)acetamide, and/or

(B3.4) compounds of various structures, such as

(B3.4.1) clomazone (PM, p. 256-257), i.e. 2-(2-chlorobenzyl)-4,4-dimethyl-1,2-oxazolidin-3-one, and/or

(B3.4.2) diflufenican (PM, p. 397-399), i.e. 2′,4′-difluoro-2-(α,α,α-trifluoro-m-tolyloxy)nicotinanilide, and/or

(B3.4.3) flumetsulam (PM, p. 573-574), i.e. 2′,6′-difluoro-5-methyl[1,2,4]triazolo[1,5-a]-pyrimidine-2-sulfoanilide, and/or

(B3.4.4) flurtamone (PM, p. 602-603), i.e. (RS)-5-methylamino-2-phenyl-4-(α,α,α-trifluoro-m-tolyl)furan-3(2H)-one, and/or

(B3.4.5) isoxaflutole (PM, p. 737-739), i.e. 5-cyclopropyl-1,2-oxazol-4-yl α,α,α-trifluoro-2-mesyl-p-tolyl ketone, and/or

(B3.4.6) metosulam (PM, p. 836-838), i.e. 2′,6′-dichloro-5,7-dimethoxy-3′-methyl[1,2,4]triazole[1,5-a]pyrimidine-2-sulfoanilide, and/or

(B3.4.7) metribuzin (PM, p. 840-841), i.e. 4-amino-6-tert-butyl-4,5-dihydro-3-methylthio-1,2,4-triazin-5-one, and/or

(B3.4.8) paraquat (salts), for example the dichloride (PM, p. 923-925), i.e. 1,1′-(dimethyl)-4,4′-bipyridinium dichloride or other salts, and/or

(B3.4.9) benoxacor (PM, p.102-103), i.e. 4-dichloroacetyl-3,4-dihydro-3-methyl-2H-1,4-benzoxazine, and/or

(B3.4.10) sulcotrione (PM, p. 1124-1125), i.e. 2-(2-chloro-4-mesyl-benzoyl)cyclohexane-1,3-dione, and/or

(B3.4.1 1) mesotrione, i.e. 2-(4-mesyl-2-nitrobenzoyl)cyclohexane-1,3-dione (ZA1296), cf. Weed Science Society of America (WSSA) in WSSA Abstracts 1999, Vol. 39, pages 65-66, numbers 130-132), and/or

(B3.4.12) quinclorac (PM, p. 1079-1080), i.e. 3,7-dichloroquinoline-8-carboxylic acid, and/or

(B3.4.13) propanil (PM, p. 1017-1019), (=N-(3,4-dichlorophenyl)propanamide), and/or

(B3.4.14) bispyribac, bispyribac-Na (KIH 2023) (PM, p. 129-131), i.e. sodium 2,6-bis-(4,6-dimethoxy-2-pyrimidin-2-yloxy)benzoate, and/or

(B3.4.15) LGC 40863, i.e.pyribenzoxim (=2,6-bis-(4,6-dimethoxy-pyridin-2-yl)-1-[N-(diphenylmethyl)iminooxycarbonyl]benzene, introduced at the Brighton Crop Protection Conference Weeds 1997), and/or

(B3.4.16) oxadiargyl (PM, p. 904-905), i.e. 5-tert-butyl-3-[2,4-dichloro-5-(prop-2-ynyloxy)phenyl]-1,3,4-oxadiazol-2(3H)-one, and/or

(B3.4.17) norflurazon (PM, p. 886-888), i.e. 4-chloro-5-(methylamino)-2-[3-(trifluoromethyl)phenyl]-3-(2H)-pyridazinone, and/or

(B3.4.18) fluometuron (PM, p. 578-579), i.e. N,N-dimethyl-N′-[3-trifluoromethyl)phenyl]urea; and/or

(B3.4.19) methylarsonic acid of the formula CH₃AS(═O)(OH)₂ and its salts, such as DSMA=disodium salt or MSMA=monosodium salt of methylarsonic acid (PM, p. 821-823), and/or

(B3.4.20) prometryn (promethyrin) (PM, p. 1011-1013), i.e. N,N′-bis(1-methylethyl)-6-methylthio)-2,4-diamino-1,3,5-triazine, and/or

(B3.4.21) trifluralin (PM, p. 1248-1250), i.e. 2,6-dinitro-N,N-dipropyl-4-trifluoromethylaniline, and/or

(B4) herbicides which are active against monocotyledonous and dicotyledonous harmful plants and which can be employed specifically in tolerant crops and on non-crop land, preferably

(B4.1) compounds of the type glufosinate or phosphinothricin (=L-glufosinate) and its salts and derivatives, such as

(B4.1.1) glufosinate in a narrow sense (PM, p. 643-645), i.e. D,L-2-amino-4-[hydroxy(methyl)phosphinyl]butanoic acid,

(B4.1.2) glufosinate monoammonium salt (PM, p. 643-645),

(B4.1.3) L-glufosinate, L- or (2S)-2-amino-4-[hydroxy(methyl)phosphinyl]butanoic acid (phosphinothricin) (PM, p. 643-645),

(B4.1.4) L-glufosinate monoammonium salt (PM, p. 643-645),

(B4.1.5) bilanafos (or bialaphos) (PM, p. 120-121), i.e. L-2-amino-4-[hydroxy(methyl)phosphinyl]butanoyl-L-alanyl-L-alanine, in particular its sodium salt.

(B4.2) compounds of the type of the phosphonomethylglycine and its salts, such as

(B4.2.1) glyphosate (PM, p. 646-649), i.e. N-(phosphonomethyl)-glycine, and/or

(B4.2.2) glyphosate monoisopropylammonium salt (PM, p. 646-649), and/or

(B4.2.3) glyphosate sodium salt (PM, p. 646-649), and/or

(B4.2.4) sulfosate, i.e. N-(phosphonomethyl)glycine trimesium salt=N-(phosphonomethyl)glycine trimethylsulfoxonium salt (PM, p. 646-649), and/or

(B4.3) imidazolinones, such as

(B4.3.1) imazapyr (PM, p. 697-699) and its salts and esters, and/or

(B4.3.2) imazethapyr (PM, p. 701-703) and its salts and esters, and/or

(B4.3.3) imazamethabenz (PM, p. 694-696) and its salts and esters, and/or

(B4.3.4) imazamox (PM, p. 696-697) and its salts and esters, and/or

(B4.3.5) imazaquin (PM, p. 699-701) and its salts and esters, for example the ammonium salt, and/or

(B4.3.6) imazapic (AC 263,222) (PM, p. 5-6) and its salts and esters, for example the ammonium salt, and/or

(B4.4) compounds of various structural types, such as

(B4.4.1) WC9717 or CGA276854=1-allyloxycarbonyl-1-methylethyl 2-chloro-5-(3-methyl-2,6-dioxo-4-trifluoromethyl-3,6-dihydro-2H-pyrimidin-1-yl)benzoate (known from U.S. Pat. No. 5,183,492)

(B4.4.2) azafenidin (PM, p. 60, 61), i.e. 2-(2-dichloro-5-prop-2-ynyloxy-phenyl)-5,6,7,8-tetrahydro-1 ,2,4-triazolo[4,3-a]pyridin-3(2H)-one, and/or

(B4.4.3) diuron (PM, p. 443-444), i.e. 3-(3,4-dichlorophenyl)-1,1-dimethylurea, and/or

(B4.4.4) oxyfluorfen (PM, p; 919-920), i.e. 2-chloro-1-(3-ethoxy-4-nitrophenoxy)-4-(trifluoromethyl)benzene.

When the short form of the common name is used, this includes all customary derivatives, such as esters and salts, in particular the commercially available form or forms. In the case of sulfonylureas, salts include those which are formed by exchanging a hydrogen atom at the sulfonamide group for a cation.

Preference is given to herbicide combinations of one or more compounds (A) with one or more compounds of group (B1) or (B2) or (B3) or (B4). Preference is furthermore given to combinations of compounds (A) with one or more compounds (B) according to the scheme:

(A)+(B1)+(B2), (A)+(B1)+(B3), (A)+(B1)+(B4) or (A)+(B2)+(B3), (A)+(B2)+(B4), (A)+(B3)+(B4) or (A)+(B1)+(B2)+(B3), (A)+(B1)+(B2)+(B4), (A)+(B4)+(B2)+(B3), (A)+(B1)+(B3)+(B4) or (A)+(B1)+(B2)+(B3)+(B4).

Also according to the invention are combinations in which one or more further active compounds of a different structure [active compounds (C)] are added, such as

(A)+(B1)+(C), (A)+(B2)+(C) or (A)+(B3)+(C), (A)+(B4)+(C), (A)+(B1)+(B2)+(C), (A)+(B1)+(B3)+(C), (A)+(B1)+(B4)+(C) or (A)+(B2)+(B3)+(C), (A)+(B2)+(B4)+(C), (A)+(B3)+(B4)+(C) or (A)+(B1)+(B2)+(B3)+(C), (A)+(B1)+(B2)+(B4)+(C), (A)+(B4)+(B2)+(B3)+(C), (A)+(B1)+(B3)+(B4)+(C) or (A)+(B1)+(B2)+(B3)+(B4)+(C).

For combinations of the last-mentioned kind with three or more active compounds, the preferred conditions explained below in particular for two-compound combinations according to the invention primarily apply likewise if they comprise the two-compound combinations according to the invention.

The application rate of the herbicides (A) can be varied within wide limits; the optimum rate depends on the herbicide in question, on the spectrum of harmful plants and on the crop plants. In general, the application rate is in the range from 10 to 1200, preferably 15 to 800, very particularly preferably from 10 to 150 g, of active compound (a.s.)/ha.

The application rates of the herbicides (B) can vary considerably from herbicide to herbicide. As a rule of thumb, for preferred application rates, the following details can apply, it also being possible in the combinations according to the invention for amounts below the lowest amount to be useful (a.s.=active substance).

Compounds of groups (B1.1) and (B1.2): 0.5 to 5000, in particular 50-5000, g of a.s./ha, predominantly against weed grasses by the post-emergence method, but also by the pre-emergence method;

compounds of groups (B1.3) and (B1.4): 0.5 to 5000, in particular 10-1500, g of a.s./ha, mainly against weed grasses by the post-emergence method, if appropriate in combination with safeners;

compounds of groups (B1.5): 10 to 5000, in particular 20 to 4000, g of a.s./ha, mainly against weed grasses by the post-emergence and pre-emergence method;

compounds of groups (B1.6): 0.5 to 2000, in particular 10 to 1500, g of a.s./ha, mainly against weed grasses by the post-emergence and pre-emergence method;

compounds of group (B2.1): 0.5 to 500, in particular 2.5-80, g of a.s./ha, predominantly against broad-leaved weeds by the post-emergence method;

compounds of group (B2.2): 20 to 5000, in particular 50-2000, g of a.s./ha, predominantly against broad-leaved weeds and Cyperaceae by the post-emergence method;

compounds of group (B2.3): 1-3000, in particular 5-2000, g of a.s./ha predominantly against broad-leaved weeds by the post-emergence method;

compounds of group (B2.4): .1 to 3000, in particular 2 to 1500, g of a.s./ha predominantly against broad-leaved weeds by the post-emergence method;

compounds of group (B2.5): 1 to 1000, in particular 2 to 200, g of a.s./ha against broad-leaved weeds by the pre- and post-emergence method; compounds of group (B2.6): 0.5 to 5000, in particular 10 to 1500, g of a.s./ha against broad-leaved weeds by the pre- and/or post-emergence method;

compounds of group (B3.1): 0.5 to 2000, in particular 1 to 500, g of a.s./ha predominantly against broad-leaved weeds and weed grasses by the post-emergence, but also by the pre-emergence method;

compounds of group (B3.2): 10 to 5000, in particular 100 to 4000, very particularly preferably 300-3000, g of a.s./ha against broad-leaved weeds and weed grasses by the post-emergence and/or pre-emergence method;

compounds of group (B3.3): 10 to 5000, in particular 100 to 4000, very particularly preferably 200-3000, g of a.s./ha against broad-leaved weeds and weed grasses by the post-emergence and/or pre-emergence method;

compounds of group (B3.4): 0.5 to 5000, in particular 10 to 1500, g of a.s./ha against broad-leaved weeds and weed grasses by the post-emergence and/or pre-emergence method;

compounds of group (B4.1): 10 to 1000, in particular 20 to 600;

compounds of group (B4.2): 20 to 1000, in particular 20 to 800;

compounds of group (B4.3): 1 to 1000, in particular 10 to 200;

compounds of group (B4.4): 10 to 8000, in particular 10 to 6000.

Ranges of suitable ratios of compounds (A) and (B) result from the abovementioned application rates for the individual substances. In the combinations according to the invention, it is generally possible to reduce the application rates.

Preferred mixing ratios (based on weight) for the combinations are listed below:

(A):(B1) in the range from 2000:1 to 1:500, preferably from 500:1 to 1:150, in particular from 75:1 to 1:80;

(A):(B2) in the range from 1600:1 to 1:500, preferably from 600:1 to 1:150, in particular from 40:1 to 1:60;

(A):(B3) in the range from 9000:1 to 1:600, preferably from 700:1 to 1:250, in particular from 100:1 to 1:150;

(A):(B4) in the range from 120:1 to 1:400, preferably from 40:1 to 1:250, in particular from 20:1 to 1:150.

Of particular interest is the use of herbicidal compositions comprising a synergistically effective amount of one or more of the following combinations of two compounds (A)+(B):

(A1)+(B1.1.1), (A1)+(B.1.2),

(A1)+(B1.2.1), (A1)+(B1.2.2), (A1)+(B1.2.3),

(A1)+(B1.3.1), (A1)+(B1.3.2), (A1)+(B1.3.3), (A1)+(B1.3.4), (A1)+(B1.3.5),

(A1)+(B1.3.6), (A1)+(B1.3.7), (A1)+(B1.3.8)

(A1)+(B1.4.1), (A1)+(B1.4.2), (A1)+(B1.4.3), (A1)+(B1.4.4), (A1)+(B1.4.5);

(A1)+(B1.5.1), (A1)+(B1.5.2), (A1)+(B1.5.3), (A1)+(B1.5.4);

(A1)+(B1.6.1), (A1)+(B1.6.2), (A1)+(B1.6.3), (A1)+(B1.6.4), (A1)+(B1.6.5),

(A1)+(B1.6.6), (A1)+(B1.6.7), (A1)+(B1.6.8), (A1)+(B1.6.9), (A1)+(B1.6.10),

(A1)+(B1.6.11), (A1)+(B1.6.12), (A1)+(B1.6.13), (A1)+(B1.6.14),

(A1)+(B1.6.15), (A1)+(B1.6.16), (A1)+(B1.6.17), (A1)+(B1.6.18),

(A1)+(B1.6.19);

(A1)+(B2.11), (A1)+(B2.1.2), (A1)+(B2.1.3), (A1)+(B2.1.4), (A1)+(B2.1.6),

(A1)+(B2.1.7), (A1)+(B2.1.8), (A1)+(B2.1.9), (A1)+(B2.1.10),

(A1)+(B2.1.11), (A1)+(B2.1.12), (A1)+(B2.1.13), (A1)+(B2.1.13);

(A1)+(B2.2.1), (A1)+(B2.2.2), (A1)+(B2.2.3), (A1)+(B2.2.4), (A1)+(B2.2.5),

(A1)+(B2.2.6), (A1)+(B2.2.7), (A1)+(B2.2.8),

(A1)+(B2.3.1), (A1)+(B2.3.2);

(A1)+(B2.4.1), (A1)+(B2.4.2), (A1)+(B2.4.3);

(A1)+(B2.5.1), (A1)+(B2.5.2);

(A1)+(B2.6.1), (A1)+(B2.6.2), (A1)+(B2.6.3), (A1)+(B2.6.4), (A1)+(B2.6.5),

(A1)+(B2.6.6), (A1)+(B2.6.7), (A1)+(B2.6.8), (A1)+(B2.6.9), (A1)+(B2.6.10),

(A1)+(B2.6.11), (A1)+(B2.6.12), (A1)+(B2.6.13), (A1)+(B2.6.14),

(A1)+(B2.6.15), (A1)+(B2.6.16);

(A1)+(B3.1.1), (A1)+(B3.1.2), (A1)+(B3.1.3), (A1)+(B3.1.4), (A1)+(B3.1.5),

(A1)+(B3.1.6), (A1)+(B3.1.7), (A1)+(B3.1.8), (A1)+(B3.1.9),

(A1)+(B3.1.10), (A1)+(B3.1.11);

(A1)+(B3.2.1), (A1)+(B3.2.2), (A1)+(B3.2.3), (A1)+(B3.2.4);

(A1)+(B3.3.1), (A1)+(B3.3.2), (A1)+(B3.3.3);

(A1)+(B3.4.1), (A1)+(B3.4.2), (A1)+(B3.4.3), (A1)+(B3.4.4), (A1)+(B3.4.5),

(A1)+(B3.4.6), (A1)+(B3.4.7), (A1)+(B3.4.8), (A1)+(B3.4.9), (A1)+(B3.4.10),

(A1)+(B3.4.1 1), (A1)+(B3.4.12), (A1)+(B3.4.13), (A1)+(B3.4.14),

(A1)+(B3.4.15), (A1)+(B3.4.16), (A1)+(B3.4.17), (A1)+(B3.4.18);

(A1)+(B3.4.19), (A1)+(B3.4.20), (A1)+(B3.4.21);

(A1)+(B4.1.1), (A1)+(B4.1.2), (A1)+(B4.1.3), (A1)+(B4.1.4); (A1)+(B4.1.5),

(A1)+(B4.2.1), (A1)+(B4.1.2), (A1)+(B4.2.3), (A1)+(B4.2.4),

(A1)+(B4.3.1), (A1)+(B4.3.2), (A1)+(B4.3.3), (A1)+(B4.3.4), (A1)+(B4.3.5),

(A1)+(B4.3.6);

(A1)+(B4.4.1), (A1)+(B4.4.2), (A1)+(B4.4.3), (A1)+(B4.4.4);

(A2)+(B1.1.1), (A2)+(B1.1.2),

(A2)+(B1.2.1), (A2)+(B1.2.2), (A2)+(B1.2.3),

(A2)+(B1.3.1), (A2)+(B1.3.2), (A2)+(B1.3.3), (A2)+(B1.3.4), (A2)+(B1.3.5),

(A2)+(B1.3.6), (A2)+(B1.3.7), (A2)+(B1.3.8)

(A2)+(B1.4.1), (A2)+(B1.4.2), (A2)+(B1.4.3), (A2)+(B1.4.4), (A2)+(B1.4.5);

(A2)+(B1.5.1), (A2)+(B1.5.2), (A2)+(B1.5.3), (A2)+(B1.5.4);

(A2)+(B1.6.1), (A2)+(B1.6.2), (A2)+(B1.6.3), (A2)+(B1.6.4), (A2)+(B1.6.5),

(A2)+(B1.6.6), (A2)+(B1.6.7), (A2)+(B1.6.8), (A2)+(B1.6.9), (A2)+(B1.6.10),

(A2)+(B1.6.11), (A2)+(B1.6.12), (A2)+(B1.6.13), (A2)+(B1.6.14),

(A2)+(B1.6.15), (A2)+(B1.6.16), (A2)+(B1.6.17), (A2)+(B1.6.18),

(A2)+(B1.6.19);

(A2)+(B2.1.1), (A2)+(B2.1.2), (A2)+(B2.1.3), (A2)+(B2.1.4), (A2)+(B2.1.6),

(A2)+(B2.1.7), (A2)+(B2.1.8), (A2)+(B2.1.9), (A2)+(B2.1.10),

(A2)+(B2.1.11), (A2)+(B2.1.12), (A2)+(B2.1.13), (A2)+(B2.1.13);

(A2)+(B2.2.1), (A2)+(B2.2.2), (A2)+(B2.2.3), (A2)+(B2.2.4), (A2)+(B2.2.5);

(A2)+(B2.2.6), (A2)+(B2.2.7), (A2)+(B2.2.8),

(A2)+(B2.3.1), (A2)+(B2.3.2);

(A2)+(B2.4.1), (A2)+(B2.4.2), (A2)+(B2.4.3);

(A2)+(B2.5.1), (A2)+(B2.5.2);

(A2)+(B2.6.1), (A2)+(B2.6.2), (A2)+(B2.6.3), (A2)+(B2.6.4), (A2)+(B2.6.5),

(A2)+(B2.6.6), (A2)+(B2.6.7), (A2)+(B2.6.8), (A2)+(B2.6.9), (A2)+(B2.6.10),

(A2)+(B2.6.11), (A2)+(B2.6.12), (A2)+(B2.6.13), (A2)+(B2.6.14),

(A2)+(B2.6.15), (A2)+(B2.6.16);

(A2)+(B3.1.1), (A2)+(B3.1.2), (A2)+(B3.1.3), (A2)+(B3.1.4), (A2)+(B3.1.5),

(A2)+(B3.1.6), (A2)+(B3.1.7), (A2)+(B3.1.8), (A2)+(B3.1.9),

(A2)+(B3.1.10), (A2)+(B3.1.11);

(A2)+(B3.2.1), (A2)+(B3.2.2), (A2)+(B3.2.3), (A2)+(B3.2.4);

(A2)+(B3.3.1), (A2)+(B3.3.2), (A2)+(B3.3.3);

(A2)+(B3.4.1), (A2)+(B3.4.2), (A2)+(B3.4.3), (A2)+(B3.4.4), (A2)+(B3.4.5),

(A2)+(B3.4.6), (A2)+(B3.4.7), (A2)+(B3.4.8), (A2)+(B3.4.9), (A2)+(B3.4.10),

(A2)+(B3.4.11), (A2)+(B3.4.12), (A2)+(B3.4.13), (A2)+(B3.4.14),

(A2)+(B3.4.15), (A2)+(B3.4.16), (A2)+(B3.4.17), (A2)+(B3.4.18);

(A2)+(B3.4.19), (A2)+(B3.4.20), (A2)+(B3.4.21);

(A2)+(B4.1.1), (A2)+(B4.1.2), (A2)+(B4.1.3), (A2)+(B4.1.4); (A2)+(B4.1.5),

(A2)+(B4.2.1), (A2)+(B4.1.2), (A2)+(B4.2.3), (A2)+(B4.2.4),

(A2)+(B4.3.1), (A2)+(B4.3.2), (A2)+(B4.3.3), (A2)+(B4.3.4), (A2)+(B4.3.5),

(A2)+(B4.3.6);

(A2)+(B4.4.1), (A2)+(B4.4.2), (A2)+(B4.4.3), (A2)+(B4.4.4);

(A3)+(B1.1.1), (A3)+(B1.1.2),

(A3)+(B1.2.1), (A3)+(B1.2.2), (A3)+(B1.2.3),

(A3)+(B1.3.1), (A3)+(B1.3.2), (A3)+(B1.3.3), (A3)+(B1.3.4), (A3)+(B1.3.5),

(A3)+(B1.3.6), (A3)+(B1.3.7), (A3)+(B1.3.8)

(A3)+(B1.4.1), (A3)+(B1.4.2), (A3)+(B1.4.3), (A3)+(B1.4.4), (A3)+(B1.4.5);

(A3)+(B1.5.1), (A3)+(B1.5.2), (A3)+(B1.5.3), (A3)+(B1.5.4);

(A3)+(B1.6.1), (A3)+(B1.6.2), (A3)+(B1.6.3), (A3)+(B1.6.4), (A3)+(B1.6.5),

(A3)+(B1.6.6), (A3)+(B1.6.7), (A3)+(B1.6.8), (A3)+(B1.6.9), (A3)+(B1.6.10),

(A3)+(B1.6.11), (A3)+(B1.6.12), (A3)+(B1.6.13), (A3)+(B1.6.14),

(A3)+(B1.6.15), (A3)+(B1.6.16), (A3)+(B1.6.17), (A3)+(B1.6.18),

(A3)+(B1.6.19);

(A3)+(B2.1.1), (A3)+(B2.1.2), (A3)+(B2.1.3), (A3)+(B2.1.4), (A3)+(B2.1.6),

(A3)+(B2.1.7), (A3)+(B2.1.8), (A3)+(B2.1.9), (A3)+(B2.1.10),

(A3)+(B2.1.11), (A3)+(B2.1.12), (A3)+(B2.1.13), (A3)+(B2.1.13);

(A3)+(B2.2.1), (A3)+(B2.2.2), (A3)+(B2.2.3), (A3)+(B2.2.4), (A3)+(B2.2.5),

(A3)+(B2.2.6), (A3)+(B2.2.7), (A3)+(B2.2.8),

(A3)+(B2.3.1), (A3)+(B2.3.2);

(A3)+(B2.4.1), (A3)+(B2.4.2), (A3)+(B2.4.3);

(A3)+(B2.5.1), (A3)+(B2.5.2);

(A3)+(B2.6.1), (A3)+(B2.6.2), (A3)+(B2.6.3), (A3)+(B2.6.4), (A3)+(B2.6.5),

(A3)+(B2.6.6), (A3)+(B2.6.7), (A3)+(B2.6.8), (A3)+(B2.6.9), (A3)+(B2.6.10),

(A3)+(B2.6.11), (A3)+(B2.6.12), (A3)+(B2.6.13), (A3)+(B2.6.14),

(A3)+(B2.6.15), (A3)+(B2.6.16);

(A3)+(B3.1.1), (A3)+(B3.1.2), (A3)+(B3.1.3), (A3)+(B3.1.4), (A3)+(B3.1.5),

(A3)+(B3.1.6), (A3)+(B3.1.7), (A3)+(B3.1.8), (A3)+(B3.1.9),

(A3)+(B3.1.10), (A3)+(B3.1.11);

(A3)+(B3.2.1), (A3)+(B3.2.2), (A3)+(B3.2.3), (A3)+(B3.2.4);

(A3)+(B3.3.1), (A3)+(B3.3.2), (A3)+(B3.3.3);

(A3)+(B3.4.1), (A3)+(B3.4.2), (A3)+(B3.4.3), (A3)+(B3.4.4), (A3)+(B3.4.5),

(A3)+(B3.4.6), (A3)+(B3.4.7), (A3)+(B3.4.8), (A3)+(B3.4.9), (A3)+(B3.4.10),

(A3)+(B3.4.11), (A3)+(B3.4.12), (A3)+(B3.4.13), (A3)+(B3.4.14),

(A3)+(B3.4.15), (A3)+(B3.4.16), (A3)+(B3.4.17), (A3)+(B3.4.18);

(A3)+(B3.4.19), (A3)+(B3.4.20), (A3)+(B3.4.21);

(A3)+(B4.1.1), (A3)+(B4.1.2), (A3)+(B4.1.3), (A3)+(B4.1.4); (A3)+(B4.1.5),

(A3)+(B4.2.1), (A3)+(B4.1.2), (A3)+(B4.2.3), (A3)+(B4.2.4),

(A3)+(B4.3.1), (A3)+(B4.3.2), (A3)+(B4.3.3), (A3)+(B4.3.4), (A3)+(B4.3.5),

(A3)+(B4.3.6);

(A3)+(B4.4.1), (A3)+(B4.4.2), (A3)+(B4.4.3), (A3)+(B4.4.4);

(A4)+(B1.1.1), (A4)+(B1.1.2),

(A4)+(B1.2.1), (A4)+(B1.2.2), (A4)+(B1.2.3),

(A4)+(B1.3.1), (A4)+(B1.3.2), (A4)+(B1.3.3), (A4)+(B1.3.4), (A4)+(B1.3.5),

(A4)+(B1.3.6), (A4)+(B1.3.7), (A4)+(B1.3.8)

(A4)+(B1.4.1), (A4)+(B1.4.2), (A4)+(B1.4.3), (A4)+(B1.4.4), (A4)+(B1.4.5);

(A4)+(B1.5.1), (A4)+(B1.5.2), (A4)+(B1.5.3), (A4)+(B1.5.4);

(A4)+(B1.6.1), (A4)+(B1.6.2), (A4)+(B1.6.3), (A4)+(B1.6.4), (A4)+(B1.6.5),

(A4)+(B1.6.6), (A4)+(B1.6.7), (A4)+(B1.6.8), (A4)+(B1.6.9), (A4)+(B1.6.10),

(A4)+(B1.6.11), (A4)+(B1.6.12), (A4)+(B1.6.13), (A4)+(B1.6.14),

(A4)+(B1.6.15), (A4)+(B1.6.16), (A4)+(B1.6.17), (A4)+(B1.6.18),

(A4)+(B1.6.19);

(A4)+(B2.1.1), (A4)+(B2.1.2), (A4)+(B2.1.3), (A4)+(B2.1.4), (A4)+(B2.1.6),

(A4)+(B2.1.7), (A4)+(B2.1.8), (A4)+(B2.1.9), (A4)+(B2.1.10),

(A4)+(B2.1.11), (A4)+(B2.1.12), (A4)+(B2.1.13), (A4)+(B2.1.13);

(A4)+(B2.2.1), (A4)+(B2.2.2), (A4)+(B2.2.3), (A4)+(B2.2.4), (A4)+(B2.2.5),

(A4)+(B2.2.6), (A4)+(B2.2.7), (A4)+(B2.2.8),

(A4)+(B2.3.1), (A4)+(B2.3.2);

(A4)+(B2.4.1), (A4)+(B2.4.2), (A4)+(B2.4.3);

(A4)+(B2.5.1), (A4)+(B2.5.2);

(A4)+(B2.6.1), (A4)+(B2.6.2), (A4)+(B2.6.3), (A4)+(B2.6.4), (A4)+(B2.6.5),

(A4)+(B2.6.6), (A4)+(B2.6.7), (A4)+(B2.6.8), (A4)+(B2.6.9), (A4)+(B2.6.10),

(A4)+(B2.6.11), (A4)+(B2.6.12), (A4)+(B2.6.13), (A4)+(B2.6.14),

(A4)+(B2.6.15), (A4)+(B2.6.16);

(A4)+(B3.1.1), (A4)+(B3.1.2), (A4)+(B3.1.3), (A4)+(B3.1.4), (A4)+(B3.1.5),

(A4)+(B3.1.6), (A4)+(B3.1.7), (A4)+(B3.1.8), (A4)+(B3.1.9),

(A4)+(B3.1.10), (A4)+(B3.1.11);

(A4)+(B3.2.1), (A4)+(B3.2.2), (A4)+(B3.2.3), (A4)+(B3.2.4);

(A4)+(B3.3.1), (A4)+(B3.3.2), (A4)+(B3.3.3);

(A4)+(B3.4.1), (A4)+(B3.4.2), (A4)+(B3.4.3), (A4)+(B3.4.4), (A4)+(B3.4.5),

(A4)+(B3.4.6), (A4)+(B3.4.7), (A4)+(B3.4.8), (A4)+(B3.4.9), (A4)+(B3.4.10),

(A4)+(B3.4.11), (A4)+(B3.4.12), (A4)+(B3.4.13), (A4)+(B3.4.14),

(A4)+(B3.4.15), (A4)+(B3.4.16), (A4)+(B3.4.17), (A4)+(B3.4.18);

(A4)+(B3.4.19), (A4)+(B3.4.20), (A4)+(B3.4.21);

(A4)+(B4.1.1), (A4)+(B4.1.2), (A4)+(B4.1.3), (A4)+(B4.1.4); (A4)+(B4.1.5),

(A4)+(B4.2.1), (A4)+(B4.1.2), (A4)+(B4.2.3), (A4)+(B4.2.4),

(A4)+(B4.3.1), (A4)+(B4.3.2), (A4)+(B4.3.3), (A4)+(B4.3.4), (A4)+(B4.3.5),

(A4)+(B4.3.6);

(A4)+(B4.4.1), (A4)+(B4.4.2), (A4)+(B4.4.3), (A4)+(B4.4.4);

(A5)+(B1.1.1), (A5)+(B1.1.2),

(A5)+(B1.2.1), (A5)+(B1.2.2), (A5)+(B1.2.3),

(A5)+(B1.3.1), (A5)+(B1.3.2), (A5)+(B1.3.3), (A5)+(B1.3.4), (A5)+(B1.3.5),

(A5)+(B1.3.6), (A5)+(B1.3.7), (A5)+(B1.3.8)

(A5)+(B1.4.1), (A5)+(B1.4.2), (A5)+(B1.4.3), (A5)+(B1.4.4), (A5)+(B1.4.5);

(A5)+(B1.5.1), (A5)+(B1.5.2), (A5)+(B1.5.3), (A5)+(B1.5.4);

(A5)+(B1.6.1), (A5)+(B1.6.2), (A5)+(B1.6.3), (A5)+(B1.6.4), (A5)+(B1.6.5),

(A5)+(B1.6.6), (A5)+(B1.6.7), (A5)+(B1.6.8), (A5)+(B1.6.9), (A5)+(B1.6.10),

(A5)+(B1.6.11), (A5)+(B1.6.12), (A5)+(B1.6.13), (A5)+(B1.6.14),

(A5)+(B1.6.15), (A5)+(B1.6.16), (A5)+(B1.6.17), (A5)+(B1.6.18),

(A5)+(B1.6.19);

(A5)+(B2.1.1), (A5)+(B2.1.2), (A5)+(B2.1.3), (A5)+(B2.1.4), (A5)+(B2.1.6),

(A5)+(B2.1.7), (A5)+(B2.1.8), (A5)+(B2.1.9), (A5)+(B2.1.10),

(A5)+(B2.1.11), (A5)+(B2.1.12), (A5)+(B2.1.13), (A5)+(B2.1.13);

(A5)+(B2.2.1), (A5)+(B2.2.2), (A5)+(B2.2.3), (A5)+(B2.2.4), (A5)+(B2.2.5),

(A5)+(B2.2.6), (A5)+(B2.2.7), (A5)+(B2.2.8),

(A5)+(B2.3.1), (A5)+(B2.3.2);

(A5)+(B2.4.1), (A5)+(B2.4.2), (A5)+(B2.4.3);

(A5)+(B2.5.1), (A5)+(B2.5.2);

(A5)+(B2.6.1), (A5)+(B2.6.2), (A5)+(B2.6.3), (A5)+(B2.6.4), (A5)+(B2.6.5),

(A5)+(B2.6.6), (A5)+(B2.6.7), (A5)+(B2.6.8), (A5)+(B2.6.9), (A5)+(B2.6.10),

(A5)+(B2.6.11), (A5)+(B2.6.12), (A5)+(B2.6.13), (A5)+(B2.6.14),

(A5)+(B2.6.15), (A5)+(B2.6.16);

(A5)+(B3.1.1), (A5)+(B3.1.2), (A5)+(B3.1.3), (A5)+(B3.1.4), (A5)+(B3.1.5),

(A5)+(B3.1.6), (A5)+(B3.1.7), (A5)+(B3.1.8), (A5)+(B3.1.9),

(A5)+(B3.1.10), (A5)+(B3.1.11);

(A5)+(B3.2.1), (A5)+(B3.2.2), (A5)+(B3.2.3), (A5)+(B3.2.4);

(A5)+(B3.3.1), (A5)+(B3.3.2), (A5)+(B3.3.3);

(A5)+(B3.4.1), (A5)+(B3.4.2), (A5)+(B3.4.3), (A5)+(B3.4.4), (A5)+(B3.4.5),

(A5)+(B3.4.6), (A5)+(B3.4.7), (A5)+(B3.4.8), (A5)+(B3.4.9), (A5)+(B3.4.10),

(A5)+(B3.4.11), (A5)+(B3.4.12), (A5)+(B3.4.13), (A5)+(B3.4.14),

(A5)+(B3.4.15), (A5)+(B3.4.16), (A5)+(B3.4.17), (A5)+(B3.4.18),

(A5)+(B3.4.19), (A5)+(B3.4.20), (A5)+(B3.4.21);

(A5)+(B4.1.1), (A5)+(B4.1.2), (A5)+(B4.1.3), (A5)+(B4.1.4); (A5)+(B4.1.5),

(A5)+(B4.2.1), (A5)+(B4.1.2), (A5)+(B4.2.3), (A5)+(B4.2.4),

(A5)+(B4.3.1), (A5)+(B4.3.2), (A5)+(B4.3.3), (A5)+(B4.3.4), (A5)+(B4.3.5),

(A5)+(B4.3.6);

(A5)+(B4.4.1), (A5)+(B4.4.2), (A5)+(B4.4.3), (A5)+(B4.4.4);

(A6)+(B1.1.1), (A6)+(B1.1.2),

(A6)+(B1.2.1), (A6)+(B1.2.2), (A6)+(B1.2.3),

(A6)+(B1.3.1), (A6)+(B1.3.2), (A6)+(B1.3.3), (A6)+(B1.3.4), (A6)+(B1.3.5),

(A6)+(B1.3.6), (A6)+(B1.3.7), (A6)+(B1.3.8)

(A6)+(B1.4.1), (A6)+(B1.4.2), (A6)+(B1.4.3), (A6)+(B1.4.4), (A6)+(B1.4.5);

(A6)+(B1.5.1), (A6)+(B1.5.2), (A6)+(B1.5.3), (A6)+(B1.5.4);

(A6)+(B1.6.1), (A6)+(B1.6.2), (A6)+(B1.6.3), (A6)+(B1.6.4), (A6)+(B1.6.5),

(A6)+(B1.6.6), (A6)+(B1.6.7), (A6)+(B1.6.8), (A6)+(B1.6.9), (A6)+(B1.6.10),

(A6)+(B1.6.11), (A6)+(B1.6.12), (A6)+(B1.6.13), (A6)+(B1.6.14),

(A6)+(B1.6.15), (A6)+(B1.6.16), (A6)+(B1.6.17), (A6)+(B1.6.18),

(A6)+(B1.6.19);

(A6)+(B2.1.1), (A6)+(B2.1.2), (A6)+(B2.1.3), (A6)+(B2.1.4), (A6)+(B2.1.6),

(A6)+(B2.1.7), (A6)+(B2.1.8), (A6)+(B2.1.9), (A6)+(B2.1.10),

(A6)+(B2.1.11), (A6)+(B2.1.12), (A6)+(B2.1.13), (A6)+(B2.1.13);

(A6)+(B2.2.1), (A6)+(B2.2.2), (A6)+(B2.2.3), (A6)+(B2.2.4), (A6)+(B2.2.5),

(A6)+(B2.2.6), (A6)+(B2.2.7), (A6)+(B2.2.8),

(A6)+(B2.3.1), (A6)+(B2.3.2);

(A6)+(B2.4.1), (A6)+(B2.4.2), (A6)+(B2.4.3);

(A6)+(B2.5.1), (A6)+(B2.5.2);

(A6)+(B2.6.1), (A6)+(B2.6.2), (A6)+(B2.6.3), (A6)+(B2.6.4), (A6)+(B2.6.5),

(A6)+(B2.6.6), (A6)+(B2.6.7), (A6)+(B2.6.8), (A6)+(B2.6.9), (A6)+(B2.6.10),

(A6)+(B2.6.11), (A6)+(B2.6.12), (A6)+(B2.6.13), (A6)+(B2.6.14),

(A6)+(B2.6.15), (A6)+(B2.6.16);

(A6)+(B3.1.1), (A6)+(B3.1.2), (A6)+(B3.1.3), (A6)+(B3.1.4), (A6)+(B3.1.5),

(A6)+(B3.1.6), (A6)+(B3.1.7), (A6)+(B3.1.8), (A6)+(B3.1.9),

(A6)+(B3.1.10), (A6)+(B3.1.11);

(A6)+(B3.2.1), (A6)+(B3.2.2), (A6)+(B3.2.3), (A6)+(B3.2.4);

(A6)+(B3.3.1), (A6)+(B3.3.2), (A6)+(B3.3.3);

(A6)+(B3.4.1), (A6)+(B3.4.2), (A6)+(B3.4.3), (A6)+(B3.4.4), (A6)+(B3.4.5),

(A6)+(B3.4.6), (A6)+(B3.4.7), (A6)+(B3.4.8), (A6)+(B3.4.9), (A6)+(B3.4.10),

(A6)+(B3.4.11), (A6)+(B3.4.12), (A6)+(B3.4.13), (A6)+(B3.4.14),

(A6)+(B3.4.15), (A6)+(B3.4.16), (A6)+(B3.4.17), (A6)+(B3.4.18),

(A6)+(B3.4.19), (A6)+(B3.4.20), (A6)+(B3.4.21);

(A6)+(B4.1.1), (A6)+(B4.1.2), (A6)+(B4.1.3), (A6)+(B4.1.4); (A6)+(B4.1.5),

(A6)+(B4.2.1), (A6)+(B4.1.2), (A6)+(B4.2.3), (A6)+(B4.2.4),

(A6)+(B4.3.1), (A6)+(B4.3.2), (A6)+(B4.3.3), (A6)+(B4.3.4), (A6)+(B4.3.5),

(A6)+(B4.3.6);

(A6)+(B4.4.1), (A6)+(B4.4.2), (A6)+(B4.4.3), (A6)+(B4.4.4);

(A7)+(B1.1.1), (A7)+(B1.1.2),

(A7)+(B1.2.1), (A7)+(B1.2.2), (A7)+(B1.2.3),

(A7)+(B1.3.1), (A7)+(B1.3.2), (A7)+(B1.3.3), (A7)+(B1.3.4), (A7)+(B1.3.5),

(A7)+(B1.3.6), (A7)+(B1.3.7), (A7)+(B1.3.8)

(A7)+(B1.4.1), (A7)+(B1.4.2), (A7)+(B1.4.3), (A7)+(B1.4.4), (A7)+(B1.4.5);

(A7)+(B1.5.1), (A7)+(B1.5.2), (A7)+(B1.5.3), (A7)+(B1.5.4);

(A7)+(B1.6.1), (A7)+(B1.6.2), (A7)+(B1.6.3), (A7)+(B1.6.4), (A7)+(B1.6.5),

(A7)+(B1.6.6), (A7)+(B1.6.7), (A7)+(B1.6.8), (A7)+(B1.6.9), (A7)+(B1.6.10),

(A7)+(B1.6.11), (A7)+(B1.6.12), (A7)+(B1.6.13), (A7)+(B1.6.14),

(A7)+(B1.6.15), (A7)+(B1.6.16), (A7)+(B1.6.17), (A7)+(B1.6.18),

(A7)+(B1.6.19);

(A7)+(B2.1.1), (A7)+(B2.1.2), (A7)+(B2.1.3), (A7)+(B2.1.4), (A7)+(B2.1.6),

(A7)+(B2.1.7), (A7)+(B2.1.8), (A7)+(B2.1.9), (A7)+(B2.1.10),

(A7)+(B2.1.11), (A7)+(B2.1.12), (A7)+(B2.1.13), (A7)+(B2.1.13);

(A7)+(B2.2.1), (A7)+(B2.2.2), (A7)+(B2.2.3), (A7)+(B2.2.4), (A7)+(B2.2.5),

(A7)+(B2.2.6), (A7)+(B2.2.7), (A7)+(B2.2.8),

(A7)+(B2.3.1), (A7)+(B2.3.2);

(A7)+(B2.4.1), (A7)+(B2.4.2), (A7)+(B2.4.3);

(A7)+(B2.5.1), (A7)+(B2.5.2);

(A7)+(B2.6.1), (A7)+(B2.6.2), (A7)+(B2.6.3), (A7)+(B2.6.4), (A7)+(B2.6.5),

(A7)+(B2.6.6), (A7)+(B2.6.7), (A7)+(B2.6.8), (A7)+(B2.6.9), (A7)+(B2.6.10),

(A7)+(B2.6.11), (A7)+(B2.6.12), (A7)+(B2.6.13), (A7)+(B2.6.14),

(A7)+(B2.6.15), (A7)+(B2.6.16);

(A7)+(B3.1.1), (A7)+(B3.1.2), (A7)+(B3.1.3), (A7)+(B3.1.4), (A7)+(B3.1.5),

(A7)+(B3.1.6), (A7)+(B3.1.7), (A7)+(B3.1.8), (A7)+(B3.1.9),

(A7)+(B3.1.10), (A7)+(B3.1.11);

(A7)+(B3.2.1), (A7)+(B3.2.2), (A7)+(B3.2.3), (A7)+(B3.2.4);

(A7)+(B3.3.1), (A7)+(B3.3.2), (A7)+(B3.3.3);

(A7)+(B3.4.1), (A7)+(B3.4.2), (A7)+(B3.4.3), (A7)+(B3.4.4), (A7)+(B3.4.5),

(A7)+(B3.4.6), (A7)+(B3.4.7), (A7)+(B3.4.8), (A7)+(B3.4.9), (A7)+(B3.4.10),

(A7)+(B3.4.11), (A7)+(B3.4.12), (A7)+(B3.4.13), (A7)+(B3.4.14),

(A7)+(B3.4.15), (A7)+(B3.4.16), (A7)+(B3.4.17), (A7)+(B3.4.18),

(A7)+(B3.4.19), (A7)+(B3.4.20), (A7)+(B3.4.21);

(A7)+(B4.1.1), (A7)+(B4.1.2), (A7)+(B4.1.3), (A7)+(B4.1.4); (A7)+(B4.1.5),

(A7)+(B4.2.1), (A7)+(B4.1.2), (A7)+(B4.2.3), (A7)+(B4.2.4),

(A7)+(B4.3. 1), (A7)+(B4.3.2), (A7)+(B4.3.3), (A7)+(B4.3.4), (A7)+(B4.3.5),

(A7)+(B4.3.6);

(A7)+(B4.4.1), (A7)+(B4.4.2), (A7)+(B4.4.3), (A7)+(B4.4.4);

The abovementioned ranges of application rates and ratios are in each case preferred.

In individual cases, it may be expedient to combine one of the compounds (A) with a plurality of compounds (B) from the classes (B1), (B2), (B3) and/or (B4). Furthermore, the combinations according to the invention may be employed together with other active compounds, for example from the group of the safeners, fungicides, insecticides and plant growth regulators, or from the group of the additives and formulation auxiliaries which are customary in crop protection.

Preference is given to herbicide combinations according to the invention comprising such an amount of safeners (C) that they act as antidotes, to reduce the phytotoxic side effects of the herbicides used in economically important crops such as cereals (wheat, barley, rye, corn, rice, millet), sugar beet, sugar cane, oilseed rape, cotton and soy. The herbicide combinations are preferably employed in cereals. Suitable safeners for the abovementioned active compounds (A) and (B) are, for example, the following groups of compounds:

a) Compounds of the type of the dichlorophenylpyrazoline-3-carboxylic acid, preferably compounds such as ethyl 1-(2,4-dichlorophenyl)-5-(ethoxycarbonyl)-5-methyl-2-pyrazoline-3-carboxylate (S1-1) (“mefenpyr-diethyl”, PM, pp. 781-782), and related compounds, as described in WO 91/07874,

b) Derivatives of dichlorophenylpyrazole carboxylic acid, preferably compounds such as ethyl 1-(2,4-dichlorophenyl)-5-methylpyrazole-3-carboxylate (S1-2), ethyl 1-(2,4-dichlorophenyl)-5-isopropyl-pyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds as described in EP-A-333 131 and EP-A-269 806.

c) Compounds of the type of the triazolecarboxylic acids, preferably compounds such as fenchlorazole(ethyl ester), i.e. ethyl 1-(2,4-dichlorophenyl)-5-trichloromethyl-(1H)-1,2,4-triazole-3-carboxylate (S1-6) and related compounds as described in EP-A-174 562 and EP-A-346 620);

d) Compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or the ethyl 5,5-diphenyl-2-isoxazolinecarboxylate (S1-9) (“isoxadifen-ethyl”) or its n-propyl ester (S1-10) or the ethyl 5-(4-fluorophenyl)-5-phenyl-2-isoxazoline-3-carboxylate (S1-11), as described in the German patent application (WO-A-95/07897).

e) Compounds of the type of the 8-quinolineoxyacetic acid (S2), preferably

1-methylhex-1-yl (5-chloro-8-quinolineoxy) acetate (common name “cloquintocet-mexyl” (S2-1) (see PM, pp. 263-264) 1,3-dimethylbut-1-yl (5-chloro-8-quinolineoxy)acetate (S2-2), 4-allyloxybutyl (5-chloro-8-quinolineoxy)acetate (S2-3), 1-allyloxyprop-2-yl (5-chloro-8-quinolineoxy)acetate (S2-4), ethyl (5-chloro-8-quinolineoxy)acetate (S2-5), methyl (5-chloro-8-quinolineoxy)acetate (S2-6), allyl (5-chloro-8-quinolineoxy)acetate (S2-7), 2-(2-propylideneiminoxy)-1-ethyl (5-chloro-8-quinolineoxy)acetate (S2-8),

2-oxoprop-1-yl (5-chloro-8-quinolineoxy)acetate (S2-9) and related compounds, as described in EP-A-86 750, EP-A-94 349 and EP-A-1 91 736 or EP-A-0 492 366.

f) Compounds of the type of the (5-chloro-8-quinolineoxy)malonic acid, preferably compounds such as diethyl (5-chloro-8-quinolineoxy)malonate, diallyl (5-chloro-8-quinolineoxy)malonate, methyl ethyl (5-chloro-8-quinolineoxy)malonate and related compounds, as described in EP-A-0 582 198.

g) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxypropionic esters (mecoprop), MCPA or 3,6-dichloro-2-methoxybenzoic acid (esters) (dicamba).

i) Active compounds of the type of the pyrimidines, which are used as soil-acting safeners in rice, such as, for example,

“fenclorim” (PM, pp. 512-511) (=4,6-dichloro-2-phenylpyrimidine), which is known as safener for pretilachlor in sown rice,

i) Active compounds of the type of the pyrimidines, which are used as soil-acting safeners in rice, such as, for example, “fenclorim” (PM pp. 512-511) (=4,6-dichloro-2-phenylpyrimidine), which is known as safener against pretilachlor damage in sown rice,

j) Active compounds of the type of the dichloroacetamides, which are frequently used as pre-emergent safeners (soil-acting safeners), such as, for example,

“dichlormid” (PM, pp. 363-364) (=N,N-diallyl-2,2-dichloroacetamide),

“R-29148” (=3-dichloroacetyl-2,2,5-trimethyl-1,3-oxazolidine from Stauffer),

“benoxacor” (PM, pp. 102-103) (=4-dichloroacetyl-3,4-dihydro-3-methyl-2H-1,4-benzoxazine),

“PPG-1292” (=N-allyl-N-[(1,3-dioxolan-2-yl)methyl]dichloro-acetamide from PPG Industries),

“DK-24” (=N-allyl-N-[(allylaminocarbonyl)methyl]dichloroacetamide from Sagro-Chem),

“AD-67” or “MON 4660” (=3-dichloroacetyl-1-oxa-3-aza-spiro[4,5]decane from Nitrokemia or Monsanto),

“diclonon” or “BAS145138” or “LAB145138” (=3-dichloroacetyl-2,5,5-trimethyl-1,3-diazabicyclo[4.3.0]nonane from BASF) and

“furilazol” or “MON 13900” (see PM, 637-638) (=(RS)-3-dichloroacetyl-5-(2-furyl)-2,2-dimethyloxazolidine)

k) Active compounds of the type of the dichloroacetone derivatives, such as, for example,

“MG 191” (CAS-Reg. No. 96420-72-3) (=2-dichloromethyl-2-methyl-1,3-dioxolane from Nitrokemia), which is known as safener for corn,

l) Active compounds of the type of the oxyimino compounds, which are known as seed dressings, such as, for example,

“oxabetrinil” (PM, pp. 902-903) (=(Z)-1,3-dioxolan-2-ylmethoxy-imino(phenyl)acetonitrile), which is known as seed dressing safener for millet against metolachlor damage,

“fluxofenim” (PM, pp. 613-614) (=1-(4-chlorophenyl)-2,2,2-trifluoro-1-ethanone O-(1,3-dioxolan-2-ylmethyl) oxime), which is known as seed dressing safener for millet against metolachlor damage,

“cyometrinil” or “-CGA-43089” (PM, p. 1304) (=(Z)-cyanomethoxyimino(phenyl)acetonitrile), which is known as seed dressing safener for millet against metolachlor damage,

m) Active compounds of the type of the thiazolecarboxylic estersi which are known as seed dressings, such as, for example,

“flurazol” (PM, pp. 590-591) (=benzyl 2-chloro-4-trifluoromethyl-1,3-thiazole-5-carboxylate), which is known as seed dressing safener for millet against alachlor and metolachlor damage,

n) Active compounds of the type of the naphthalenedicarboxylic acid derivatives, which are known as seed dressings, such as, for example,

“naphthalic anhydride” (PM, p. 1342) (=1,8-naphthalenedicarboxylic anhydride), which is known as seed dressing safener for corn against thiocarbamate herbicide damage,

o) Active compounds of the type of the chromanacetic acid derivatives, such as, for example,

“CL 304415” (CAS-Reg. No. 31541-57-8) (=2-(4-carboxychroman-4-yl)acetic acid from American Cyanamid), which is known as safener for corn against imidazolinone damage,

p) Active compounds which, in addition to a herbidical action against harmful plants, also have safener action in crop plants such as rice, such as, for example,

“dimepiperate” or “MY-93” (PM, pp. 404-405) (=S-1-methyl-1-phenylethyl piperidine-1-thiocarboxylate), which is known as safener for rice against damage by the herbicide molinate,

“daimuron” or “SK 23” (PM, p. 330) (=1-(1-methyl-1-phenylethyl)-3-p-tolylurea), which is known as safener for rice against damage by the herbicide imazosulfuron,

“cumyluron”=“JC-940” (=3-(2-chlorophenylmethyl)-1-(1-methyl-1-phenylethyl)urea, see JP-A-60087254), which is known as safener for rice against damage by some herbicides,

“methoxyphenon” or “NK 049” (=3,3′-dimethyl-4-methoxybenzophenone), which is known as safener for rice against damage by some herbicides,

“CSB” (=1-bromo-4-(chloromethylsulfonyl)benzene) (CAS-Reg. No. 54091-06-4 from Kumiai), which is known as safener against damage by some herbicides in rice

q) N-Acylsulfonamides of the formula (S3) and salts thereof,

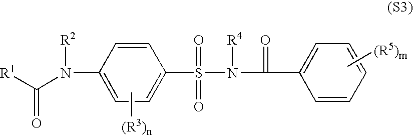

as described in WO-A-97/45016,

r) Acylsulfamoylbenzoamides of the formula (S4), if appropriate also in salt form,

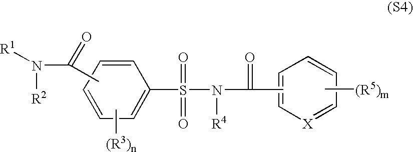

as described in the International Application No. PCT/EP98/06097, and

s) Compounds of the formula (S5),

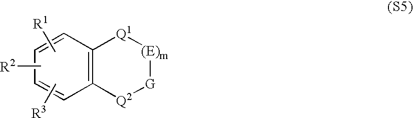

as described in WO-A 98/13 361,

including the stereoisomers and the salts used in agriculture.

Among the safeners mentioned, (S1-1) and (S1-9) and (S2-1), in particular (S1-1) and (S1-9), are of particular interest.

Some of the safeners have already been mentioned above as herbicides and consequently show, in addition to the herbicidal action against harmful plants, also protective action in connection with crop plants.

The combinations according to the invention (=herbicidal compositions) have an outstanding herbicidal activity against a broad spectrum of economically important monocotyledonous and dicotyledonous harmful plants. The active ingredients also act efficiently on perennial weeds which produce shoots from rhizomes, rootstocks or other perennial organs and which are difficult to control.

Specifically, examples may be mentioned of some representatives of the monocotyledonous and dicotyledonous weed flora which can be controlled by the compounds according to the invention, without the enumeration being a restriction to certain species.

Examples of weed species on which the herbicidal compositions act efficiently are, from amongst the monocotyledonous weed species, Avena spp., Alopecurus spp., Brachiaria spp., Digitaria spp., Lolium spp., Echinochloa spp., Panicum spp., Phalaris spp., Poa spp., Setaria spp. and Cyperus species from the annual group, and, amongst the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

If the compounds according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the compositions are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crop plants, is eliminated at a very early point in time and in a sustained manner.

The herbicidal compositions according to the invention are distinguished by a rapidly commencing and long-lasting herbicidal action. As a rule, the rainfastness of the active ingredients in the combinations according to the invention is advantageous. A particular advantage is that the dosages of the compounds (A) and (B), which are used in the combinations and are effective, can be adjusted to such a low quantity that their soil action is optimally low. This does not only allow them to be employed in sensitive crops in the first place, but groundwater contaminations are virtually avoided. The active-ingredient combination according to the invention allows the application rate of the active ingredients required to be reduced considerably.

When herbicides of the type (A)+(B) are used jointly, superadditive (=synergistic) effects are observed. This means that the effect in the combinations exceeds the expected total of the effects of the individual herbicides employed. The synergistic effects allow the application rate to be reduced, a broader spectrum of broad-leaved weeds and grass weeds to be controlled, the herbicidal action to take place more rapidly, the duration of action to be longer, the harmful plants to be controlled better while using only one, or few, applications, and the application period which is possible to be extended. In some cases, use of the compositions also reduces the amount of harmful constituents, such as nitrogen or oleic acid, and their entry into the ground.

The abovementioned properties and advantages are necessary for weed control practice to keep agricultural crops free from undesired competing plants and thus to guarantee and/or increase the yields from the qualitative and quantitative point of view. These novel combinations markedly exceed the technical state of the art with a view to the properties described.

While the combinations according to the invention have an outstanding herbicidal activity against monocotyledonous and dicotyledonous weeds, the crop plants are damaged only to a minor extent, if at all.

Moreover, some of the compositions according to the invention have outstanding growth-regulatory properties on the crop plants They engage in the plants' metabolism in a regulatory manner and can thus be employed for provoking directed effects on plant constituents and to facilitate harvesting such as for example by triggering desiccation and stunted growth. Moreover, they are also suitable for the general control and inhibition of undesired vegetative growth without simultaneously destroying the plants. An inhibition of vegetative growth is very important in a large number of monocotyledonous and dicotyledonous crops since lodging can thus be reduced, or prevented completely.

Owing to their herbicidal and plant-growth-regulatory properties, the compositions can be employed for controlling harmful plants in known plant crops or tolerant or genetically modified crop plants still to be developed. The transgenic plants are generally distinguished by particular, advantageous properties, such as resistances to plant diseases or causative agents of plant diseases such as particular insects or microorganisms such as fungi, bacteria or viruses in addition to resistances to the compositions according to the invention. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:

the modification, by recombinant technology, of crop plants with the aim of modifying the starch synthesized in the plants (for example WO 92/11376, WO 92/14827, WO 91/19806),

transgenic crop plants which exhibit resistances to other herbicides, for example to sulfonylureas (EP-A-0257993, U.S. Pat. No. 5,013,659),

transgenic crop plants with the capability of producing Bacillus thuringiensis toxins (Bt toxins), which make the plants resistant to certain pests (EP-A-01 42924, EP-A-01 93259),

transgenic crop plants with a modified fatty acid composition (WO 91/13972).

A large number of techniques in molecular biology are known in principle with the aid of which novel transgenic plants with modified properties can be generated: see, for example, Sambrook et al., 1989, Molecular Cloning, A Laboratory Manual, 2nd Edition, Cold Spring Harbor Laboratory Press, Cold Spring Harbor, N.Y.; or Winnacker “Gene und Klone”, VCH Weinheim 2nd Edition 1996 or Christou, “Trends in Plant Science” 1 (1996) 423-431). To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribosome which specifically cleaves transcripts of the abovementioned gene product.

To this end, it is possible to use, on the one hand, DNA molecules which encompass the entire coding sequence of a gene product inclusive of any flanking sequences which may be present, as well as DNA molecules which only encompass portions of the coding sequence, it being necessary for these portions to be long enough to have an antisense effect on the cells. The use of DNA sequences which have a high degree of homology to the encoding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to intact plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

The invention therefore also relates to a method of controlling undesired vegetation, preferably in plant crops, which comprises applying one or more compositions of type (A) together with one or more herbicides of type (B) to the harmful plants, parts of these plants, or the area under cultivation.

The invention also relates to the use of the herbicidal compositions of compounds (A)+(B) for controlling harmful plants, preferably in plant crops. The active ingredient combinations according to the invention can exist not only as mixed formulations of the two components, if appropriate together with further active ingredients, additives and/or customary formulation auxiliaries, which are then applied in the customary manner as a dilution with water, but also as so-called tank mixes by jointly diluting the separately formulated, or partially separately formulated, components with water.

The compounds (A) and (B) or their combinations can be formulated in various ways, depending on the prevailing biological and/or chemical-physical parameters. The following are examples of general possibilities for formulations: wettable powders (WP), emulsifiable concentrates (EC), aqueous solutions (SL), emulsions (EW) such as oil-in-water and water-in-oil emulsions, sprayable solutions or emulsions, oil- or water-based dispersions, suspoemulsions, dusts (DP), seed-dressing materials, granules for soil application or for broadcasting, or water-dispersible granules (WG), ULV formulations, microcapsules or waxes.

The individual formulation types are known in principle and are described for example, in: Winnacker-Küchler, “Chemische Technologie”, Volume 7, C. Hauser Verlag Munich, 4th Edition, 1986; van Valkenburg, “Pesticide Formulations”, Marcel Dekker N. Y., 1973; K. Martens, “Spray Drying Handbook”, 3rd Ed. 1979, G. Goodwin Ltd. London.

The formulation auxiliaries required, such as inert materials, surfactants, solvents and other additives are also known and are described, for example, in Watkins, “Handbook of Insecticide Dust Diluents and Carriers”, 2nd Ed., Darland Books, Caldwell N. J.; H. v. Olphen, “Introduction to Clay Colloid Chemistry”; 2nd Ed., J. Wiley & Sons, N.Y. Marsden, “Solvents Guide”, 2nd Ed., lnterscience, N.Y. 1950; McCutcheon's, “Detergents and Emulsifiers Annual”, MC Publ. Corp., Ridegewood N.J.; Sisley and Wood, “Encyclopedia of Surface Active Egents”, Chem. PubI. Co. Inc., N.Y. 1964; Schönfeldt, “Grenzflächenaktive Äthylenoxidaddukte” [Surface-active ethylene oxide adducts], Wiss. Verlagsgesellschaft, Stuttgart 1976, Winnacker-Küchler, “Chemische Technologie”, Volume 7, C. Hauser Verlag Munich, 4th Edition 1986.

Based on these formulations, combinations with other pesticidally active substances, such as other herbicides, fungicides or insecticides, and with safeners, fertilizers and/or growth regulators, may also be prepared, for example in the form of a readymix or a tank mix.

Wettable powders (sprayable powders) are preparations which are uniformly dispersible in water and which, besides the active ingredient, also comprise ionic or nonionic surfactants (wetters, dispersants), for example polyoxethylated alkylphenols, polyethoxylated fatty alcohols or fatty amines, alkanesulfonates or alkylbenzenesulfonates, sodium lignosulfonate, sodium 2,2′-dinaphthylmethane-6,6′-disulfonate, sodium dibutyinaphthalenesulfonate or else sodium oleoylmethyltauride, in addition to a diluent or inert material.

Emulsifiable concentrates are prepared by dissolving the active ingredient in an organic solvent, for example butanol, cyclohexanone, dimethylformamide, xylene or else higher-boiling aromatics or hydrocarbons with addition of one or more ionic or nonionic surfactants (emulsifiers). Examples of emulsifiers which may be used are: calcium salts of alkylarylsulfonic acids, such as Ca dodecylbenzene sulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxethylene sorbitol esters.

Dusts are obtained by grinding the active ingredient with finely divided solid materials, for example talc, natural clays such as kaolin, bentonite and pyrophyllite, or diatomaceous earth.

Granules can be prepared either by spraying the active ingredient onto adsorptive, granulated inert material or by applying active ingredient concentrates to the surface of carriers such as sand, kaolinites or granulated inert material with the aid of binders, for example polyvinyl alcohol, sodium polyacrylate or else mineral oils. Suitable active ingredients may also be granulated in the manner conventionally used for the production of fertilizer granules, if desired in a mixture with fertilizers. In general, water-dispersible granules are prepared by processes such as spray drying, fluidized-bed granulation, disk granulation, mixing with high-speed mixers and extrusion without solid inert material.

In general, the agrochemical formulations comprise 0.1 to 99 percent by weight, in particular 2 to 95% by weight, of active ingredients of the types A and/or B, the following concentrations being customary, depending on the type of formulation:

The active ingredient concentration in wettable powders is, for example, approximately 10 to 95% by weight, the remainder to 100% by weight being composed of customary formulation constituents. In the case of emulsifiable concentrates, the active ingredient concentration may amount to, for example, 5 to 80% by weight.

Formulations in the form of dusts comprise, in most cases, 5 to 20% by weight of active ingredient, sprayable solutions approximately 0.2 to 25% by weight of active ingredient.

In the case of granules such as dispersible granules, the active ingredient content depends partly on whether the active compound is present in liquid or solid form and on which granulation auxiliaries and fillers are being used. As a rule, the content amounts to between 10 and 90% by weight in the case of the water-dispersible granules.

In addition, the abovementioned active ingredient formulations may comprise, if appropriate, the conventional adhesives, wetters, dispersants, emulsifiers, preservatives, antifreeze agents, solvents, fillers, colorants, carriers, antifoams, evaporation inhibitors, pH regulators or viscosity regulators, thickeners, fertilizers and/or dyes.

For use, the formulations, which are present in commercially available form, are optionally diluted in the customary manner, for example using water in the case of wettable powders, emulsifiable concentrates, dispersions and water-dispersible granules. Preparations in the form of dusts, soil granules, granules for broadcasting and sprayable solutions are usually not diluted further with other inert substances prior to use.

The active ingredients can be applied to the plants, parts of the plants, seeds of the plants or the area under cultivation (soil of the field), preferably to the green plants and parts of the plants and, if appropriate, additionally to the soil of the field.

One possible use is the joint application of the active ingredients in the form of tank mixes, the concentrated formulations of the individual active ingredients, in optimal formulations, jointly being mixed with water in the tank and the resulting spray mixture being applied.

A joint herbicidal formulation of the combination according to the invention of the active ingredients (A) and (B) has the advantage of being easier to apply since the quantities of the components are already presented in the correct ratio to each other. Moreover, the adjuvants in the formulation can be matched optimally to each other, while a tank mix of different formulations may lead to undesired combinations of adjuvants.

A. General Formulation Examples

a) A dust is obtained by mixing 10 parts by weight of an active ingredient/active ingredient mixture and 90 parts by weight of talc as inert material and comminuting the mixture in a hammer mill.

b) A wettable powder which is readily dispersible in water is obtained by mixing 25 parts by weight of an active ingredient/active ingredient mixture, 64 parts by weight of kaolin-containing quartz as inert material, 10 parts by weight of potassium lignosulfonate and 1 part by weight of sodium oleoylmethyltaurinate as wetter and dispersant, and grinding the mixture in a pinned-disk mill.

c) A dispersion concentrate which is readily dispersible in water is obtained by mixing 20 parts by weight of an active ingredient/active ingredient mixture with 6 parts by weight of alkylphenol polyglycol ether (7 Triton X 207), 3 parts by weight of isotridecanol polyglycol ether (8 EO) and 71 parts by weight of paraffinic mineral oil (boiling range for example approx. 255 to 277EC), and grinding the mixture in a ball mill to a fineness of below 5 microns.

d) An emulsifiable concentrate is obtained from 15 parts by weight of an active ingredient/active ingredient mixture, 75 parts by weight of cyclohexanone as solvent and 10 parts by weight of oxethylated nonylphenol as emulsifier.

e) Water-dispersible granules are obtained by mixing

75 parts by weight of an active ingredient/active ingredient mixture,

10 parts by weight of calcium lignosulfonate,

5 parts by weight of sodium lauryl sulfate,

3 parts by weight of polyvinyl alcohol and

7 parts by weight of kaolin,

grinding the mixture on a pinned-disk mill and granulating the powder in a fluidized bed by spraying on water as granulation liquid.

f) Water-dispersible granules are also obtained by homogenizing and precomminuting, in a colloid mill,

25 parts by weight of an active ingredient/active ingredient mixture,

5 parts by weight of sodium 2,2′-dinaphthylmethane-6,6′-disulfonate,

2 parts by weight of sodium oleoylmethyltaurinate,

1 part by weight of polyvinyl alcohol,

17 parts by weight of calcium carbonate and

50 parts by weight of water,

subsequently grinding the mixture in a bead mill and atomizing and drying the resulting suspension in a spray tower by means of a single-substance nozzle.

### Biological Examples

1. Pre-Emergence Effect on Weeds

Seeds or rhizome pieces of monocotyledonous and dicotyledonous weed plants are placed in sandy loam soil in pots and covered with soil. The compositions, formulated in the form of concentrated aqueous solutions, wettable powders or emulsion concentrates, are then applied to the surface of the soil cover as aqueous solution, suspension or emulsion at an application rate of 600 to 800 l of water/ha (converted), in various dosages. After the treatment, the pots are placed in a greenhouse and kept under good growth conditions for the weeds. After the test plants have emerged, the damage to the plants or the negative effects on the emergence is scored visually after a test period of 3 to 4 weeks by comparison with untreated controls. As shown by the test results, the compositions according to the invention have good herbicidal pre-emergence activity against a broad spectrum of weed grasses and broad-leaved weeds.

Scoring and Evaluation of the Synergistic Herbicidal Effects:

The herbicidal efficacy of the active compounds or active compound mixtures was scored visually using the treated plots in comparison to untreated control plots. The damage and development of all above-ground parts of the plants were recorded. Scoring was carried out using a percentage scale (100% effect=all plants killed; 50% effect=50% of the plants and the green parts of the plants killed; 0% effect=no noticeable effect=like control plot. The scores of in each case 4 plots were averaged.

When using the combinations according to the invention, herbicidal effects on a harmful plant species are frequently observed which exceed the formal sum of the activities of the herbicides contained in the combination when applied on their own. Alternatively, in some cases, it can be observed that a lower application rate is required for the herbicide combination in order to obtain, compared to the individual preparations, the same effect on a harmful plant species. Such activity increases or increases in effectiveness or reduced application rates are a strong indication of a synergistic effect.

If the observed activity values already exceed the formal sum of the values for the trials with the individual applications, they also exceed the expected value according to Colby which is calculated using the following formula and which is likewise considered to be an indication of synergism (cf. S. R. Colby; in Weeds 15 (1967) p. 20 to 22):

E=A+B−(A×B/100)

The figures denote: A, B=activity of the active compounds A or B in % at an application rate a or b g of a.s./ha; E=expected value in % of the active compound combination at an application rate of a+b g of a.s./ha (a.s.=active substance).

The observed test results show, at suitable low dosages, an effect of the combinations which exceeds the formal sum of the effects in the case of individual application or the expected values according to Colby.

2. Post-Emergence Effect on Weeds

Seeds or rhizome pieces of monocotyledonous and dicotyledonous weeds are placed in sandy loam soil in pots, covered with soil and grown in a greenhouse under good growth conditions (temperature, atmospheric humidity, water supply). Three weeks after sowing, the test plants are treated at the three-leaf stage with the compositions according to the invention. The compositions according to the invention, formulated as wettable powders or as emulsion concentrates, are sprayed, at various dosages, onto the green parts of the plant at an application rate of 600 to 800 l of water/ha (converted). After the test plants have been in the greenhouse for about 3 to 4 weeks under ideal growth conditions, the effect of the preparations is scored visually by comparison with untreated controls (cf. Section 1). The compositions according to the invention also have a good herbicidal post-emergence activity against a broad spectrum of economically important weed grasses and broad-leaved weeds.

Frequently, activities of the combinations according to the invention are observed which exceed the formal sum of the activities when the herbicides are applied individually. The observed test results show, at suitable low dosages, an effect of the combinations which exceeds the formal sum of the effects in the case of individual application or the expected values according to Colby.

3. Herbicidal Effect and Crop Plant Compatibility (Field Trials)

Crop plants were grown outdoors on plots under natural outdoor conditions, and seeds or rhizome pieces of typical harmful plants were laid out or the natural weed growth was utilized. Treatment with the compositions according to the invention was carried out after the harmful plants had emerged and the crop plants were, generally, at the 2- to 4-leaf stage; in some cases (as stated), application of individual active compounds or active compound combinations was carried out pre-emergence (cf. Section 1) or post-emergence (cf. Section 2) or as a sequential treatment partly pre-emergence and/or post-emergence. After the application, for example 2, 4, 6 and 8 weeks after the application, the effect of the preparations was scored visually by comparison with untreated controls (cf. scoring in Section 1). In the field trial as well, the compositions according to the invention have synergistic herbicidal activity against a broad spectrum of economically important weed grasses and broad-leaved weeds. The comparison showed that the combinations according to the invention in most cases have a higher, in some cases a considerably higher, herbicidal activity than the sum of the activities of the individual herbicides, thus indicating synergism. Moreover, the effects in essential phases of the scoring period were above the expected values according to Colby, also indicating synergism. In contrast, the crop plants were, as a consequence of the treatments with the herbicidal compositions, damaged only to a small degree, if at all.

Abbreviations used in the tables below:

ai=a.s.=active substance (based on 100% active compound

E^{a}=formal sum of the effects of the individual applications (cf. Section 1)

E^{c}=expected value according to Colby (cf. scoring in Section 1)

The numbers in the columns of the table under the designations of the harmful plants and the crop plants relate to the herbicidal effects or damage to the plants in percent.

### EXAMPLE 1

| Compound | g of ai/ha | HORVW | PAPRH |
|---|---|---|---|
| (A4) | 25 | 0 | 0 |
| | 50 | 0 | 0 |
| | 100 | 0 | 0 |
| (B1.1.1) | 1000 | 0 | 15 |
| (A4) + (B1.1.1) | 100 + 1000 | 0 | 90 (E^{a} = 15) |

Field trial, 2-4 leaf stage, scoring 28 days after application
(A4) = compound of the formula (A4), i.e. 4-amino-6-(1-fluoro-1-methylethyl)-2-[2-(3-chlorophenoxy)-1-methylethyl-amino]-1,3,5-triazine
(B1.1.1) = isoproturon
HORVW = winter barley
PAPRH = Papaver rhoeas

### EXAMPLE 2

| Compound | g of ai/ha | HORVW | PAPRH |
|---|---|---|---|
| (A4) | 100 | 0 | 0 |
| | 50 | 0 | 0 |
| | 100 | 0 | 0 |
| (B3.1.5)^{s} | 10 | 0 | 40 |
| (A4) + (B3.1.5)^{s} | 10 + 100 | 0 | 99 (E^{a} = 40) |
| (B3.1.4)^{s} | 2.5 | 0 | 0 |
| (A4) + (B3.1.4)^{s} | 100 + 2.5 | 0 | 99 (E^{a} = 0) |
| | 50 + 2.5 | 0 | 90 (E^{a} = 0) |
| | 25 + 2.5 | 0 | 90 (E^{a} = 0) |

Field trial —Fall application 2-4 leaf stage - evaluation 45 days after the application
(A4) = compound of the formula (A4), i.e. 4-amino-6-(1-fluoro-1-methylethyl)-2-[2-(3-chlorophenoxy)-1-methylethyl-amino]-1,3,5-triazine
^{s}= in combination with the safener mefenpyr-diethyl
(B3.1.4) = iodosulfuron-methyl sodium salt
(B3.1.5) = (methyl 4-methylsulfonylamino-2-(4,6-dimethoxypyrimidin-2-ylcarbamoylsulfamoyl)benzoate)
HORVW = Hordeum vulgare (W) = winter barley
PAPRH = Papaver rhoeas

### EXAMPLE 3

| Compound | g of ai/ha | TRZAW | VIOAR |
|---|---|---|---|
| (B3.1.5)^{s} | 10 | 0 | 13 |
| (B3.1.5)^{s} + (B3.1.4) | 10 + 2.5 | 0 | 24 |
| (A4) | 50 | 0 | 78 |
| | 100 | 0 | 88 |
| (B3.1.5)^{s} + (B3.1.4) + (A4) | (10 + 2.5) + 100 | 0 | 97 (E^{c} = 91) |

Field trial: = Fall application 2-4 leaf stage Evaluation - 60 days after application
^{s}= in combination with safener mefenpyr-diethyl
(A4) = compound of the formula (A4), i.e. 4-amino-6-(1-fluoro-1-methylethyl)-2-[2-(3-chlorophenoxy)-1-methylethyl-amino]-1,3,5-triazine
(B3.1.4) = iodosulfuron-methyl sodium salt
(B3.1.5) = (methyl 4-methylsulfonylamino-2-(4,6-dimethoxypyrimidin-2-ylcarbamoylsulfamoyl)benzoate)
TRZAW = Triticum aestivum (W) = winter wheat
VIOAR = Viola arvensis

### EXAMPLE 4

| | | | Aphanes | Veronica |
|---|---|---|---|---|
| Compound | g of ai/ha | TRZAW | arvensis | hederifolia |
| (A4) | 100 | 0 | 20 | 40 |
| (B3.1.4)^{s} + (B3.1.5) | 2.5 + 10 | 0 | 60 | 55 |
| (A4) + ((B3.1.4)^{s} + (B3.1.5)) | 100 + (2.5 + 10) | 0 | 85 (E^{a} = 80) | 90 (E^{a} = 73) |

Field trial: Application fall - 2-4 leaf stage Evaluation 60 days after application
^{s}= in combination with the safener mefenpyr-diethyl
(A4) = see Example 3
(B3.1.4) = iodosulfuron-methyl sodium salt (see Example 3)
(B3.1.5) = see Example 3

### EXAMPLE 5

| Compound | g of ai/ha | HORVW | PAPRH |
|---|---|---|---|
| (B3.1.4) | 2.5 | 0 | 0 |
| (B3.1.5)^{s} | 10 | 0 | 40 |
| (B3.1.4) + (B3.1.5)^{s} | 2.5 + 10 | 0 | 80 (E^{a} = 40) |
| (A4) | 100 | 0 | 0 |
| | 50 | 0 | 0 |
| [(B3.1.4) + (B3.1.5)^{s}] + | (2.5 + 10) + 100 | 0 | 100 (E^{a} = 80) |
| (A4) | (2.5 + 10) + 50 | 0 | 100 (E^{a} = 80) |

Field trial: 2-4 leaf stage Scoring 28 days after application
^{s}= in combination with safener mefenpyr-diethyl
(A4) = see Example 3
(B3.1.4) = iodosulfuron-methyl sodium salt
(B3.1.5) = see Example 3
HORVW = Hordeum vulgare W (winter barley)
PAPRH = Papaver rhoeas

### EXAMPLE 6

| Compound | g of ai/ha | TRZAW | VERPE |
|---|---|---|---|
| (B1.1.1) + (B1.3.3)^{s} | (750) + 40 | 2 | 40 |
| (A3) | 50 | 0 | 55 |
| (A3) + (B1.1.1) + | 50 + (750 + 40) | 6 | 96 (E^{a} = 95) |
| (B1.3.3)^{s} | | | |

Field trial; stage begin of VERPE blossom, evaluation 28 days after application
(A3) = Compound of the formula (A3), i.e. 4-amino-6-(1-fluoro-1-methylethyl)-2-(3-phenyl-1-ethylpropylamino)-1,3,5-triazine
(B1.1.1) = isoproturon
(B1.3.3) = fenoxaprop-P-ethyl
^{s}= with the safener mefenpyr-diethyl
TRZAW = Triticum aestivum (W) = winter wheat
VERPE = Veronica persicaria

### EXAMPLE 7a

| Compound | g of ai/ha | TRZAW | CHEAL |
|---|---|---|---|
| (B3.1.4)^{s} | 2.5 | 6 | 74 |
| (A3) | 25 | 1 | 5 |
| | 50 | 0 | 35 |
| | 100 | 10 | 85 |
| (B3.1.4)^{s} + (A3) | 2.5 + 50 | 7 | 95 (E^{c} = 85) |

Field trial: 2-4 leaf stage; evaluation 28 days after application

### EXAMPLE 7b

| Compound | g of ai/ha | TRZAW | STEME |
|---|---|---|---|
| (B3.1.5)^{s} | 10 | 2 | 20 |
| (A3) | 50 | 2 | 48 |
| (B3.1.5)^{s} + (A3) | 10 + 50 | 3 | 71 (E^{a} = 20 + 48) |

Field trial: 2-4 leaf stage; evaluation 28 days after application
Abbreviations for 7a and b:
^{s}= with the safener mefenpyr-diethyl
(A3) = see Example 6
(B3.1.4) = iodosulfuron-methyl sodium salt (see Example 3)
(B3.1.5) = see Example 3
CHEAL = Chenopodium album
STEME = Stellaria media
TRZAW = Triticum aestivum (W) = winter wheat

### EXAMPLE 8

| Compound | g of ai/ha | TRZAW | VERHE |
|---|---|---|---|
| (B3.1.5)^{s} | 10 | 0 | 0 |
| (A5) | 25 | 0 | 14 |
| | 50 | 0 | 22 |
| | 100 | 0 | 34 |
| (B3.1.5)^{s} + (A5) | 10 + 25 | | 82 (E^{a} = 14) |

Field trial; 4-leaf stage; 28 days after application
(A5) = compound of the formula (A5), i.e. 4-amino-6-(1-fluoro-1-methylethyl)-2-[2-(3-chloro-5-methoxyphenoxy)-1-methylethylamino]-1,3,5-triazine
(B3.1.5) = see Example 3
^{s}= with the safener mefenpyr-diethyl
VERHE = Veronica hederofolia
TRZAW = Triticum aestivum (W) = winter wheat

### EXAMPLE 9

### Aminotriazines in Cereals: (A1) and (A2)

| Active compound(s) | g of ai/ha | HORVW | TRZAW | CAPBP | ALOMY |
|---|---|---|---|---|---|
| (A1) | 100 | 0 | 0 | 88 | 0 |
| (A2) | 100 | 0 | 0 | 90 | 0 |
| (B1.1.1) | 2000 | 0 | 0 | 0 | 0 |
| (A1) + (B1.1.1) | 100 + 2000 | 0 | 0 | 99 (E^{a} = 88) | 92 (E^{a} = 0) |
| (A2) + (B1.1.1) | 100 + 2000 | 0 | 0 | 97 (E^{a} = 90) | 52 (E^{a} = 0) |

Examples from a group of field trials: Application 1-3 leaf stage broad-leaved weeds
Evaluation 120 to 160 days after application
(B1.1.1) = isoproturon
(A1) = compound of the formula (A1), i.e. 4-amino-6-(1-fluoro-1-methylethyl)-2-(3-phenyl-1-cyclobutylpropylamino)-1,3,5-triazine
(A2) = compound of the formula (A2), i.e. 4-amino-6-(1-fluoro-1-methylethyl)-2-(4-phenyl-1-cyclopropylbutylamino)-1,3,5-triazine
CAPBP = Capsella bursa-pastoris
ALOMY = Alopecurus myosuroides
HORVW = Hordeum vulgare W (winter barley)
TRZAW = Triticum aestivum (W) = winter wheat
VIOAR = Viola arvensis

### EXAMPLE 10

| Active compound(s) | g of ai/ha | GALAP | TRZAW |
|---|---|---|---|
| (A1) | 50 | 45 | 1 |
| | 100 | 45 | 2 |
| (B1.2.1) | 180 | 45 | 2 |
| (A1) + (B1.2.1) | 50 + 180 | 75 (E^{c} = 70) | 3 |
| | 100 + 180 | 88 (E^{c} = 70) | 4 |
| (B1.2.2) | 1000 | 30 | |
| (A1) + (B1.2.2) | 50 + 1000 | 93 (E^{a} = 75) | 3 |
| | 100 + 1000 | 96 (E^{a} = 75) | 5 |
| (B1.1.1) | 1000 | 15 | 0 |
| (A1) + (B1.1.1) | 50 + 1000 | 98 (E^{a} = 60) | 6 |
| (B3.4.4) | 250 | 50 | 2 |
| (A1) + (B3.4.4) | 50 + 250 | 98 (E^{a} = 95) | 7 |
| | 100 + 250 | 99 (E^{a} = 95) | 7 |

Pre-emergence application, fall, evaluation 169 days after application
(A1) = see Example 9
(B1.2.1) = fluthiamide = flufenacet,
(B1.2.2) = pendimethalin
(B1.1.1) = isoproturon
(B3.4.4) = flurtamone
GALAP = Galium aparine
TRZAW = Triticum aestivum (W) = winter wheat

### EXAMPLE 11

| Active compound(s) | g of ai/ha | CAPPBP | | TRZAW |
|---|---|---|---|---|
| (A1) | 25 | 40 | | 0 |
| | 50 | 68 | | 1 |
| | 75 | 73 | | 1 |
| | 100 | 79 | | 2 |
| (B1.3.3)^{s} | 60 | 10 | | 1 |
| (A1) + (B1.3.3)^{s} | 50 + 60 | 100 | (E^{a} = 78) | 3 |
| (B3.4.2) | 75 | 45 | | 0 |
| | 150 | 67 | | 0 |
| (A1) + (B3.4.2) | 25 + 75 | 96 | (E^{a} = 95) | 2 |
| | 25 + 150 | 97 | (E^{a} = 80) | 3 |

Field trial: Application in the 2- to 4-leaf stage
Evaluation 28 days after application
(A1) = see Example 9
(B1.3.3) = fenoxaprop-P-ethyl
^{s} = with the safener mefenpyr-diethyl
(B3.4.2) = diflufenican
CAPBP = Capsella bursa-pastoris
TRZAW = Triticum aestivum (W) = winter wheat

### EXAMPLE 12

| Active compound(s) | g of ai/ha | LAMPU | TRZAW |
|---|---|---|---|
| (A1) | 12.5 | 25 | 0 |
| | 25 | 65 | 0 |
| | 50 | 70 | 0 |
| (B2.6.8) | 25 | 60 | 3 |
| | 50 | 60 | 3 |
| (A1) + (B2.6.8) | 12.5 + 25 | 93 (E^{a} = 85) | 4 |
| (B2.5.2) | 3.7 | 35 | 3 |
| | 7.5 | 35 | 3 |
| | 15 | 40 | 6 |
| (A1) + (B2.5.2) | 12.5 + 3.7 | 78 (E^{a} = 60) | 4 |

Field trial: Application in the 2- to 4-leaf stage
Evaluation 42 days after application
(A1) = see Example 9
(B2.6.8) = cinidon-ethyl
(B2.5.2) = florasulam
LAMPU = Lamium purpurea
TRZAW = Triticum aestivum (W) = winter wheat

### EXAMPLE 13

| | | | |
|---|---|---|---|
| Compound | g of ai/ha | SORVE | TRZAS |

| | | | | |
|---|---|---|---|---|
| (A1) | 62.5 | 35 | | 5 |
| | 125 | 50 | | 13 |
| (B2.3.1) | 225 | 0 | | 0 |
| | 450 | 25 | | 0 |
| (A1) + (B2.3.1) | 62.5 + 450 | 73 | (E^{a} = 60) | 8 |
| | 125 + 225 | 65 | (E^{a} = 50) | 12 |
| (B2.1.1) | 12.5 | 0 | | 0 |
| (A1) + (B2.1.1) | 62.5 + 12.5 | 53 | (E^{a} = 35) | 3 |
| | 125 + 12.5 | 76 | (E^{a} = 50) | 8 |

Field trial: Application in the 2- to 4-leaf stage
Evaluation 17 days after application
(A1) = see Example 9
(B2.3.1) = bromoxynil
(B2.1.1) = tribenuron-methyl
SORVE = Sorghum verticilliflorum
TRZAS = Triticum aestivum (S) = summer wheat

### EXAMPLE 14

| Active compound(s) | g of ai/ha | MATCH | | TRZAS |
|---|---|---|---|---|
| (A1) | 25 | 43 | | 2 |
| | 50 | 58 | | 2 |
| | 100 | 73 | | 5 |
| (B2.2.4) | 750 | 54 | | 0 |
| | 1500 | 63 | | 0 |
| (A1) + (B2.2.4) | 25 + 750 | 98 | (E^{c} = 97) | 1 |
| | 25 + 1500 | 100 | (E^{c} = 80) | 2 |
| (B2.3.2) | 187 | 30 | | 2 |
| | 375 | 45 | | 3 |
| (A1) + (B2.3.2) | 25 + 187 | 99 | (E^{a} = 73) | 3 |
| | 25 + 375 | 100 | (E^{a} = 90) | 4 |

Field trial: Application in the 2- to 4-leaf stage
Evaluation 28 days after application
(A1) = see Example 9
(B2.2.4) = mecoprop-P (MCCP-P)
(B2.3.2) = ioxynil
MATCH = Matricaria chamomilla
TRZAS = Triticum aestivum (S) = summer wheat

### EXAMPLE 15

| Active compound(s) | g of ai/ha | LAMAM | | TRZAW |
|---|---|---|---|---|
| (A1) | 25 | 60 | | 0 |
| | 50 | 74 | | 2 |
| | 100 | 80 | | 2 |
| (B2.1.4) | 12.5 | 10 | | 0 |
| | 25 | 25 | | 0 |
| (A1) + (B2.1.4) | 25 + 25 | 100 | (E^{a} = 85) | 1 |
| | 25 + 12.5 | 97 | (E^{a} = 70) | 0 |
| | 50 + 25 | 100 | (E^{a} = 99) | 1 |
| | 100 + 12.5 | 99 | (E^{a} = 90) | 2 |

Field trial: Application in the 2- to 4-leaf stage
Evaluation 28 days after application
(A1) = see Example 9
(B2.1.4) = amidosulfuron
LAMAM = Lamium amolexicaule
TRZAW = Triticum aestivum (W) = winter wheat

### EXAMPLE 16

### Synergistic Effect/Broadening of the Spectrum

| | Active compound(s) | | | |
|---|---|---|---|---|
| | (A1) | (B1.2.1) | (A1) + (B1.2.1) | |
| | Application rate (g of ai/ha) | | | |
| | 50 | 180 | 50 + 180 | |
| Species/herbicidal | | | | |
| effect (%): | | | | |
| MYOAR | 81 | 16 | 99 | (E^{a} = 97) |
| ANTAR | 0 | 25 | 100 | (E^{a} = 25) |
| LAMSS | 53 | 87 | 97 | (E^{c} = 94) |
| MATCH | 19 | 61 | 97 | (E^{a} = 80) |
| GALAP | 66 | 68 | 92 | (E^{c} = 89) |
| HORVW | 0 | 0 | 0 | |
| TRZAW | 0 | 0 | 0 | |
| PAPRH | 96 | 12 | 100 | (E^{c} = 96) |
| VIOAR | 90 | 20 | 99 | (E^{c} = 92) |

Field trial: Post-emergence, application in the 2- to 3-leaf stage
Evaluation 69 days after application
(A1) = see Example 9
(B1.2.1) = flufenacet = fluthiamide
MYOAR = Myosotis arvensis
ANTAR = Anthemis arvensis
LAMSS = Lamium ssp.
MATCH = Matricaria chamomilla
GALAP = Galium aparine
HORVW = Hordeum vulgare W (winter barley)
TRZAW = Triticum aestivum (W) = winter wheat
PAPRH = Papaver rhoeas
VIOAR = Viola arvensis

### EXAMPLE 17

| Active | | | | |
|---|---|---|---|---|
| compound(s) | g of ai/ha | IPOHE | SETFA | ZEAMA |
| (A1) | 50 | 85 | 85 | 0 |
| | 100 | 93 | 94 | 0 |
| (B3.4.5) | 105 | 87 | 90 | 0 |
| | 210 | 85 | 93 | 0 |
| (A1) + | 100 + 105 | 100 | 100 | 0 |
| (B3.4.5) | | (E^{c} = 99) | (E^{c} = 99) | |
| | 50 + 105 | 100 | 100 | 0 |
| | | (E^{c} = 98) | (E^{c} = 98) | |

Field trial: Pre-emergence, evaluation 16 days after application
(A1) = see Example 9
(B3.4.5) = isoxaflutole
IPOHE = Ipomoea hederacea
SETFA = Setaria faberi
ZEAMA = Zea mays (corn)

### EXAMPLE 18

| Active compounds | g of ai/ha | ELEIN | Corn (LL) |
|---|---|---|---|
| (A1) | 100 | 0 | 0 |
| (B4.1.2) | 300 | 55 | 0 |
| | 600 | 78 | 0 |
| (A1) + (B4.1.2) | 100 + 300 | 90 (E^{a} = 55) | 0 |
| | 100 + 600 | 93 (E^{a} = 78) | 0 |
| (B3.1.11)^{s} | 30 | 75 | 0 |
| | 45 | 80 | 0 |
| (A1) + (B3.1.11)^{s} | 100 + 30 | 88 (E^{a} = 75) | 0 |
| | 100 + 60 | 93 (E^{a} = 80) | 0 |

Field trial: Application in the 3-leaf stage, evaluation 31 days after application
Corn (LL) = corn which is glufosinate-ammonium-resistant
(A1) = see Example 9
(B4.1.2) = glufosinate-ammonium
(B3.1.11) = AEF360
^{s} = combined with safener (S1-9) (isoxadifen-ethyl)
ELEIN = Elusine indica

### EXAMPLE 19

| Active compound | g of ai/ha | ZEAMA | SETVI | ECHCG |
|---|---|---|---|---|
| (A1) | 100 | 0 | 0 | 0 |
| (B3.1.11)^{s} | 45 | 0 | 68 | 78 |
| (A1) + | (100 + 45) | 0 | 83 (E^{a} = 68) | 90 (E^{a} = 78) |
| (B3.1.11)^{s} | | | | |
| (B3.1.11)^{s} + | (30 + 1) | 0 | 40 | 55 |
| (B3.1.4) | | | | |
| (A1) + | 100 | 0 | 85 (E^{a} = 40) | 95 (E^{a} = 55) |
| (B3.1.11)^{s} + | (30 + 1) | | | |
| (B3.1.4) | | | | |

Field trial: Application in the 4 to 5-leaf stage
Evaluation 31 days after application
(A1) = see Example 9
(B3.1.11) = AEF360
(B3.1.4) = iodosulfuron-methyl sodium salt
^{s} = combined with safener (S1-9) (isoxadifen-ethyl)
SETVI = Setaria viridis
ECHCG = Echinochloa crus-galli
ZEAMA = Zea mays (corn)

### EXAMPLE 20

| Active compound(s) | g of ai/ha | EPHHL | ORYSA |
|---|---|---|---|
| (A1) | 25 | 15 | 0 |
| | 50 | 50 | 0 |
| | 100 | 60 | 0 |
| (B2.1.9) | 22.5 | 45 | 0 |
| | 45 | 65 | 0 |
| (A1) + | 25 + 22.5 | 75 (E^{a}= 60) | 0 |
| (B2.1.9) | | | |

Field trial: Application in the 3-leaf stage, evaluation 31 days after application
(A1) = see Example 9
(B2.1.9) = ethoxysulfuron
EPHHL = Euphorbia heterophylla
ORYSA = Oryza sativa (rice)

### EXAMPLE 21

| Active compounds | g of ai/ha | PHBPU | ORYSA |
|---|---|---|---|
| (A1) | 25 | 90 | 0 |
| | 50 | 95 | 0 |
| | 100 | 97 | 0 |
| (B1.3.3)^{s} | 45 | 0 | 0 |
| | 60 | 0 | 0 |
| (A1) + (B1.3.3)^{s} | 50 + 45 | 97 (E^{a} = 95) | 0 |

Field trial: Application in the 4-leaf stage, evaluation 42 days after application
(B1.3.3) = fenoxaprop-P-ethyl
^{s}= combined with safener (S1-9) (isoxadifen-ethyl)
PHBPU = Pharbitis purpurea
ORYSA = Oryza sativa (rice)

### EXAMPLE 22

| Active compounds | g of ai/ha | MOOVA | ORYSA |
|---|---|---|---|
| (A1) | 25 | 3 | 0 |
| | 50 | 90 | 10 |
| | 100 | 95 | 13 |
| (B1.6.5) | 250 | 95 | 5 |
| (A1) + (B1.6.5) | 25 + 250 | 100 (E^{a} = 98) | 0 |
| (B1.6.14) | 25 | 82 | 0 |
| (A1) + (B1.6.14) | 25 + 25 | 100 (E^{a} = 85) | 9 |
| (B1.6.4)^{s} | 60 | 73 | 0 |
| (A1) + (B1.6.4) | 25 + 60 | 100 (E^{a} = 76) | 0 |
| (B2.6.3) | 60 | 47 | 0 |
| (A1) + (B2.6.3) | 25 + 60 | 100 (E ^{a} = 47) | 0 |

Field trial: Application in the 2-leaf stage, evaluation 14 days after application
(B1.6.5) = anilofos
(B1.6.14) = AEB391
(B1.6.4) = MY100
(B2.6.3) = carfentrazone-ethyl
MOOVA = Monochoria vaginalis
ORYSA = Oryza sativa (rice)

1. A herbicide combination herbicide combinations comprising a synergistically effective amount of components (A) and (B), where
(A) is one or more herbicidally active aminotriazine compounds having a partial structure of the formula (I) 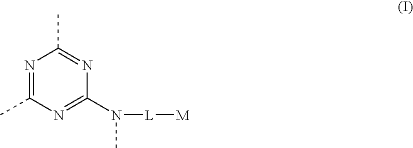
where
L: is a straight-chain or branched, optionally mono- or polysubstituted and/or -bridged alkylene group having 1 to 6 carbon atoms, where one CH₂ group may be replaced by O, N, S(O)ₓ, where x is 0, 1 or 2, or by NO, or is a corresponding alkenylene or alkynylene group having 2 to 8 carbon atoms, where one CH₂ group may be replaced by O, and which is optionally mono- or polysubstituted and/or bridged, and
M is an unsubstituted or substituted aryl or heterocyclyl group, with the proviso that one of the two remaining radicals on the triazine ring is haloalkyl if -L- is a group of the formula —CH(CH₃)—CH₂—O—, and
(B) is one or more herbicides selected from the group of compounds consisting of
(B1) foliar- and/or soil-acting herbicides which are active against monocotyledonous harmful plants,
(B2) herbicides which are active against predominantly dicotyledonous harmful plants and
(B3) herbicides which are active against monocotyledonous and dicotyledonous harmful plants and
(B4) herbicides which are active against monocotyledonous and dicotyledonous harmful plants and which can be employed specifically in tolerant crops or on non-crop land, except for combinations of herbicides of the formula (I′) 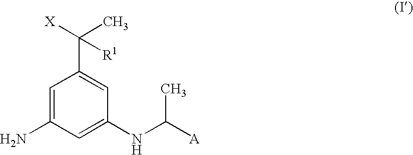
in which
R¹ is H or methyl,
X is a chlorine or fluorine atom and
A is a phenoxymethyl group which is unsubstituted in the phenyl ring or substituted by one or two radicals selected from the group consisting of methyl and fluorine, or
is a benzofuran-2-yl or benzothiophen-2-yl radical,
with herbicides from the group consisting of isoproturon, diclofop-methyl, fenoxaprop-ethyl and amidosulfuron.

2. The herbicide combination as claimed in claim 1, wherein component (A) comprises a compound of the formula (II)-(IX):
compounds of the formula (II) and their salts 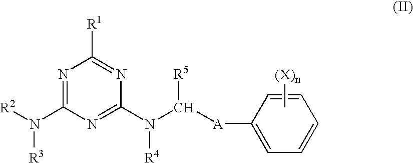
in which
R¹ is (C₁-C₆)-alkyl,
which is unsubstituted or substituted by one or more radicals selected from the group consisting of halogen, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-C₄)-alkynyl, phenyl, which is unsubstituted or substituted, and heterocyclyl having 3 to 6 ring atoms and 1 to 3 hetero ring atoms selected from the group consisting of N, O and S, the ring being unsubstituted or substituted,
R² and R³ in each case independently of one another are hydrogen, amino or alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical or
R² and R³ together with the nitrogen atom of the group NR²R³ are a heterocyclic radical having 3 to 6 ring atoms and 1 to 4 hetero ring atoms, where the further hetero ring atoms which are optionally present in addition to the nitrogen atom are selected from the group consisting of N, O and S and the radical is unsubstituted or substituted,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms, preferably having 1 to 6 carbon atoms or a heterocyclyl radical, heterocyclyloxy radical or heterocyclylamino .radical having in each case 3 to 6 ring atoms and 1 to 3 hetero ring atoms selected from the group consisting of N, O and S, where each of the five last-mentioned radicals is unsubstituted or substituted, or an acyl radical,
R⁵ is hydrogen, halogen, nitro, cyano, thiocyanato or a radical of the formula —B¹—Y¹, where B¹ and Y¹ are as defined below,
A is an alkylene radical having 1 to 5 straight-chain carbon atoms or alkenylene or alkynylene having in each case 2 to 5 straight-chain carbon atoms, where each of the three last-mentioned diradicals is unsubstituted or substituted by one or more radicals selected from the group consisting of halogen, nitro, cyano, thiocyanato and a radical of the formula —B²—Y²,
(X)ₙ are n substituents X, where X in each case independently of one another, is halogen, (C₁-C₆)-alkyl, (C₂-C₆)-alkenyl, (C₂-C₆)-alkynyl, (C₁-C₆)-alkoxy, (C₂-C₆)-alkenyloxy, (C₂-C₆)-alkynyloxy, [(C₁-C₄)-alkyl]-carbonyl, [(C₁-C₄)-alkoxy]-carbonyl or [(C₁-C₄)-alkylthio]-carbonyl, where the hydrocarbon-containing moieties in the 9 last-mentioned radicals are unsubstituted or substituted, or is a radical of the formula —B^{o}—R^{o}, where B^{o} is as defined below and R^{o} is an aromatic, saturated or partially saturated carbocyclic or heterocyclic radical, where the cyclic radical is substituted or unsubstituted, or two adjacent radicals X together are a fused-on cycle having 4 to 6 ring atoms which is carbocyclic or contains hetero ring atoms selected from the group consisting of O, S and N and which is unsubsituted or substituted by one or more radicals selected from the group consisting of halogen, (C₁-C₄)-alkyl and oxo,
n is 0, 1, 2, 3, 4 or 5,
B^{o},B¹,B² in each case independently of one another are a direct bond or a divalent group of the formula —O—, —S(O)ₚ—, —S(O)ₚ—O—, —O—S(O)ₚ—, —CO—, —O—CO—, —CO—O—, —NR′—, —O—NR′—, —NR′—O—, —NR′—CO—, —CO—NR′—, where p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,
Y¹,Y² in each case independently of one another are H or an acyclic hydrocarbon radical having, for example, 1 to 20 carbon atoms or a cyclic hydrocarbon radical having 3 to 8 carbon atoms or a heterocyclic radical having 3 to 9 ring atoms and 1 to 3 hetero ring atoms selected from the group consisting of N, O and S, where each of the three last-mentioned radicals is unsubstituted or substituted;
compounds of the formula (III) or their salts 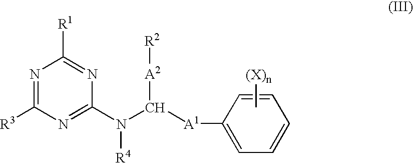
in which
R¹ is aryl, which is unsubstitued or substituted, or (C₃-C₉)-cycloalkyl, which is unsubstituted or substituted, or heterocyclyl, which is substituted or unsubstituted, or
(C₁-C₆)-alkyl, (C₂-C₆)-alkenyl or (C₂-C₆)-alkynyl,
where each of the 3 last-mentioned radicals is unsubstituted or substituted by one or more radicals selected from the group consisting of halogen, hydroxyl, cyano, nitro, thiocyanato, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl and (C₃-C₉)-cycloalkyl, which is unsubstituted or substituted, and phenyl, which is unsubstituted or substituted, and heterocyclyl, which is unsubstituted or substituted, and radicals of the formulae R′—C(═Z′)—, R′—C(═Z′)—Z—, R′—Z—C(═Z′)—, R′R″N—C(═Z′)—, R′—Z—C(═Z′)—O—, R′R−N—C(═Z′)—Z—, R′—C(═Z′)—NR″ and R′R″N—C(═Z′)—NR′″—, in which R′, R″ and R′″ in each case independently of one another are (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted, and in which Z and Z′ independently of one another are each an oxygen or sulfur atom,
R² is (C₃-C₉)-cycloalkyl, which is unsubstituted or substituted, (C₄-C₉)-cycloalkenyl, which is unsubstituted or substituted, heterocyclyl, which is unsubstituted or substituted, or phenyl, which is unsubstituted or substituted, or R³ is hydrogen, (C₁-C₆)-alkyl, aryl or (C₃-C₉)-cycloalkyl, where each of the 3 last-mentioned radicals is unsubstituted or substituted, or a radical of the formula —N(B¹-D¹)(B²-D²) or —NR′—N(B¹-D¹)(B²-D²), in which in each case B¹, B², D¹ and D² are as defined below and R′ is hydrogen, (C₁-C₆)-alkyl or [(C₁-C₄)-alkyl]-carbonyl,
R⁴ is a radical of the formula —B³-D³, where B³ and D³ are as defined below,
A¹ is straight-chain alkylene having 1 to 5 carbon atoms or straight-chain alkenylene or alkynylene having in each case 2 to 5 carbon atoms, where each of the three last-mentioned diradicals is unsubstituted or substituted by one or more radicals selected from the group consisting of halogen, nitro, cyano, thiocyanato and radicals of the formula —B⁴-D⁴, where B⁴ and D⁴ are as defined below,
A² is a direct bond or straight-chain alkylene having 1 to 4 carbon atoms or straight-chain alkenylene or alkynylene having in each case 2 to 5 carbon atoms, where each of the three last-mentioned diradicals is unsubstituted or substituted by one or more radicals selected from the group consisting of halogen, nitro, cyano, thiocyanato and radicals of the formula —B⁵-D⁵, or a divalent radical of the formula V¹, V², V³, V⁴ or V⁵,
—CR⁶R⁷—W*—CR⁸R⁹— (V¹)
—CR¹⁰R¹¹—W*—CR¹²R¹³—CR¹⁴R¹⁵— (V²)
—CR¹⁶R¹⁷—CR¹⁸R¹⁹—W*—CR²⁰R²¹ (V³)
—CR²²R²³—CR²⁴R²⁵—W*— (V⁴)
—CR²⁶R²⁷—W*— (V⁵)
where each of the radicals R⁶ to R²⁷, in each case independently of one another, is hydrogen, halogen,. nitro, cyano, thiocyanato or a radical of the formula —B⁶-D⁶,
W* is in each case an oxygen atom, a sulfur atom or a group of the formula N(B⁷-D⁷) and
B⁵, B6, B⁷, D⁵, D⁶ and D⁷ are as defined below,
B¹, B², B³ and B⁷ in each case independently of one another are a direct bond or a divalent group of the formulae —C(═Z*)—, —C(═Z*)—Z**—, —C(═Z*)—NH— or —C(═Z*)—NR*—, where Z*=an oxygen or sulfur atom, Z**=an oxygen or sulfur atom and R*=(C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted,
B⁴, B⁵ and B⁶ in each case independently of one another are a direct bond or a divalent group of the formulae —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where p is the integer 0, 1 or 2 and R^{O} is hydrogen, (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubsituted or substituted,
D¹, D², D³, D⁴, D⁵ and D⁶ in each case independently of one another are hydrogen, (C₁-C₆)-alkyl, aryl, aryl-(C₁-C₆)-alkyl, (C₃-C₉)-cycloalkyl or (C₃-C₉)-cycloalkyl-(C₁-C₆)-alkyl, where each of the 5 last-mentioned radicals is unsubstituted or substituted, or in each case two radicals D⁵ of two groups —B⁵-D⁵ attached to one carbon atom are attached to one another forming an alkylene group having 2 to 4 carbon atoms which is unsubstituted or substituted by one or more radicals selected from the group consisting of (C₁-C₄)-alkyl and (C₁-C₄)-alkoxy,
(X)ₙ are n substituents X, where X, in each case independently of one another, is halogen, hydroxyl, amino, nitro, formyl, carboxyl, cyano, thiocyanato, aminocarbonyl or (C₁-C₆)-alkyl, (C₁-C₆)-alkoxy, (C₁-C₆)-alkylthio, mono-(C₁-C₆)-alkylamino, di-(C₁-C₄)-alkylamino, (C₂-C₆)-alkenyl, (C₂-C₆)-alkynyl, [(C₁-C₆)-alkyl]-carbonyl, [(C₁-C₆)-alkoxy]-carbonyl, mono-(C₁-C₆)-alkylamino-carbonyl di-(C₁-C₄)-alkylamino-carbonyl, N-(C₁-C₆)-alkanoyl-amino or N-(C₁-C₄)-alkanoyl-N-(C₁-C₄)-alkylamino, where each of the 13 last-mentioned radicals is unsubsituted or substituted, preferably unsubstituted or substituted by one or more radicals selected from the group consisting of halogen, hydroxyl, amino, nitro, formyl, carboxyl, cyano, thiocyanato, (C₁-C₄)-alkoxy, (C₁-C₄)-haloalkoxy, (C₁-C₄)-alkylthio, (C₁-C₄)-haloalkylthio, mono-(C₁-C₄)-alkylamino, di-(C₁-C₄)-alkylamino, (C₃-C₉)-cycloalkyl, (C₃-Cg)-cycloalkyl-amino, [(C₁-C₄)-alkyl]-carbonyl, [(C₁-C₄)-alkoxy]-carbonyl, aminocarbonyl, mono-(C₁-C₄)-alkylamino-carbonyl, di-(C₁-C₄)-alkylamino-carbonyl, phenyl, phenoxy, phenylthio, phenylcarbonyl, heterocyclyl, heterocyclyloxy, heterocyclylthio and heterocyclylamino, where each of the 8 last-mentioned radicals is unsubstituted or substituted by one or more substituents selected from the group consisting of halogen, nitro, cyano, (C₁-C₄)-alkyl, (C₁-C₄)-alkoxy, (C₁-C₄)-alkylthio, (C₁-C₄)-haloalkyl, (C₁-C₄)-haloalkoxy, formyl, (C₁-C₄)-alkyl-carbonyl and (C₁-C₄)-alkoxy-carbonyl,
or (C₃-C₉)-cycloalkyl, (C₃-C₉)-cycloalkoxy, (C₃-C₉)-cycloalkylamino, phenyl, phenoxy, phenylthio, phenylcarbonyl, heterocyclyl, heterocyclyloxy, heterocyclylthio or heterocyclylamino, where each of the 11 last-mentioned radicals is unsubstituted or substituted, or two adjacent radicals X together are a fused-on cycle having 4 to 6 ring atoms which is carbocyclic or contains hetero ring atoms selected from the group consisting of O, S and N and which is unsubstituted or substituted by one or more radicals selected from the group consisting of halogen, (C₁-C₄)-alkyl and oxo,
n is 0, 1, 3, 4 or 5 and
“Heterocyclyl” in the radicals mentioned above, independently of one another, is in each case a heterocyclic radical having 3 to 7 ring atoms and 1 to 3 heteroatoms selected from the group consisting of N, O and S,
where
a) the total of the carbon atoms in the radicals A¹ and A²-R² is at least 6 carbon atoms or
b) the total of the carbon atoms in the radicals A¹ and A²-R² is 5 carbon atoms and A¹=a group of the formula —CH₂— or —CH₂CH₂— and R¹=(C₁-C₄)-alkyl, (C₁-C₄)-haloalkyl, (C₂-C₆)-haloalkenyl or (C₃-C₉)-cycloalkyl, which is unsubstituted or substituted;
compounds of the formula (IV) or their salts 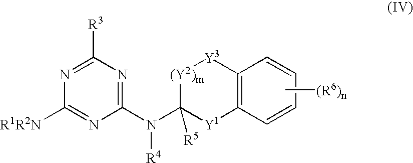
in which
R¹ and R² in each case independently of one another are hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical, heterocyclylthio radical or heterocyclylamino radical having in each case 3 to 6 ring atoms and 1 to 3 hetero ring atoms selected from the group consisting of N, O and S, where each of the five last-mentioned radicals is unsubstituted or substituted, or
an acyl radical or
R¹ and R² together with the nitrogen atom of the group NR¹R² are a heterocyclic radical having 3 to 6 ring atoms and 1 to 4 hetero ring atoms, where any further hetero ring atoms present in addition to the nitrogen atom are selected from the group consisting of N, O and S and the radical is unsubstituted or substituted,
R³ is halogen, cyano, thiocyanato, nitro or a radical of the formula —Z¹—R⁷,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 hetero ring atoms selected from the group consisting of N, O and S, where each of the five last-mentioned radicals is unsubstituted or substituted, or an acyl radical,
R⁵ is halogen, cyano, thiocyanato, nitro or a radical of the formula —Z²—R⁸,
R⁶, in the case where n=1, or the radicals R⁶ in each case independently of one another, if n is greater than 1, is/are halogen, cyano, thiocyanato, nitro or a group of the formula —Z³—R⁹,
R⁷, R⁸, R⁹ in each case independently of one another are
hydrogen or
an acyclic hydrocarbon radical, where carbon atoms in the chain may be substituted by heteroatoms selected from the group consisting of N, O and S, or
a cyclic hydrocarbon radical or
a heterocyclic radical,
where each of the 3 last-mentioned radicals is unsubstituted or substituted,
Z¹, Z², Z³ in each case independently of one another are
a direct bond or
a divalent group of the formula —O—, —S(O)ₚ—, —S(O)ₚ—O—, —O—S(O)ₚ—, —CO—, —CS—, —S—CO—, —CO—S—, —O—CS—, —CS—O—, —S—CS—, —CS—S—, —OCO—, —CO—O—, —NR′—, —O—NR′—, —NR′—O—, —NR′—CO— or —CO—NR′—, where
p=0, 1 or 2 and R′=0 is hydrogen, alkyl having 1 to 6 carbon atoms, phenyl, benzyl, cycloalkyl having 3 to 6 carbon atoms or alkanoyl having 1 to 6 carbon atoms,
Y¹,Y², Y³ and, if m is 2, 3 or 4, further groups Y² are, in each case independently of one another,
a divalent group of the formula CR^{a}R^{b}, where R^{a} and R^{b} are identical or different and are in each case a radical selected from the group of the radicals possible for R⁷ to R⁹, or
a divalent group of the formula —O—, —CO—, —C(═NR*)—, —S(O)_{q}—, —NR— or —N(O)—, where q=0, 1 or 2 and R* is hydrogen or alkyl having 1 to 4 carbon atoms, or
Y¹ or Y³ is a direct bond,
where two oxygen atoms of groups Y² and Y³ are not adjacent,
m is 1, 2, 3 or 4,
n is 0, 1, 2, 3 or 4;
substituted 2,4-diamino-1,3,5-triazines of the formula (V), 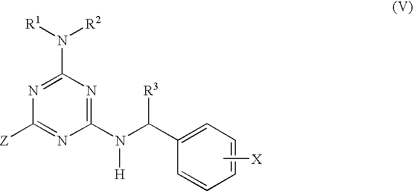
in which
R¹ is hydrogen or unsubstituted or hydroxyl-, cyano-, halogen- or C₁-C₄-alkoxy-substituted alkyl having 1 to 6 carbon atoms,
R² is hydrogen, formyl, in each case unsubstituted or cyano-, halogen- or C₁-C₄-alkoxy-substituted alkyl, alkylcarbonyl, alkoxycarbonyl or alkylsulfonyl having in each case 1 to 6 carbon atoms in the alkyl groups, or is unsubstituted or cyano-, halo-C₁-C₄-alkyl-, C₁-C₄-alkoxy-, halo-C₁-C₄-alkoxy- or C₁-C₄-alkoxy-carbonyl-substituted phenylcarbonyl, naphthylcarbonyl, phenylsulfonyl or naphthylsulfonyl,
R³ is unsubstituted or cyano-, halogen- or C₁-C₄-alkoxy-substituted alkyl having 1 to 6 carbon atoms or is unsubstituted or cyano-, halogen- or C₁-C₄-alkyl-substituted cycloalkyl having 3 to 6 carbon atoms,
X is a substituent selected from the group below:
hydroxyl, cyano, nitro, halogen, in each case unsubstituted or hydroxyl-, cyano- or hajogen-substituted alkyl or alkoxy having in each case 1 to 6 carbon atoms, in each case unsubstituted or halogen-substituted alkylcarbonyl, alkoxycarbonyl, alkylthio, alkylsulfinyl or alkylsulfonyl having in each case 1 to 6 carbon atoms in the alkyl groups, in each case unsubstituted or hydroxyl-, cyano-, nitro-, halogen-, C₁-C₄-alkyl, C₁-C₄-haloalkyl-, C₁-C₄-alkoxy or C₁-C₄-haloalkoxy-substituted phenyl or phenoxy, and
Z is hydrogen, hydroxyl, halogen, is in each case unsubstituted or hydroxyl-, cyano-, nitro-, halogen-, C₁-C₄-alkoxy-, C₁-C₄-alkyl-carbonyl-, C₁-C₄-alkoxy-carbonyl-, C₁-C₄-alkylthio-, C₁-C₄-alkylsulfinyl- or C₁-C₄-alkylsulfonyl-substituted alkyl, alkoxy, alkylcarbonyl, alkoxycarbonyl, alkylthio, alkylsulfinyl or alkylsulfonyl, having in each case 1 to 6 carbon atoms in the alkyl groups, is in each case unsubstituted or halogen-substituted alkenyl or alkynyl having in each case 2 to 6 carbon atoms or is unsubstituted or cyano-, halogen- or C₁-C₄-alkyl-substituted cycloalkyl having 3 to 6 carbon atoms,
compounds of the formula (VI) and their salts 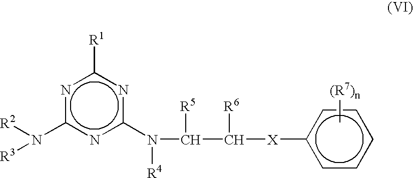
in which
R¹ is (C₁-C₆)-alkyl, which is unsubstituted or substituted by one or more radicals selected from the group consisting of halogen, hydroxyl, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-Q₄)-alkynyl and unsubstituted or substituted phenyl, or phenyl, which is unsubstituted or substituted,
R² and R³ in each case independently of one another are hydrogen, amino, (C₁-C₆)-alkyl-amino or di-[(C₁-C₆)-alkyl]-amino, a hydrocarbon radical or a hydrocarbonoxy radical having in each case 1 to 10 carbon atoms, a heterocyclyl radical, heterocyclyloxy radical or heterocyclylamino radical having in each case 3 to 9 ring atoms and 1 to 3 hetero ring atoms selected from the group consisting of N, O and S, where each of the five last-mentioned radicals is unsubstituted or substituted, or an acyl radical or
R² and R³ together with the nitrogen atom of the group NR²R³ are a heterocyclic radical having 3 to 6 ring atoms and 1 to 4 hetero ring atoms, where any hetero ring atoms present in addition to the nitrogen atom are selected from the group consisting of N, O and S and the radical is unsubstituted or substituted,
R⁴ is hydrogen, amino, (C₁-C₆)-alkylamino, di-[(C₁-C₆)-alkyl]-amino, a hydrocarbon radical or hydrocarbonoxy radical having in each case 1 to 10 carbon atoms or a heterocyclyl radical, heterocyclyloxy radical or heterocyclylamino radical having in each case 3 to 9 ring atoms and 1 to 3 hetero ring atoms selected from the group consisting of N, O and S, where each of the five last-mentioned radicals is unsubstituted or substituted, or an acyl radical,
R⁵ and R⁶ in each case independently of one another are halogen, nitro, cyano, thiocyanato or a radical of the formula —X¹-A¹, in which X¹ is a direct bond or a divalent group of the formula —O—, —S(O)ₚ—O—, —O—S(O)ₚ—, —CO—, —O—CO—, —CO—O—, —NR′—, —O—NR′—, —NR′—O—, —NR′—CO— or —CO—NR′—, where in the formulae p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms, and in which A¹ is hydrogen or a hydrocarbon radical or a heterocyclic radical, where each of the two last-mentioned radicals is unsubstituted or substituted, or
R⁵ and R⁶ together are an alkylene chain having 2 to 4 carbon atoms which is unsubstituted or substituted by one or more radicals selected from the group consisting of halogen, (C₁-C₄)-alkyl and oxo,
R⁷, independently of other radicals R⁷, is in each case halogen, nitro, cyano, thiocyanato or a radical of the formula —X²-A², in which X² is a direct bond or a divalent group of the formula —O—, —S(O)_{q}—, —S(O)_{q}—O—, —O—S(O)_{q}—, —CO—, —O—CO—, —CO—O—, —NR″—, —O—N—R″—, —NR″—O—, —NR″—CO— or —CO—NR″—, where in the formulae q=0, 1 or 2 and R″=hydrogen, (C₁-C₆)-alkyl, phenyl, (C₃-C₆)-cycloalkyl, and in which A² is hydrogen or a hydrocarbon radical or a heterocyclic radical, where each of the two last-mentioned radicals is unsubstituted or substituted,
or two adjacent radicals R⁷ together are a fused-on cycle having 4 to 6 ring atoms which is carbocyclic or contains hetero ring atoms selected from the group consisting of O, S and N and which is unsubstituted or substituted by one or more radicals selected from the group consisting of halogen, (C₁-C₄)-alkyl and oxo,
X is a group of the formula —O—, —S(O)ᵣ—, —NR*— or —N(O)—, where r=0, 1 or 2 and R is hydrogen or alkyl having 1 to 4 carbon atoms, and
n is 0, 1, 2, 3, 4 or 5,
where the grouping —CHR⁵—CHR⁶— has to contain at least 4 carbon atoms if X is —O—;
2,4-amino-1,3,5-triazines of the formula (VIl), if appropriate also in their salt form 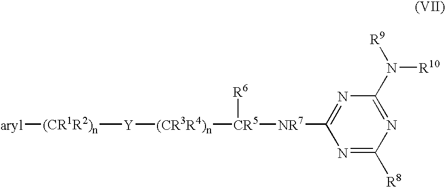
in which
aryl is an unsubstituted or substituted mono- or bicyclic aromatic radical having 5 to 14 ring atoms, 1, 2, 3 or 4 of which, in each case independently of one another, can be from the group consisting of oxygen, sulfur and nitrogen;
—Y— is a divalent unit selected from the group consisting of —O—, —S—, —NR¹¹—, —NR¹²CONR¹³—, —CO₂—, —OCO₂—, —OCONR¹⁴—, —SO—, —SO₂—, —SO₂O—, —SO₂O—, —SO₂NR¹⁴—, —O—NR¹¹—, —NR″—NR″—, in which R′ and R″ independently of one another are defined as R¹⁴, and —(Y′—CR^{a}R^{b}—CR^{c}R³)ᵢ—Y″ in which Y′ and Y″ independently of one another are O, S, NH or N[(C₁-C₄)-alkyl], R^{a}, R^{b}, R^{c} and R^{d} in each case independently of one another are H or (C₁-C₄)-alkyl and i is an integer from 1 to 5, or a trivalent unit of the formula —O—N═,
m is 0, 1, 2, 3, 4 or 5,
n is an integer from 1 to 10, with the proviso that n is not 1 if m is zero and —Y— is —O—, —S—, —SO—, —SO₂— or —NR¹¹—;
R¹, R² in each case independently of one another are a radical of a group G1 comprising hydrogen, (C₁-C₁₀)-alkyl, (C₂-C₈)-alkenyl, (C₂-C₈)-alkynyl, (C₁-C₁₀)-alkoxy, (C₃-C₈)-cycloalkyl, (C₃-C₈)-cycloalkoxy, aryl-(C₁-C₆)-alkyl and (C₃-C₈)-cycloalkyl-(C₁-C₆)-alkyl, where in each case the cyclic moiety of the four last-mentioned radicals is unsubstituted or substituted by one or more identical or different radicals selected from the group consisting of halogen, nitro, cyano, thiocyanato and —B—X¹, where —B— and X¹ are as defined below, and where in each case the noncyclic moiety of the eight last-mentioned radicals of group G1 is unsubstituted or substituted by one or more identical or different radicals selected from the group consisting of halogen, nitro, cyano, thiocyanato and —B—X², where X² is as defined below, and where in each case the noncyclic moiety of the radicals of group G1 may be interrupted by one or more identical or different heteroatoms selected from the group consisting of oxygen and sulfur,
R¹ and R² of a (CR¹R²) group form, together with the carbon atom that carries them, a carbonyl group, a group CR¹⁵R¹⁶ or a 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or
two R¹ of two directly or not directly adjacent (CR¹R²) groups form, together with the carbon atoms that carry or link them, an unsubstituted or substituted 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or
two R¹ of two directly adjacent (CR¹R²) groups, together with the bond between the carbon atoms of the groups, are a double bond, or two R¹ and two R² of two directly adjacent (CR¹R²) groups, together with the bond between the carbon atoms of the groups, are a triple bond, or
R¹ is a binding site for the double bond in the case that Y is a trivalent unit ═N—O— adjacent to a CR¹R² group,
R³, R⁴ in each case independently of one another are a radical of a group G2 comprising hydrogen, (C₁-C₁₀)-alkyl, (C₂-C₈)-alkenyl, (C₂-C₈)-alkynyl, (C₁-C₁₀)-alkoxy, (C₁-C₁₀)-alkylthio, (C₁-C₁₀)-alkylsulfinyl, (C₁-C₁₀)-alkylsulfonyl, (C₃-C₈)-cycloalkyl, (C₃-C₈)-cycloalkoxy, aryl, aryl-(C₁-C₆)-alkyl, aryl-(C₁-C₆)-alkoxy, (C₃-C₈)-cycloalkyl-(C₁-C₆)-alkyl, (C₃-C₈)-cycloalkyl-(C₁-C₆)-alkoxy, (C₃-C₈)-cycloalkoxy-(C₁-C₆)-alkyl and (C₃-C₈)-cycloalkoxy-(C₁-C₆)-alkoxy, where in each case the cyclic moiety of the nine last-mentioned radicals is unsubstituted or substituted by one or more identical or different radicals selected from the group consisting of halogen, nitro, cyano, thiocyanato und —B—X¹, where —B— and X¹ are as defined below, and where in each case the noncyclic moiety of the sixteen last-mentioned radicals of group G2 is unsubstituted or substituted by one or more identical or different radicals selected from the group consisting of halogen, nitro, cyano, thiocyanato and —B—X², where x² is as defined below, and where in each case the noncyclic moiety of the radicals of group G2 may be interrupted by one or more identical or different heteroatoms selected from the group consisting of oxygen and sulfur, or
R³ and R⁴ form, together with the carbon atom that carries them, a carbonyl group, a group CR¹⁵R¹⁶ or a 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or
two R³ of two directly or not directly adjacent (CR³R⁴) groups form, together with the carbon atoms that carry or link them, an unsubstituted or substituted 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or two R³ of two directly adjacent (CR³R⁴) groups, together with the bond between the carbon atoms of the groups, are a double bond, or two R³ and two R⁴ of two directly adjacent (CR³R⁴) groups, together with the bond between the carbon atoms of the groups, are a triple bond, or
R³ is a binding site for the double bond in the case that Y is a trivalent unit —O—N═ adjacent to a CR³R⁴ group,
—B— is a direct bond or a divalent unit selected from the group consisting of —O—, —S—, —NR¹¹—, —NR¹²CONR¹³—, —CO₂—, —OCO₂—, —OCONR¹⁴—, —SO—, —SO₂—, —SO₂O—, —OSO₂O— and —SO₂NR¹⁴—;
X¹ is hydrogen, (C₁-C₈)-alkyl, (C₂-C₈)-alkenyl, (C₂-C₈)-alkynyl, (C₃-C₈)-cycloalkyl or heterocyclyl having 3 to 9 ring atoms, 1, 2 or 3 of which are from the group consisting of nitrogen, oxygen and sulfur, where the five last-mentioned radicals are unsubstituted or substituted by one or more identical or different halogen atoms;
X² is hydrogen or heterocyclyl having 3 to 9 ring atoms, 1, 2 or 3 of which are from the group consisting of nitrogen, oxygen and sulfur, which heterocyclyl is unsubstituted or substituted by one or more identical or different halogen atoms;
R⁵, R⁶ in each case independently of one another are a radical of group G2, or
R³ and R⁵ of two directly or not directly adjacent (CR³R⁴) and (CR⁵R⁶) groups form, together with the carbon atoms linking them, an unsubstituted or substituted 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or
R⁵ and R⁶ form, together with the carbon atom that carries them, a carbonyl group, a group CR¹⁵R¹⁶ or a 3- to 6-membered ring which optionally contains one or two identical or different heteroatoms selected from the group consisting of oxygen, nitrogen and sulfur and which is unsubstituted or substituted by one or more identical or different radicals selected from the group consisting of halogen, nitro, cyano, thiocyanato and —B—X¹, or
R⁶ is heterocyclyl;
R⁷ is hydrogen, amino, alkylcarbonyl, alkylamino or dialkylamino having in each case one to six carbon atoms in the alkyl radical, an acyclic hydrocarbon or hydrocarbonoxy radical having in each case one to six carbon atoms, a cyclic hydrocarbon or hydrocarbonoxy radical having in each case three to six carbon atoms or heterocyclyl, heterocyclyloxy or heterocyclylamino having in each case three to six ring atoms and one to three hetero ring atoms selected from the group consisting of nitrogen, oxygen and sulfur, where each of the ten last-mentioned radicals is unsubstituted or substituted by one or more identical or different radicals selected from the group consisting of halogen, (C₁-C₄)-alkoxy, halo-(C₁-C₄)-alkoxy, (C₁-C₄)-alkylthio, (C₂-C₄)-alkenyl, (C₂-C₄)-alkynyl, (C₂-C₄)-alkenyloxy, (C₂-C₄)-alkynyloxy, hydroxyl, amino, acylamino, alkylamino, dialkylamino, nitro, carboxyl, cyano, azido, (C₁-C4)-alkoxycarbonyl, (C₁-C₄)-alkylcarbonyl, formyl, carbamoyl, mono- and di-(C₁-C₄)-alkyl)-aminocarbonyl, (C₁-C₄)-alkylsulfinyl, halo-(C₁-C₄)-alkylsulfinyl, (C₁-C₄)-alkylsulfonyl, halo-(C₁-C₄)-alkylsulfonyl and, in the case of cyclic radicals, also (C₁-C₄)-alkyl and halo-(C₁-C₄)-alkyl;
R⁸ is (C₁-C₁₀)-alkyl, (C₂-C₈)-alkenyl, (C₂-C₈)-alkynyl, which are unsubstituted or substituted by one or more identical or different radicals selected from the group consisting of halogen, cyano, nitro, thiocyanato, hydroxyl, (C₁-C₄)-alkoxy, (C₁-C₄)-alkylthio, (C₁-C₄)-alkylsulfinyl, (C₁-C₄)-alkylsulfonyl, phenyl, (C₃-C₉)-cycloalkyl, (C₃-C₉)-cycloalkoxy and heterocyclyl having three to six ring atoms and one to three hetero ring atoms selected from the group consisting of oxygen, nitrogen and sulfur, which heterocyclyl is unsubstituted or substituted by one or more identical or different radicals selected from the group consisting of halogen, amino, (C₁-C₄)-alkyl, (C₁-C₄)-alkoxy, halo-(C₁-C₄)-alkyl and halo-(C₁-C₄)-alkoxy, (C₃-C₈)-cycloalkyl, (C₃-C₈)-cycloalkoxy or a heterocyclyl radical having three to six ring atoms, where these three last-mentioned radicals are unsubstituted or substituted by one or more identical or different radicals selected from the group consisting of halogen, nitro, cyano, thiocyanato, (C₁-C₄)-alkyl, (C₁-C₄)-alkoxy, halo-(C₁-C₄)-alkyl and halo-(C₁-C₄)-alkoxy;
R⁹, R¹⁰ in each case independently of one another are hydrogen, amino, (C₁-C₁₀)-alkylcarbonyl, (C₁-C₁₀)-alkylamino, di-[(C₁-C₁₀)-alkyl]amino, (C₁-C₁₀)-alkyl, (C₃-C₈)-cycloalkyl, (C₁-C₁₀)-alkoxy, (C₃-C₈)-cycloalkoxy, heterocyclyl, heterocyclyloxy or heterocyclylamino having in each case 3 to 6 ring atoms and 1 to 3 hetero ring atoms selected from the group consisting of oxygen, nitrogen and sulfur, where each of the ten last-mentioned radicals is unsubstituted or substituted, or
R⁹ and R¹⁰ form, together with the nitrogen atom that carries them, a heterocycle having a total of three to six ring atoms, one to four of which are hetero ring atoms, where any further hetero ring atoms present in addition to the nitrogen atom are selected from the group consisting of oxygen, nitrogen and sulfur and where this heterocycle is unsubstituted or substituted;
R¹¹ is hydrogen, amino, (C₁-C₁₀)-alkylamino, di-[(C₁-C₁₀)-alkyl]amino, (C₁-C₁₀)-alkyl, (C₃-C₈)-cycloalkyl, (C₃-C₈)-cycloalkyl-(C₁-C₆)-alkyl, (C₁-C₁₀)-alkoxy, (C₁-C₆)-alkoxy-(C₁-C₆)-alkoxy, (C₃-C₈)-cycloalkoxy, (C₁-C₁₀)-alkylcarbonyl, where the nine last-mentioned radicals are unsubstituted or substituted;
R¹², R¹³ in each case independently of one another are hydrogen, (C₁-C₁₀)-alkyl, (C₂-C₈)-alkenyl, (C₂-C₈)-alkynyl, phenyl, phenyl-(C₁-C₆)-alkyl, (C₃-C₈)-cycloalkyl, (C₃-C₈)-cycloalkyl-(C₁-C₆)-alkyl, where in each case the cyclic moiety of the four last-mentioned radicals is unsubstituted or substituted by one or more identical or different radicals selected from the group consisting of (C₁-C₄)-alkyl, halo-(C₁-C₄)-alkyl, (C₁-C₄)-alkoxy and halo-(C₁-C₄)-alkoxy, or
R¹² and R¹³ form, together with the N-CO-N group that carries them, a 5- to 8-membered ring which, in addition to the two nitrogen atoms mentioned, may contain a further heteroatom selected from the group consisting of oxygen, nitrogen and sulfur and which is unsubstituted or substituted,
R¹⁴ is hydrogen or in each case unsubstituted or substituted (C₁-C₁₀)-alkyl or (C₃-C₁₀)-cycloalkyl and
R¹⁵ R¹⁶ in each case independently of one another are hydrogen, aryl (C₁-C₁₀)-alkoxy, aryl-(C₁-C₆)-alkyl, (C₁-C₁₀)-alkyl, (C₁-C₁₀)-alkylthio, where the five last-mentioned radicals are unsubstituted or substituted, and where the aliphatic carbon skeleton of the three last-mentioned radicals may be interrupted by one or more identical or different heteroatoms selected from the group consisting of oxygen and sulfur, or
R¹⁵ and R¹⁶ form, together with the carbon atom that carries them, a 3- to 6-membered ring which optionally contains one or two identical or different heteroatoms selected from the group consisting of oxygen, nitrogen and sulfur and which is unsubstituted or substituted;
substituted 2-amino-4-alkylamino-1,3,5-triazines of the formula (VIII) 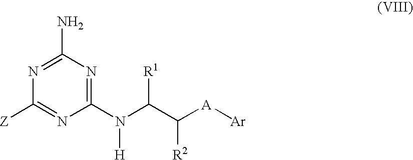
in which
R¹ is in each case unsubstituted or substituted alkyl having 2 to 6 carbon atoms or cycloalkyl having 3 to 6 carbon atoms,
R² is hydrogen or is alkyl having 1 to 4 carbon atoms,
A is oxygen or methylene,
Ar is in each case unsubstituted or substituted phenyl, naphthyl or heterocyclyl, and
Z is hydrogen, is halogen or is in each case unsubstituted or substituted alkyl, alkoxy, alkylcarbonyl, alkoxycarbonyl, alkylthio, alkylsulfinyl, alkylsulfonyl, alkenyl or alkynyl; and
2,4-amino-1,3,5-triazines of the formula (IX), if appropriate also in their salt form, 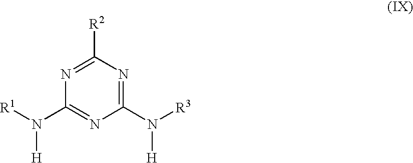
in which
R¹ is hydrogen or is unsubstituted or substituted alkyl, alkylcarbonyl, alkoxycarbonyl, alkenylcarbonyl or alkynylcarbonyl;
R² is hydrogen or is in each case unsubstituted or substituted alkenyl or alkynyl, and
R³ is the grouping -A-Z; in which
A is unsubstituted or substituted straight-chain or branched alkanediyl which optionally contains, at the beginning or at the end or within the alkanediyl chain, a heteroatom (group) selected from the group consisting of O, S, NH and alkylimino, and
Z is an unsubstituted or substituted monocyclic or bicyclic, carbocyclic or heterocyclic grouping selected from the group consisting of cyclopentyl, cyclohexyl, phenyl, naphthyl, tetralinyl, decalinyl, indanyl, indenyl, furyl, benzofuryl, dihydrobenzofuryl, thienyl, benzothienyl, dihydrobenzothienyl, isobenzofuryl, dihydroisobenzofuryl, isobenzothienyl, dihydroisobenzothienyl, pyrrolyl, indolyl, isoindolyl, indolinyl, isoindolinyl, benzodioxolyl, oxazolyl, benzoxazolyl, thiazolyl, benzothiazolyl, indazolyl, oxadiazolyl, thiadiazolyl, pyrazolyl, pyridinyl, pyrimidinyl, pyrazinyl, pyridazinyl, quinolyl, isoquinolyl, quinoxalinyl, cinnolinyl and phathalazinyl.
Halogen is preferably chlorine, bromine and iodine; in haloalkyl, halogen is preferably fluorine.
R¹ is preferably —CF(CH₃)₂,
R is preferably (C₁-C₄)-alkyl or (C₃-C₄)-cycloalkyl.
A is preferably —CH₂—, —CH₂—CH₂— or —CH₂—CH₂—CH₂—.

3. The herbicide combination as claimed in claim 1 or 2, which comprises, as component (A), one or more triazine derivatives of the formula (X) 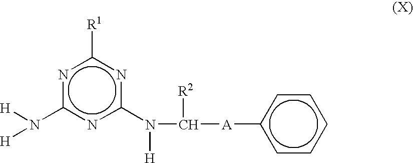
in which
R¹ is (C₁-C₄)-alkyl or (C₁-C₄)-haloalkyl;
R² is (C₁-C₄)-alkyl, (C₃-C6)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—.

4. The herbicide combination as claimed in any of claims 1 to 3, which comprises, as component (A), one or more triazine derivatives of the formulae (A1), (A2), (A3), (A4), (A5), (A6) and (A7):

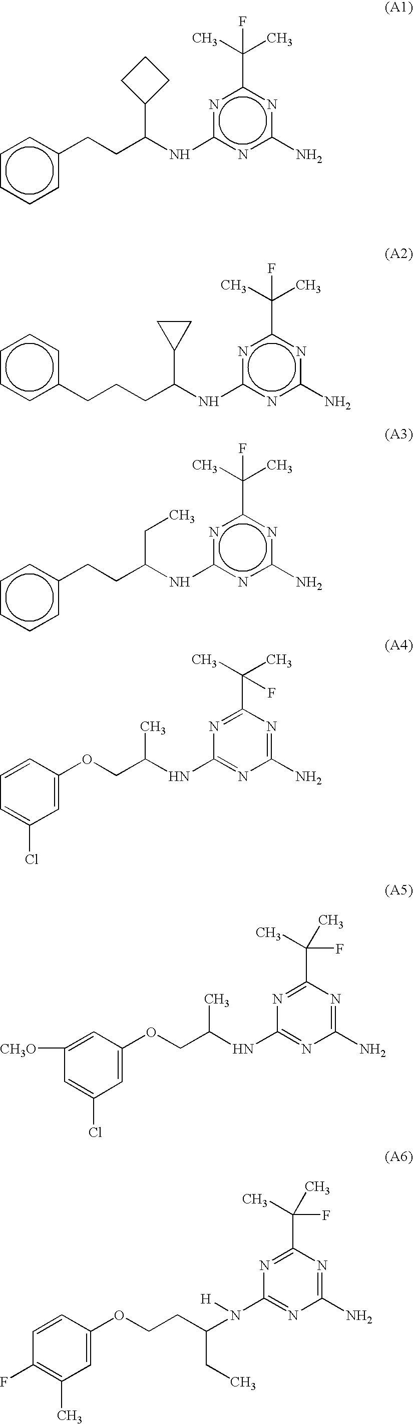

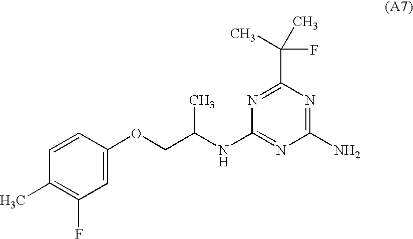

5. The herbicide combination as claimed in one or more of claims 1 to 4, wherein component (B) comprises one or more compounds selected from the group consisting of
(B1.1.1) isoproturon,
(B1.1.2) chlorotoluron,
(B1.2.1) flufenacet,
(B1.2.2) pendimethalin,
(B1.2.3) prosulfocarb,
(B1.3.1) clodinafop-propargyl,
(B1.3.2) diclofop-methyl,
(B1.3.3) fenoxaprop-P-ethyl and fenoxaprop-ethyl,
(B1.3.4) quizalofop-P and its salts and esters and quizalofop and its salts and esters,
(B1.3.5) fluazifop-P and its esters and fluazifop and its esters,
(B1.3.6) haloxyfop and haloxyfop-P and their esters,
(B1.3.7) propaquizafop (PM, p. 1021-1022),
(B1.3.8) cyhalofop and its esters,
(B1.4.1) sethoxydim,
(B1.4.2) cycloxydim
(B1.4.3) clethodim,
(B1.4.4) clefoxidim,
(B1.4.5) tralkoxidim,
(B1.5.1) dimethenamid,
(B1.5.2) penthoxamid,
(B1.5.3) butachlor,
(B1.5.4) pretilachlor,
(B1.6.1) imazamethabenz-methyl
(B1.6.2) simazin
(B1.6.3) molinate
(B1.6.4) thiobencarb
(B1.6.4) MY 100,
(B1.6.5) anilofos,
(B1.6.6) cafenstrole,
(B1.6.7) mefenacet,
(B1.6.8) fentrazamid,
(B1.6.9) thiazopyr,
(B1.6.10) oxadiazon,
(B1.6.11) esprocarb,
(B1.6.12) pyributicarb,
(B1.6.13) azimsulfuron,
(B1.6.14) AEB391 and related azoles,
(B1.6.15) thenylchlor,
(B1.6.16) pentoxazone,
(B1.6.17) pyriminobac and pyriminobac-methyl,
(B1.6.18) flucarbazone and its salts,
(B1.6.19) procarbazone and its salts,
(B2.1.1) tribenuron-methyl,
(B2.1.2) thifensulfuron and its esters,
(B2.1.3) prosulfuron,
(B2.1.4) amidosulfuron,
(B2.1.5) chlorimuron and its esters,
(B2.1.6) halosulfuron and its esters and salts,
(B2.1.7) LAB271272, (=tritosulfuron),
(B2.1.8) bensulfuron-methyl,
(B2.1.9) ethoxysulfuron,
(B2.1.10) cinosulfuron,
(B2.1.11) pyrazosulfuron and its esters,
(B2.1.12) imazosulfuron,
(B2. 1.13) cyclosulfamuron,
(B2.2.1) MCPA,
(B2.2.2) 2,4-D,
(B2.2.3) dichlorprop,
(B2.2.4) mecoprop-(P),
(B2.2.5) fluoroxypyr,
(B2.2.6) dicamba,
(B2.2.7) clopyralid,
(B2.2.8) picloram,
(B.2.3.1) bromoxynil,
(B.2.3.2) ioxynil,
(B2.4.1) fluoroglycofen-ethyl,
(B2.4.2) aclonifen,
(B2.4.3) acifluorfen and its salts,
(B2.5.1) cloransulam and its esters
(B2.5.2) florasulam,
(B2.6.1) bentazone,
(B2.6.2) bifenox,
(B2.6.3) carfentrazone-ethyl,
(B2.6.4) pyraflufen,
(B2.6.5) pyridate,
(B2.6.6) linuron,
(B2.6.7) diflufenzopyr and its salts,
(B2.6.8) cinidon-ethyl,
(B2.6.9) clopyralid and its salts and esters,
(B2.6.10) metribuzin,
(B2.6.11) picolinafen,
(B2.6.12) clomazone,
(B2.6.13) bromobutide,
(B2.6.14) benfuresate,
(B2.6.15) dithiopyr,
(B2.6.16) triclopyr and its salts and esters,
(B3.1.1) metsulfuron and its esters,
(B3.1.2) triasulfuron,
(B3.1.3) chlorsulfuron,
(B3.1.4) iodosulfuron-methyl,
(B3.1.5) AEF060,
(B3.1.6) sulfosulfuron,
(B3.1.7) flupyrsulfuron and its salts,
(B3.1.8) nicosulfuron,
(B3.1.9) rimsulfuron,
(B3.1.10) primisulfuron and esters,
(B3.1.11) AEF360,
(B3.2. 1) cyanazine,
(B3.2.2) atrazin
(B3.2.3) terbuthylazin,
(B3.2.4) terbutryn,
(B3.3.1) acetochlor
(B3.3.2) metolachlor,
(B3.3.3) alachlor,
(B3.4.1) clomazone,
(B3.4.2) diflufenican,
(B3.4.3) flumetsulam,
(B3.4.4) flurtamone,
(B3.4.5) isoxaflutole,
(B3.4.6) metosulam,
(B3.4.7) metribuzin,
(B3.4.8) paraquat (salts),
(B3.4.9) benoxacor,
(B3.4.10) sulcotrione,
(B3.4.11) mesotrione,
(B3.4.12) quinclorac,
(B3.4.13) propanil,
(B3.4.14) bispyribac, bispyribac-Na,
(B3.4.15) LGC 40863 (pyribenzoxim),
(B3.4.16) oxadiargyl,
(B3.4.17) norFlurazon,
(B3.4.18) fluometuron,
(B3.4.19) methylarsonic acid and its salts (DSMA, MSMA).
(B3.4.20) prometryn,
(B3.4.21) trifluralin,
(B4.1.1) glufosinate,
(B4.1.2) glufosinate monoammonium salt,
(B4.1.3) L-glufosinate,
(B4.1.4) L-glufosinate monoammonium salt,
(B4.1.5) bilanafos,
(B4.2.1) glyphosate,
(B4.2.2) glyphosate monoisopropylammonium salt,
(B4.2.3) glyphosate sodium salt,
(B4.2.4) sulfosate,
(B4.3. 1) imazapyr,
(B4.3.2) imazethapyr
(B4.3.3) imazamethabenz, and its salts and esters,
(B4.3.4) imazamox and its salts and esters,
(B4.3.5) imazaquin and its salts and esters,
(B4.3.6) imazapic (AC 263,222) and its salts and esters
(B4.4.1) WC9717 or CGA276854,
(B4.4.2) azafenidin,
(B4.4.3) diuron and
(B4.4.4) oxyfluorfen,
and, if appropriate, their agriculturally useful salts.

6. The herbicide combination as claimed in any of claims 1 to 5, which comprises one or more further components selected from the group consisting of crop protection agents of a different type, additives which are customary in crop protection and formulation auxiliaries.

7. A method for controlling harmful plants, which comprises applying the herbicides of the herbicide combination as defined in one or more of claims 1 to 6 together or separately, pre-emergence, post-emergence or pre- and post-emergence, to the plants, parts of plants, plant seeds or the area under cultivation.

8. The method as claimed in claim 7 for the selective control of harmful plants in crops of plants.

9. The method as claimed in claim 6 for the control of harmful plants in cereal.

10. The use of the herbicide combinations defined in any of claims 1 to 6 for controlling harmful plants.
